(19) United States
(12) Patent Application Publication
(10) Pub. No.: US 2023/0363328 A1
(43) Pub. Date: Nov. 16, 2023

(54) MULTISENSORY METHODS AND APPARATUS FOR CONTROLLED ENVIRONMENT HORTICULTURE

(71) Applicant: Agnetix, Inc., San Diego, CA (US)

(72) Inventors: Ihor Lys, La Jolla, CA (US); Nicholas Maderas, Richmond, CA (US)

(73) Assignee: Agnetix, Inc., San Diego, CA (US)

(21) Appl. No.: 18/358,145

(22) Filed: Jul. 25, 2023

Related U.S. Application Data
(63) Continuation of application No. PCT/US22/13755, filed on Jan. 25, 2022.
(60) Provisional application No. 63/197,261, filed on Jun. 4, 2021.
(60) Provisional application No. 63/141,453, filed on Jan. 25, 2021.

(51) Int. Cl. A01G 9/26; G01J 5/10; G01J 3/02; G01J 3/28; A01G 7/02; A01G 9/24; A01G 7/04; H05B 45/12

(52) U.S. Cl. CPC A01G 9/26; G01J 5/10; G01J 3/0291; G01J 3/2823; A01G 7/02; A01G 9/246; A01G 9/247; A01G 9/249; A01G 7/045; H05B 45/12; G01J 2005/106

(57) ABSTRACT

An integrated sensor assembly includes a housing having a rectangular shape, a front side having a length and width and including a plurality of openings, and a thickness significantly less than the length or the width of the front side. The assembly includes an infrared thermal sensor disposed in the housing and aligned with a first opening of the plurality of openings, a time-of-flight proximity sensor disposed in the housing and aligned with a second opening of the plurality of openings, and a color light sensor, disposed in the housing and aligned with the second opening of the plurality of openings, to respectively sense at least red light, green light, and blue light. The integrated sensor assembly does not include a narrowband irradiator to facilitate multispectral imaging of reflected or emitted radiation from at least one object in response to irradiation by the narrowband irradiator.

### CROSS-REFERENCE TO RELATED PATENT APPLICATION(S)

The present application is a bypass continuation of international application No. PCT/US2022/013755, filed on Jan. 25, 2022, entitled “MULTISENSORY METHODS AND APPARATUS FOR CONTROLLED ENVIRONMENT HORTICULTURE,” which claims priority to U.S. provisional application No. 63/141,453, filed on Jan. 25, 2021, entitled “MULTISPECTRAL IMAGING METHODS AND APPARATUS FOR CONTROLLED ENVIRONMENT HORTICULTURE USING ILLUMINATORS AND CAMERAS AND/OR SENSORS” and U.S. provisional application No. 63/197,261, filed on Jun. 4, 2021, entitled “FLUID-COOLED LED-BASED LIGHTING METHODS AND APPARATUS FOR CONTROLLED ENVIRONMENT HORTICULTURE AND INSPECTION OF SAME.” Each of the aforementioned applications is incorporated herein by reference in its entirety.

### BACKGROUND

Farmers are increasingly using agricultural imaging of outdoor crops in an effort to improve crop yields. Conventional agricultural imaging techniques can facilitate easier inspection of outdoor crops, greater precision of crop monitoring, and earlier detection of crop problems, such as certain nutrient deficiencies, insect infestations, and diseases. Satellites, aircraft, or unmanned aerial vehicles (UAVs) are used to capture hyperspectral or multispectral aerial images of the crops. These aerial images can be processed using vegetation indices (VIs) to determine certain crop features.

A VI is a spectral transformation of two or more spectral reflectance measurement bands that takes advantage of differences in light reflectance from vegetation in different spectral bands. VIs may facilitate indicating an amount of vegetation, distinguishing between soil and vegetation, or reducing atmospheric and topographic effects in images of vegetation. VIs can be correlated with various crop characteristics, such as leaf area index (LAI), percent green cover, chlorophyll content, green biomass, and absorbed photosynthetically active radiation (APAR). The Normalized Difference Vegetation Index (NDVI) is a common VI that compares visible red and near-infrared (NIR) spectral reflectance bands. Other common VIs include the Photochemical Reflectance Index (PRI), the Difference Vegetation Index (DVI), the Ratio Vegetation Index (RVI), and the Crop Water Stress Index (CWSI). Images that are generated and/or processed based on one or more VIs can show changes in crops weeks before the changes are visible to the naked eye. Such insights from images can be used to improve resource use efficiency; protect crops from certain diseases, pests, and water stress; and improve crop yield.

In conventional agricultural imaging techniques, multiple parameters affect the efficacy and utility of images of crops; examples of such parameters include pixel resolution (size of the pixels), image bandwidth (spectral range of wavelengths being imaged), radiometry resolution (range of relative radiation reflectance values per pixel), and positional accuracy. All of these parameters impact the usefulness of the image for crop monitoring. In particular, agricultural imaging equipment that provides sufficient imaging resolution and accuracy generally translates to increased costs to the farmer. In some instances, the cost of effective agricultural imaging for a given farmer can offset any increased profits due to better yields, leaving the potential agricultural advantages of such imaging out of reach for some farmers.

Controlled Environment Horticulture (CEH) (also referred to more generally as controlled environment agriculture or CEA) is the process of growing plants in a controlled environment where various environmental parameters are monitored and adjusted to improve the quality and yield of the plants grown. Compared to conventional approaches of plant cultivation, CEH may enable year-round production of plants, insensitivity to variable weather conditions, reduce pests and diseases, and reduce the number of resources consumed on a per plant basis. A controlled horticultural environment is typically enclosed, at least in part, by a building structure such as a greenhouse, a grow room, or a cover for a portion of a field in order to provide some degree of control over environmental conditions. Additional control systems may be deployed in CEH to adjust various environmental parameters including lighting, temperature, humidity, nutrient levels, and carbon dioxide (CO2) concentrations. For example, one or more artificial lighting systems are often used in such controlled horticultural environments to supplement and/or replace natural sunlight that may be obstructed by the building structure or insufficient during certain periods of the year (e.g., winter months).

There have been multiple attempts to adapt agricultural imaging systems for CEH. For example, in the article by Story and Kacira, “Design and Implementation of a Computer Vision-Guided Greenhouse Crop Diagnostics System,” Machine Vision and Applications, Vol. 26 (2015), pp. 495-506, the authors describe a canopy imaging system with robotic positioning to move the imaging system around a CEH growth environment. The imaging system determined crop features, such as color, texture, morphology, and temperature under greenhouse field lighting conditions, using three cameras for visible, near infrared (NIR), and thermal imaging, respectively. Robotic positioning moved the three-camera housing within an xy-coordinate system above the crop canopy.

As another example, international patent publication WO 2017/192566 describes a horticultural lighting system with one or more modular devices, such as a hyperspectral, stereoscopic, or infrared camera, installed into a receptacle in a lighting device. The modular devices can be used to validate light levels and spectrum delivered to growth environments in order to identify light intensity decay and spectrum shift over time.

As a third example, U.S. Pat. No. 8,850,742 describes a lighting system used to modulate and control growth and attributes of greenhouse crops. The system includes arrays of high power LEDS having different ranges of wavelengths to irradiate one or more plants in the CEH, as well as sensors or cameras with specific color filters to sense reflected or emitted light from the crops. This system uses the data collected from the sensors or cameras to predict response and performance of plants to various growing conditions and modulates the lighting produced by the lighting system based on the data.

In addition to imaging, more generally a variety of environmental sensing equipment available from multiple manufacturers has been conventionally employed to monitor different conditions and aspects of crops and their environs. Like agricultural imaging, incorporating multiple sensing modalities in CEH may provide greater insight and control on environmental parameters pertinent to plant development, crop yield, and crop quality. Various types of conventional sensors deployed in CEH, however, often are installed, connected, and controlled individually and/or in an uncoordinated manner (e.g., particularly if each sensor type from a given manufacturer has a proprietary connection mechanism). This in turn may outweigh the potential benefits of increased monitoring of crops via diverse sensing; in particular, increasing the number of diverse sensors unduly increases the complexity of the sensing system and thereby may pose a greater time, cost and/or other resource burden on farmers.

### SUMMARY

As noted above, aerial agricultural imaging is limited to outdoor agricultural environments. Accordingly, there are multiple considerations for adapting agricultural imaging to Controlled Environment Horticulture (CEH), given that crops are not accessible for aerial imaging (e.g., using satellites, planes, or UAVs). Additionally, one or more artificial lighting systems often are used in CEH to supplement and/or replace natural sunlight that may be obstructed by the building structure or insufficient during certain periods of the year (e.g., winter months).

The Inventors have recognized and appreciated that previous efforts to adapt conventional agricultural imaging techniques to CEH have had some shortcomings. For example, some previous efforts, such as those disclosed in WO 2017/192566 and Story and Kacira, relied on illumination from the growing environment (e.g., either artificial growing lights or the sun) to provide sufficient light for imaging. However, the Inventors have recognized and appreciated the benefits of augmenting an artificial lighting system for CEH with an imaging system that includes its own irradiation devices; such an imaging system allows crops to be irradiated with specific narrow spectral bands to sense and image crop conditions that may be particularly represented in one or more of these narrow spectral bands. The Inventors have also recognized the importance of measuring spectral characteristics of crops in situ without necessarily affecting morphological changes in the crops due to irradiation from an imaging system.

To this end, the Inventors have appreciated some of the limitations of imaging techniques such as those disclosed techniques in U.S. Pat. No. 8,850,742, which employed simultaneous irradiation of plants using several high power narrow spectral band irradiators. However, by simultaneously irradiating plants with several relatively high power and narrow spectral bands, the techniques employed in this patent mask or make it difficult to isolate a particular characteristic of the irradiated crops at any one narrow spectral band. When considered together with the relatively low-resolution cameras employed, the disclosed techniques in U.S. Pat. No. 8,850,742 compromise accuracy and reliability. Additionally, the disclosed high-power irradiating techniques intentionally modified biochemical attributes of the plants, and hence were not oriented to measuring various aspects of plants in situ in the nominal conditions of the controlled environment.

In view of the foregoing, the present disclosure is directed generally to multisensory imaging methods and apparatus that involve one or both of multispectral imaging and integrated sensing to provide a fuller compliment of information regarding crops in CEH, from an entire grow space, to some smaller portion of a grow space, down to individual plants, leaves, buds, or other plant constituents. In example implementations discussed herein, comprehensive multisensory imaging may be realized in relatively large “fields of view” in a given grow space, (in which the resolution of data captured in a given image may be on the scale of multiple plants or groups of plants or a larger portion of a grow space), as well as relatively smaller fields of view (in which the resolution of data captured by a given image may be on the scale of a single plant or portion of a plant). In one salient aspect, various data constituting an image, acquired from virtually any size field of view or any image resolution, is indexed as respective pixels representing points in a one-dimensional (1D), two-dimensional (2D) or three-dimensional (3D) arrangement of sensing nodes in some portion (or all of) a grow space.

The various concepts disclosed herein constitute significant improvements in horticultural imaging that reduce cost, improve access of agricultural imaging to farmers, and improve image quality and the quantum of information that can be derived from the images. These concepts also constitute significant improvements in horticultural sensing more generally that reduce cost, improve access to farmers, and enhance the quantum of information that can be derived from sensors deployed in CEH. Furthermore, in some example implementations, the disclosed concepts integrate agricultural sensing and imaging together for CEH, and further integrate sensing and imaging concepts with artificial lighting and environmental conditioning (e.g., HVAC) for CEH to provide holistic control and monitoring solutions.

For example, one implementation disclosed herein relates to a multispectral imaging system that is deployed in combination with a fluid-cooled light emitting diode (LED)-based lighting fixture (also referred to hereafter as a “lighting fixture” or “illuminator”). The multispectral imaging system may provide finite spectra sensing to measure narrowband spectra (e.g., about 2 nm to about 40 nm). The finite spectra sensing capabilities provided by the multispectral imaging system may enable the characterization of various aspects of CEH crops including, but not limited to deep plant phenotyping, plant-environment interactions, genotype-phenotype relations, growth rate correlations, imaging, and analysis of plants in pots, containers, and/or ground soil. Furthermore, the multispectral imaging system is sufficiently compact for deployment and use at length scales less than 100 meters (unlike previous imaging systems deployed on aircraft, i.e., at length scales greater than 1000 meters).

In one aspect, the multispectral imaging system may be integrated with a lighting fixture or a separate module (or accessory) connected to the lighting fixture via a wired or wireless connection. The multispectral imaging system may include imagers/sensors to acquire imagery and spectra on the agricultural environment. The imagers/sensors may be configured to acquire imagery and/or spectra over a broad wavelength range (e.g., ultraviolet to long wavelength infrared). In some implementations, the multispectral imaging system may include a first imager/camera to acquire imagery from the UV to short wavelength infrared (SWIR) regimes and a second imager/camera to acquire imagery in the long wavelength infrared (LWIR) regime. In some implementations, the second imager/camera may continually acquire LWIR imagery while the first imager/camera is periodically activated in combination with an illumination source (e.g., the onboard LED elements) to acquire UV-SWIR imagery.

In some implementations, the multispectral imaging system may include one or more irradiation sources (e.g., LED elements) to illuminate the agricultural environment with radiation at different wavelengths. In this manner, the imagers/sensors may acquire imagery corresponding to the radiation at each respective wavelength, which may then be overlaid to form a multispectral image. In some implementations, the multispectral imaging system may instead use LED light sources integrated into the lighting fixture to illuminate the environment at one or more wavelengths. The multispectral imaging system may also include one or more filters (e.g., a filter wheel) to selectively acquire imagery/spectra data at a particular wavelength if the illuminator (e.g., the LED light sources, the onboard LED elements) illuminate the environment with radiation at multiple wavelengths.

In one exemplary method, the multispectral imaging system may acquire imagery/spectra of the agricultural environment using the following steps: (1) turning on a first LED element in the multispectral imaging system to irradiate the agricultural environment with radiation at a first wavelength, (2) acquiring imagery/spectra of the environment using the imagers/sensors in the multispectral imaging system, and (3) turning off the first LED element. This method may be repeated for additional LED elements in the multispectral imaging system using, for example, the following steps: (4) turning on a second LED element in the multispectral imaging system to irradiate the agricultural environment with radiation at a second wavelength, (5) acquiring imagery/spectra of the environment using the imagers/sensors in the multispectral imaging system, and (6) turning off the second LED element.

In some implementations, the multispectral imaging system may acquire imagery/spectra of the environment while no other illumination sources are active. For example, the lighting fixture may include LED light sources that provide photosynthetically active radiation (PAR). The LED light sources may be turned off when the multispectral imaging system acquires imagery/spectra of the environment. Said in another way, the multispectral imaging system may be configured to irradiate a dark environment with a series of flashes (e.g., brief pulses of radiation) to acquire imagery/spectra at several wavelengths.

The multispectral imaging system may also include supplementary LED elements. In some implementations, the supplementary LED elements may be used to modify the plants and/or their surroundings. For example, one or more of the supplementary LED elements may emit UV radiation with sufficient brightness (and/or intensity) to repel pests or to reduce the growth of mildew (e.g., using 275 nm wavelength radiation). In another example, one or more of the supplementary LED elements may alter the morphology and/or the photoperiod of the plants (e.g., using 730 nm wavelength radiation). It should be appreciated that the light treatment functionality provided by the supplementary LED elements may also be provided by the LED light sources that illuminate the plants with PAR.

In some implementations, the multispectral imaging system may be paired with another irradiator that provides radiation to the environment. The irradiator may provide radiation that covers the UV, visible, near infrared (NIR), and/or SWIR regimes. In some implementations, the lighting fixture may be paired with another imager/sensor. The imager/sensor may be configured to acquire imagery/spectra covering the UV, visible, NIR, SWIR, and/or LWIR regimes. In general, the imager/sensor may acquire 2D imagery and/or 3D imagery (e.g., Lidar, a pan-tilt-zoom (PTZ) camera) of the environment. The imager/sensor may also have a field of view that ranges between a portion of the environment that includes one or more plants to an entire room of the environment. Note the environment may contain multiple rooms.

In some implementations, the multispectral imaging system may be calibrated using various calibration sources disposed in the environment. In one example, a phantom may be used to calibrate imagery/spectra acquired between the UV and SWIR regimes. The phantom may be an object with known optical properties (e.g., emissivity, absorptivity, reflectivity) with various shapes (e.g., a sphere, a polyhedron, a plant, an animal). One or more phantoms may be placed within the field of view of the imager/sensors to calibrate the magnitude and wavelength of radiation detected by the imager/sensors. In another example, a blackbody reference may be used to calibrate thermal imagery/spectra acquired in the LWIR regime. The blackbody reference may be an object that includes a heater and a temperature sensor. The blackbody reference may be used to calibrate the temperature value in a heatmap acquire by a LWIR imager/sensor.

In various implementations, the imaging system disclosed herein may include one or more communication and/or auxiliary power ports, for example, to provide auxiliary DC power to one or more auxiliary devices coupled to the port(s). Example of such ports include, but are not limited to, one or more Power over Ethernet (PoE) ports and/or one or more Universal Serial Bus (USB) ports to communicatively couple multiple lighting fixtures together and/or support operation of one or more auxiliary devices (e.g., sensors, actuators, or other external electronic devices). Examples of various sensors that may be coupled to one or more imaging systems via one or more of the PoE or USB ports include, but is not limited to, air temperature sensors, near-infrared (NIR) leaf moisture sensors, hyperspectral cameras, finite spectral cameras, IR leaf temperature sensors, relative humidity sensors, and carbon dioxide sensors. Other examples of auxiliary devices that may be coupled to one or more imaging systems via PoE or USB ports include, but are not limited to, one or more fans, security cameras, smart phones, and multi-spectral cameras (e.g., to analyze soil moisture, nutrient content, leaves of the plants). In this manner, various auxiliary devices may be particularly distributed in the controlled agricultural environment due to the flexible placement of communication ports on the imaging system.

In some implementations, the processor of the imaging system may be used to control one or more auxiliary devices and/or process data from the auxiliary devices. The processor may then utilize the data to adjust and control operation of one or more lighting fixtures (e.g., adjusting the PAR output from the lighting fixture) one or more coolant circuits (e.g., adjusting the fluid flow through the coolant circuit including the lighting loop, hydronics loop, and cooling loops), one or more fans, one or more dehumidifiers, or one or more air conditioners in the controlled agricultural environment. In some implementations, various environmental conditions are measured and controlled to provide target vapor pressure deficits in the environment.

In yet other example implementations, a modular integrated sensor assembly is disclosed that includes only includes three sensors (e.g., an infrared thermal sensor, a time-of-flight proximity sensor, and a color light sensor), and does not include any irradiation sources to facilitate image acquisition (e.g., by detecting radiation reflected or emitted by an object in the controlled horticultural environment), nor does the integrated sensor assembly include any supplemental illumination source (e.g., to provide UV or far red illumination). In some example implementations, the integrated sensor assembly further does not include any camera. The implementation of an integrated sensor assembly having a similar or same form factor as the imaging engines described elsewhere herein, but with a purposefully reduced number of components and particularly-selected sensor types, provides additional benefits that compliment or are valuable alternatives to those provided by the various disclosed imaging engines.

Each of the following patent applications are incorporated by reference in their entirety: U.S. application Ser. No. 16/114,088, filed Aug. 27, 2018, entitled “FLUID-COOLED LED-BASED LIGHTING METHODS AND APPARATUS FOR CONTROLLED ENVIRONMENT AGRICULTURE;” U.S. application Ser. No. 16/390,501, filed May 21, 2019, entitled “INTEGRATED SENSOR ASSEMBLY FOR LED-BASED CONTROLLED ENVIRONMENT AGRICULTURE (CEA) LIGHTING, AND METHODS AND APPARATUS EMPLOYING SAME;” U.S. application Ser. No. 16/404,192, filed May 6, 2019, entitled “FLUID-COOLED LIGHTING SYSTEMS AND KITS FOR CONTROLLED AGRICULTURAL ENVIRONMENTS, AND METHODS FOR INSTALLING SAME;” U.S. application Ser. No. 16/828,521, filed May 24, 2020, entitled “METHODS, APPARATUS, AND SYSTEMS FOR LIGHTING AND DISTRIBUTED SENSING IN CONTROLLED AGRICULTURAL ENVIRONMENTS;” U.S. application Ser. No. 17/083,461, filed Oct. 29, 2020, entitled “FLUID-COOLED LED-BASED LIGHTING METHODS AND APPARATUS FOR CONTROLLED ENVIRONMENT AGRICULTURE WITH INTEGRATED CAMERAS AND/OR SENSORS AND WIRELESS COMMUNICATIONS;” U.S. application Ser. No. 17/356,429, filed Jun. 23, 2021, entitled “MULTISENSORY IMAGING METHODS AND APPARATUS FOR CONTROLLED ENVIRONMENT HORTICULTURE USING IRRADIATORS AND CAMERAS AND/OR SENSORS;” and U.S. application Ser. No. 17/238,044, filed Apr. 22, 2021, entitled “FLUID-COOLED LED-BASED LIGHTING METHODS AND APPARATUS IN CLOSE PROXIMITY GROW SYSTEMS FOR CONTROLLED ENVIRONMENT HORTICULTURE.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a multisensory imaging system according to one inventive implementation.

FIG. 2 illustrates a multispectral imaging system according to one inventive implementation.

FIG. 3 is a block diagram of a multispectral imaging engine according to some implementations of the disclosure.

FIG. 4 is a block diagram of a multispectral imaging engine according to some implementations of the disclosure.

FIG. 5 illustrates a multispectral imaging engine, according to some implementations of the disclosure.

FIG. 6 shows a top, front, left perspective view of the imaging engine of FIG. 5.

FIG. 7 illustrates a multispectral imaging engine, according to some implementations of the disclosure.

FIG. 8 illustrates the multispectral imaging engine of FIG. 7 coupled to a carrier board and a processor.

FIG. 9A illustrates an exploded view of the multispectral imaging engine of FIG. 8 and the carrier board.

FIG. 9B illustrates a side-view of the multispectral imaging engine and carrier board of FIG. 8.

FIG. 9C illustrates a side-view of the multispectral imaging engine coupled to the carrier board via a cable.

FIG. 10 illustrates a circular multispectral imaging engine, according to some implementations of the disclosure.

FIG. 11 illustrates narrowband image calibration of a multispectral imaging system using a reference reflectance target.

FIG. 12 illustrates thermal image calibration of a multispectral imaging system using a blackbody radiator.

FIG. 13 shows constituent narrowband and thermal images collected by a multispectral imaging system, used to create multispectral imagery.

FIG. 14 is a vector of values used as a feature set, according to some implementations of the disclosure.

FIG. 15 shows a reference condition library, according to some implementations of the disclosure.

FIG. 16 shows a block diagram of image processing methodology, according to some implementations of the disclosure.

FIG. 17 shows a block diagram of machine learning algorithm methodology, according to some implementations of the disclosure.

FIG. 18 is a vector of values used as a feature set, according to some implementations of the disclosure.

FIG. 19 shows albedo spectra of various environments in the visible to short wavelength infrared (SWIR) regimes.

FIG. 20 shows the spectral absorbance of various plant-related compounds.

FIG. 21 shows the spectral absorbance of chlorophyl a and chlorophyl b.

FIG. 22 illustrates a multispectral imaging system according to one inventive implementation.

FIG. 23 illustrates a multispectral imaging system in a CEH system.

FIG. 24 illustrates a multisensory imaging system according to one inventive implementation.

FIG. 25 illustrates a 2D sensor grid according to one inventive implementation.

FIG. 26 shows the 2D sensor grid of FIG. 25 in a CEH system according to one inventive implementation.

FIG. 27 is a block diagram of several sensors at a sensor node, according to some implementations of the disclosure.

FIG. 28 shows constituent sensory images compiled from sensor information collected by a multisensory imaging system.

FIG. 29 is a vector of values used as a feature set, according to some implementations of the disclosure.

FIG. 30 shows a reference condition library, according to some implementations of the disclosure.

FIG. 31 illustrates a multisensory imaging system's 3D sensor grid according to one inventive implementation.

FIG. 32A shows a top view of the multisensory imaging system of FIG. 31.

FIG. 32B shows a side view of the multisensory imaging system of FIG. 31.

FIG. 32C shows a front view of the multisensory imaging system of FIG. 31.

FIG. 33 vector of values used as a feature set, according to some implementations of the disclosure.

FIG. 34A shows part of a multisensory imaging system according to one inventive implementation.

FIG. 34B shows another part of the multisensory imaging system shown in FIG. 34A.

FIG. 35 is a block diagram of an imaging engine and several sensors at a sensor node, according to some implementations of the disclosure.

FIG. 36 is a top view of the multisensory imaging system of FIG. 34.

FIG. 37A shows a front view of another exemplary integrated sensor assembly without an irradiation source or a camera.

FIG. 37B shows a bottom, front, left perspective view of the integrated sensor assembly of FIG. 37A.

FIG. 37C shows a left-side view of the integrated sensor assembly of FIG. 37A.

FIG. 37D shows a bottom view of the integrated sensor assembly of FIG. 37A.

FIG. 37E shows a rear view of the integrated sensor assembly of FIG. 37A.

FIG. 37F shows a bottom, rear, left perspective view of the integrated sensor assembly of FIG. 37A.

FIG. 38A shows a front view of another exemplary imaging engine with multiple irradiators and a camera.

FIG. 38B shows a bottom, front, left perspective view of the imaging engine of FIG. 38A.

FIG. 38C shows a left-side view of the imaging engine of FIG. 38A.

FIG. 38D shows bottom view of the imaging engine of FIG. 38A.

FIG. 38E shows a rear view of the imaging engine of FIG. 38A.

FIG. 38F shows a bottom, rear, left perspective view of the imaging engine of FIG. 38A.

FIG. 39A shows a front view of another exemplary imaging engine with multiple irradiators, a camera, and a thermal imager.

FIG. 39B shows a bottom, front, left perspective view of the imaging engine of FIG. 39A.

FIG. 39C shows a left-side view of the imaging engine of FIG. 39A.

FIG. 39D shows bottom view of the imaging engine of FIG. 39A.

FIG. 39E shows a rear view of the imaging engine of FIG. 39A.

FIG. 39F shows a bottom, rear, left perspective view of the imaging engine of FIG. 39A.

FIG. 40A shows a rear view of an exemplary connector on an imaging engine.

FIG. 40B shows a rear perspective view of the connector of FIG. 40A.

FIG. 41A shows a top, front, right perspective view of a circuit board supporting a time-of-flight (TOF) sensor and a light sensor.

FIG. 41B shows a front view of the circuit board of FIG. 41A.

FIG. 41C shows a rear view of the circuit board of FIG. 41A.

FIG. 41D shows a bottom view of the circuit board of FIG. 41A.

FIG. 41E shows a right-side view of the circuit board of FIG. 41A.

FIG. 42A shows a top view of part of a CEH system employing the exemplary imaging engines of FIGS. 37A and 39A.

FIG. 42B shows a bottom view of one light fixture corresponding to Inset A of FIG. 42A where the light fixture includes an imaging engine of FIG. 37A.

FIG. 42C shows a bottom view of one light fixture corresponding to Inset B of FIG. 42A where the light fixture includes an imaging engine of FIG. 39A.

FIG. 43 shows an exemplary block diagram of an imaging engine connected to a lighting fixture.

FIG. 44A shows a first portion of an exemplary circuit diagram for the imaging engine of FIG. 37A.

FIG. 44B shows a second portion of the circuit diagram of FIG. 44A.

FIG. 45 shows a circuit diagram for the circuit board of FIG. 41A

FIG. 46 shows a spectral responsivity for a TCS3400 color sensor.

FIG. 47 shows an example of a nominal spectral power distribution of the PAR generated by a lighting fixture.

FIG. 48 is a vector of values used as a feature set, according to some implementations of the disclosure.

### DETAILED DESCRIPTION

Following below are a glossary of terms and more detailed descriptions of various concepts related to, and implementations of, multisensory methods, apparatus, and systems for controlled environment horticulture. It should be appreciated that various concepts introduced above and discussed in greater detail below may be implemented in numerous ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of multisensory imaging systems, methods of acquiring, processing, and quantifying multisensory imagery, and inventive lighting systems integrated with multisensory imaging systems are provided, wherein a given example showcases one or more particular features in a given context. It should be appreciated that one or more features discussed in connection with a given example of a multisensory imaging system may be employed in other examples according to the present disclosure, such that the various features disclosed herein may be readily combined in a given system according to the present disclosure (provided that respective features are not mutually inconsistent).

### Glossary

Albedo: The term “albedo” refers to the ratio of radiosity from an object to the irradiance (flux per unit area) of an object. Thus, it is a measure of reflection of radiation out of the total radiation impinging on an object, measured on a scale from 0 (corresponding to a black body that absorbs all incident radiation) to 1 (corresponding to a body that reflects all incident radiation). The albedo of an object at a certain wavelength band or spectral region may be measured. For example, UV albedo refers to UV radiation reflected from an object out of the total UV radiation impinging on the object. As another example, narrowband albedo refers to narrowband radiation reflected from an object out of the total narrowband radiation impinging on the object.

Controlled Environment Horticulture: Controlled Environment Horticulture (CEH) (also referred to as controlled environment agriculture or CEA) is the process of growing plants in a controlled environment where various environmental parameters, such as lighting, temperature, humidity, nutrient levels, and carbon dioxide (CO₂) concentrations are monitored and adjusted to improve the quality and yield of the plants. Compared to conventional approaches of plant cultivation, CEH may enable year-round production of plants, insensitivity to variable weather conditions, reduce pests and diseases, and reduce the number of resources consumed on a per plant basis. Additionally, CEH may support various types of growing systems including, but not limited to soil-based systems and hydroponics systems.

A controlled agricultural environment is typically enclosed, at least in part, by a building structure such as a greenhouse, a grow room, or a covered portion of a field in order to provide some degree of control over environmental conditions. One or more artificial lighting systems are often used in such controlled agricultural environments to supplement and/or replace natural sunlight that may be obstructed by the building structure or insufficient during certain periods of the year (e.g., winter months). The use of an artificial lighting system may also provide yet another measure of control where the intensity and spectral characteristics of the lighting system may be tailored to improve the photosynthetic rates of plants. Various types of artificial lighting systems may be used including, but not limited to, a high intensity discharge lamp, a light emitting diode (LED), and a fluorescent lamp.

Emissivity: “emissivity” is a measure of an object's ability to emit infrared energy. Emitted energy indicates the temperature of the object. Emissivity can have a value from 0 (shiny mirror) to 1 (blackbody).

Feature/Labeled Feature Set: a “feature” is a structured mathematical representation of a discrete measured value that is suitable for input into a machine learning system. Features determine what information a machine learning algorithm has access to regarding the measurement. A plurality of different discrete measurements may be used to develop a “labeled feature set” for a reference condition.

Field of View: a “field of view” refers to an area or footprint of inspection in which a measurement of some measurable property may be captured by one or more sensors/cameras.

Hyperspectral Imaging: “hyperspectral imaging” is an imaging technique that collects and processes a wide spectrum of radiation (either continuous or many discrete measurements) for each pixel in the plurality of pixels in the resulting image. Unlike multispectral imaging, which measures finite, non-continuous narrowbands, hyperspectral imaging measures continuous ranges of wavelengths over a wide spectrum.

Illuminator: an “illuminator” is a radiation source, such as an LED, that is not primarily used to provide radiation for sensing, in contrast to an irradiator. An illuminator may, for example, provide ambient lighting in an enclosed structure, or provide photosynthetically active radiation (PAR) in a CEH system.

Irradiator: an “irradiator” is a radiation source, such as an LED, that primarily provides light for sensing. For example, a series of narrowband irradiators may be used to irradiate an object to collect multispectral images of the object.

Multisensory Imaging: “multisensory imaging” is an imaging technique that collects and processes a plurality of imagery and sensory data to create a multisensory image, where each pixel in the plurality of pixels in the resulting image contains finite narrowband spectral data as well as sensory data. Each pixel in the resulting image may be close or far apart in any dimension.

Multispectral Imaging: “multispectral imaging” is an imaging technique that collects and processes a plurality of finite, non-continuous narrowband images, where each pixel in the plurality of pixels in the resulting image contains finite narrowband spectral data.

Narrowband/Narrowband Image: a “narrowband” is a narrow wavelength band of radiation with a bandwidth of about 2 nm and 40 nm. A narrowband image is an image captured using one or more narrowbands.

Normalize/Normalization: The terms “normalize”, or “normalization” refer to a process of modifying one or more disparate pieces of data relating to a same or similar thing, such that all of the pieces of data relating to the same or similar thing are homogenized in some manner (e.g., according to a predetermined standard or format).

Pixel: a “pixel” is the smallest element of an image that can be individually processed in an image. An image includes at least one pixel. Generally, each pixel in an image represents a radiation value at a spatial position in the field of view. Each pixel in an image may be close (neighboring) or far apart (with unmeasured space in between) in any dimension.

Radiation Value: a “radiation value” represents an amount of sensed radiation at a particular wavelength or spectral band. Each pixel in an image may be digitally represented by a radiation value. For example, a radiation value may be an amplitude of radiation at a particular narrowband reflected from an object within a camera's field of view. As another example, a radiation value may be an amplitude of fluorescence from an object within a camera's field of view.

Reference Condition/Reference Condition Library: a “reference condition” is a known condition for which a labeled feature set exists in a reference condition library. Examples of reference conditions for crops may include particular types of nutrient deficiency, insect infestation, fungal infection, or water stress. Other examples of reference conditions for crops may include stage of development, prospective crop yield, appearance, nutritional composition, structural integrity, flowering, and pollination. Reference conditions are not limited to crops and may describe known conditions of other objects in different environments. A reference condition library includes more than one labeled feature sets for various reference conditions. A machine learning algorithm may be used to compare experimental results to the reference condition library to determine if one or more reference conditions are present.

Overview of Multisensory Imaging Systems and Methods

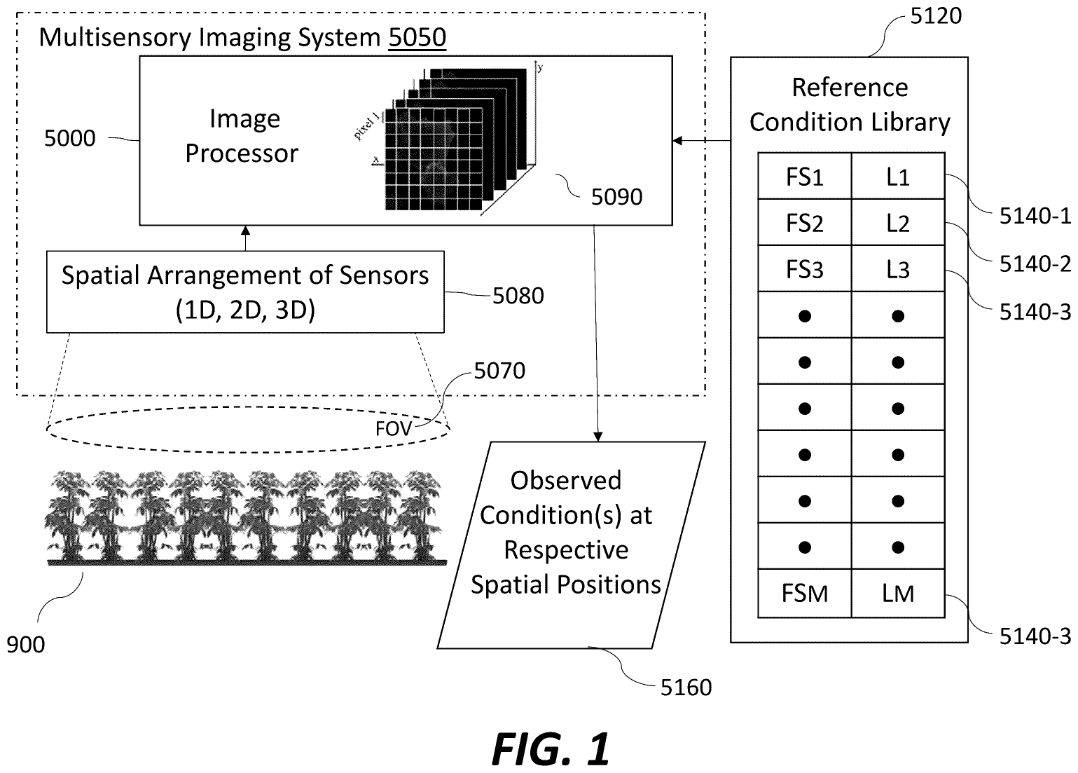

FIG. 1 illustrates a block diagram of a multisensory imaging system 5050 according to one inventive implementation. As shown in FIG. 1, the multisensory imaging system 5050 includes a spatial arrangement of sensors 5080 having a collective field of view 5070 (FOV). For purposes of the present discussion, a “field of view” refers to an area or volume of inspection in which one or more conditions or properties may be sensed (e.g., acquired or captured by one or more sensors) to provide a representative value for each sensed condition/property. Thus, within the field of view 5070, multiple measurable conditions may be sensed by respective sensors of the spatial arrangement of sensors 5080.

In the depiction of FIG. 1, the field of view 5070 of the spatial arrangement of sensors 5080 includes one or more plants 900. As noted above and discussed further below, the plants 900 may be within a building structure (e.g., a greenhouse, an enclosed grow room or container, a cover for at least a portion of a field) that provides a controlled horticultural environment. Alternatively, the field of view 5070 of the spatial arrangement of sensors may include one or more plants or other vegetation in an open grow space or field (e.g., exposed to natural ambient light), or other object(s) of interest for which various conditions may be measured. In view of the foregoing, it should be appreciated the multisensory imaging system 5050 not only has utility and advantages in the context of CEH, but more generally may be employed to generate and process images of a wide variety of objects/environments of interest based on one or more measurable conditions, according to the concepts disclosed herein.

As discussed in greater detail below in connection with different implementation examples, the spatial arrangement of sensors 5080 may comprise a one-dimensional (1D), two-dimensional (2D), or three-dimensional (3D) array of sensor nodes. In one aspect, a given sensor node may be considered to be a picture element or “pixel” of an image of the field of view 5070, e.g., an element that is indexed (or “addressable”) in the 1D, 2D, or 3D array of sensor nodes. With the foregoing in mind, it should be appreciated that, generally speaking, the spatial arrangement of sensors thus may include a number of discrete sensors (or integrated sensor assemblies) positioned at respective indexed/addressable positions (pixels) in a 1D, 2D, or 3D spatial arrangement. Some examples of a 2D spatial arrangement of sensors that may constitute the spatial arrangement of sensors 5080 include a CCD, CMOS or microbolometer sensor array (the “imaging chip”) of a digital camera, as discussed in greater detail below.

With reference again to FIG. 1, at a given sensor node (or pixel) of a 1D, 2D or 3D array constituting the spatial arrangement of sensors 5080, one or more sensors may be positioned so as to measure at least two different measurable conditions at the given sensor node. Thus, each measurable condition that is sensed at a given sensor node can be represented as a pixel value of a pixel in an image of the field of view 5070. Accordingly, since at least two different measurable conditions may be sensed at a given sensor node, a given pixel of an image of the field of view 5070 may have at least two pixel values respectively representing the at least two different measurable conditions.

As shown in FIG. 1, the multisensory imaging system 5050 also comprises an image processor (5000), coupled to the spatial arrangement of sensors 5080, to process sensed conditions at respective sensor nodes (e.g., represented by one or more pixel values at respective pixels of one or more images of the field of view 5070). In one example implementation, the image processor 5000 is configured to process sensed conditions and generate multiple “mono-sensory” images 5090 respectively corresponding to the two or more different sensed conditions in the field of view 5070.

More specifically, as readily observed in FIG. 1, each mono-sensory image of the multiple mono-sensory images 5090 is depicted as a 2D array of pixels arranged along an x-axis and a y-axis and representing a different condition of the two or more sensed conditions in the field of view 5070. Thus, each pixel in a given mono-sensory image is digitally indexed (or “addressed”) by pixel coordinates representing a spatial position in the field of view where a particular condition was sensed. Each pixel of the mono-sensory image also has a pixel value (a “measurement value”) representing the sensed condition at that spatial position.

In the example of FIG. 1, the image processor 5000 is configured to process the plurality of mono-sensory images 5090, based at least in part on respective pixel values in the plurality of images 5090 and a reference condition library 5120, to estimate or determine (e.g., with significant confidence or sufficient probability) one or more environmental conditions of interest 5160 observed at respective spatial positions in the field of view 5070. The estimated or determined environmental condition(s) of interest 5160 may relate to one or more states or conditions of one or more objects at a given spatial position (e.g., multiple plants, a single plant, or a particular part of a plant), identification of substances or compounds present in one or more objects at a given spatial position, and/or one or more ambient conditions at a given spatial position (e.g., ambient conditions proximate to one or more plants or other objects in field of view).

To this end, in one implementation the image processor 5000 processes the plurality of mono-sensory images 5090 to generate a multisensory image, wherein respective pixels of the multisensory image may have multiple pixel values (measurement values) respectively representing the two or more measurable conditions that were sensed at a given spatial position. For example, considering for the moment a 2D array of sensor nodes and corresponding 2D array of pixels in an image of the field of view 5070, the notation below represents a first pixel P₁ (x₁, y₁), in which a first measurable condition C₁ that may be sensed in the field of view has a first measurement value M₁ at the first pixel P₁, and in which a second measurable condition C₂ that may be sensed in the field of view has a measurement value M₂ at the first pixel P₁:

P₁(x₁,y₁)=[M₁,M₂].

With the foregoing in mind, the reference condition library 5120 may include multiple labeled feature sets 5140 (a “collection” of labeled feature sets) respectively corresponding to various reference conditions of prospective interest in the field of view 5070 (some of which reference conditions may relate to an object or objects and others of which reference conditions may relate to states of the ambient) which depend, at least in part, on the two or more measurable conditions at respective spatial positions in the field of view. For example, the reference condition library 5120 may include a first labeled feature set 5140-1 representing a first reference condition and including a first feature set FS₁ having a first label L₁. Similarly, the reference condition library 5120 may include a second labeled feature set 5140-2 representing a second reference condition and including a second feature set FS₂ having a second label L₂, and may further include a third labeled feature set 5140-3 representing a third reference condition and including a third feature set FS₃ having a third label L₃, and so on (in FIG. 1, the reference condition library 5120 is shown as containing a collection 5140 of M labeled feature sets, where M is virtually any number of prospectively useful reference conditions of interest).

Each feature set FS₁, FS₂, FS₃ . . . FS_{M} in the collection 5140 of labeled feature sets represents a set of “features,” in which at least some respective features in the set correspond to respective measurable conditions that may be sensed by the spatial arrangement of sensors 5080. For each such feature, the feature set includes a reference value corresponding to one measurable condition of the respective measurable conditions. Thus, if as discussed above, a first measurable condition C₁ may be sensed at a given spatial position in the field of view 5070 and a second measurable condition C₂ also may be sensed at the given spatial position in the field of view 5070, respective feature sets FS₁, FS₂, FS₃ . . . FS_{M} in the collection 5140 of labeled feature sets include particular (and unique) combinations of reference values for the features C₁ and C₂ that, as a feature set, together represent the reference condition serving as the label for the feature set. Table 1 below provides some illustrative examples of a collection 5140 of labeled feature sets based at least in part on the measurable conditions C₁ and C₂, and corresponding example labels for reference conditions of prospective interest:

| | |
|---|---|
| FS₁ = [C₁, ₁; C₂, ₁] | L₁ = nitrogen deficiency |
| FS₂ = [C₁, ₂; C₂, ₂] | L₂ = aphid infestation |
| FS₃ = [C₁, ₃; C₂, ₃] | L₃ = bud break |
| • | • |
| • | • |
| • | • |
| FS_{M} = [C₁, _{M}; C₂, _{M}] | L_{M} = labeled condition |

In one implementation, the image processor 5000 employs a variety of image processing and machine learning (ML) techniques to process a multisensory image to estimate or determine one or more environmental conditions of interest 5160 observed at respective spatial positions in the field of view 5070, based on the collection 5140 of labeled feature sets in the reference condition library 5120. In some implementations, various models are trained and utilized by the image processor 5000 to process multisensory images and “find” in those images one or more conditions that match, with a certain level of confidence, one or more corresponding reference conditions represented by the collection 5140 of labeled feature sets in the reference condition library 5120.

In some implementations, the various models estimate or determine one or more environmental conditions of interest 5160 observed at respective spatial positions in the field of view 5070 using measurement values at a pixel of interest. In other implementations, the various models sample measurement values in pixels adjacent to or in proximity to the pixel of interest, in addition to sampling measurement values at the pixel of interest, to estimate or determine one or more environmental conditions of interest 5160.

As would be appreciated by those of skill in the relevant arts, Machine learning (ML) is a branch of artificial intelligence based on the idea that systems (e.g., intelligent agents, like the image processor 5000) can learn from data, identify patterns, and make decisions with minimal human intervention. Thus, ML relates to algorithms and statistical models that intelligent agents (e.g., the image processor 5000) use to progressively improve their performance on a specific task. In more formal terms, an intelligent agent based on an ML model learns from experience E with respect to some class of tasks T and performance measure P if its performance at tasks in T, as measured by P, improves with experience E. Deep learning is a subset of AI using layered structures of algorithms called an artificial neural network (ANN).

Machine learning tasks conventionally are classified into multiple categories. In “supervised learning,” an ML algorithm builds a mathematical model of a set of “training data” that contains both the inputs and the desired outputs from performing a certain task. For example, if the task were determining whether an image contained a certain object having a condition that corresponded to a reference condition of interest, the training data for a supervised learning algorithm may include a first image or images of the object having the particular condition of interest and a second image or images of the object not having the condition of interest (the input), and each image would have a label (the output) designating whether or not the object had the condition of interest. “Semi-supervised learning” algorithms develop mathematical models from incomplete training data, where a portion of the sample inputs are missing the desired output. “Classification” algorithms and “regression” algorithms are types of supervised learning. Classification algorithms are used when the outputs are restricted to a limited set of values (e.g., represented by the Boolean values one and zero), whereas regression algorithms have continuous outputs (e.g., any value within a range of values).

In “unsupervised learning,” an ML algorithm builds a mathematical model of a set of data which contains only inputs and no desired outputs. Unsupervised learning algorithms are used to find structure in the data, like grouping or clustering of data points. Unsupervised learning can discover patterns in the data, and can group the inputs into categories, as in “feature learning.” “Dimensionality reduction” is the process of reducing the number of “features” (e.g., inputs) in a set of data. “Active learning” algorithms access the desired outputs (training labels) for a limited set of inputs based on a budget and optimize the choice of inputs for which it will acquire training labels. When used interactively, these inputs can be presented to a human user for labeling (“annotation”).

Examples of various ML models known in the relevant arts include, but are not limited to, Linear Regression, Logistic Regression, Decision Tree, Support Vector Machine, Naive Bayes, kNN, K-Means, Random Forest, Convolution Neural Network, Multilayer Perceptron, and Recurrent Neural Network.

Accordingly, it may be appreciated from the foregoing that a multisensory imaging system may be implemented for a variety of applications and, in particular, CEH. As discussed in different examples below, a multisensory imaging system according to the concepts disclosed herein may be implemented to cover various sizes (and shapes) of fields of view 5070, and differing degrees of resolution for a spatial arrangement of sensors—in these respects, it should be appreciated that the general concepts underlying multisensory imaging systems disclosed herein are agnostic to the size/scale of field of view and resolution of images and, as such, may be implemented so as to cover different sizes/scales of fields of view with various resolution. With respect to CEH, multisensory imaging systems according to the present disclosure may be employed to observe groups of crops, individual plants, or parts of plants, over various periods of time, to provide a wealth of information about the evolution of crops and their growing environment.

An Exemplary Multispectral Imaging System

In one example implementation, a multisensory imaging system according to the present disclosure is implemented more specifically as a multispectral imaging system that provides finite spectra sensing. In this manner, the imaging system may detect the presence and/or quantify reference conditions. These reference conditions may have a time-dependence and/or a spatial distribution within an environment. In another implementation, the imaging system may be integrated into a CEH system. In this manner, the multisensory imaging system may detect the presence and/or quantify certain reference conditions present in the CEH system.

The imaging system may be used to characterize reference conditions of objects within an environment. These reference conditions may, for example, be related to the growth and/or health of plants in an environment as a function of time. This may be accomplished, in part, by using the imaging system by itself or in conjunction with one or more light sources and/or illuminators to irradiate plants and/or other subjects of interest with different wavelengths or wavelength bands of radiation and using imagers/sensors to measure the spectral optical properties of the plants and/or other subjects of interest in their surroundings over time, in response to irradiation at different wavelengths. The foregoing process may be referred to as “kinetic finite absorbance and reflectance spectroscopy,” in which different finite narrowband spectral images and/or other information are collected for plants and/or other subjects of interest in response to irradiation at particular wavelengths, as a function of time, and then the acquired images/collected information are analyzed to determine conditions in the plants and/or other subjects of interest.

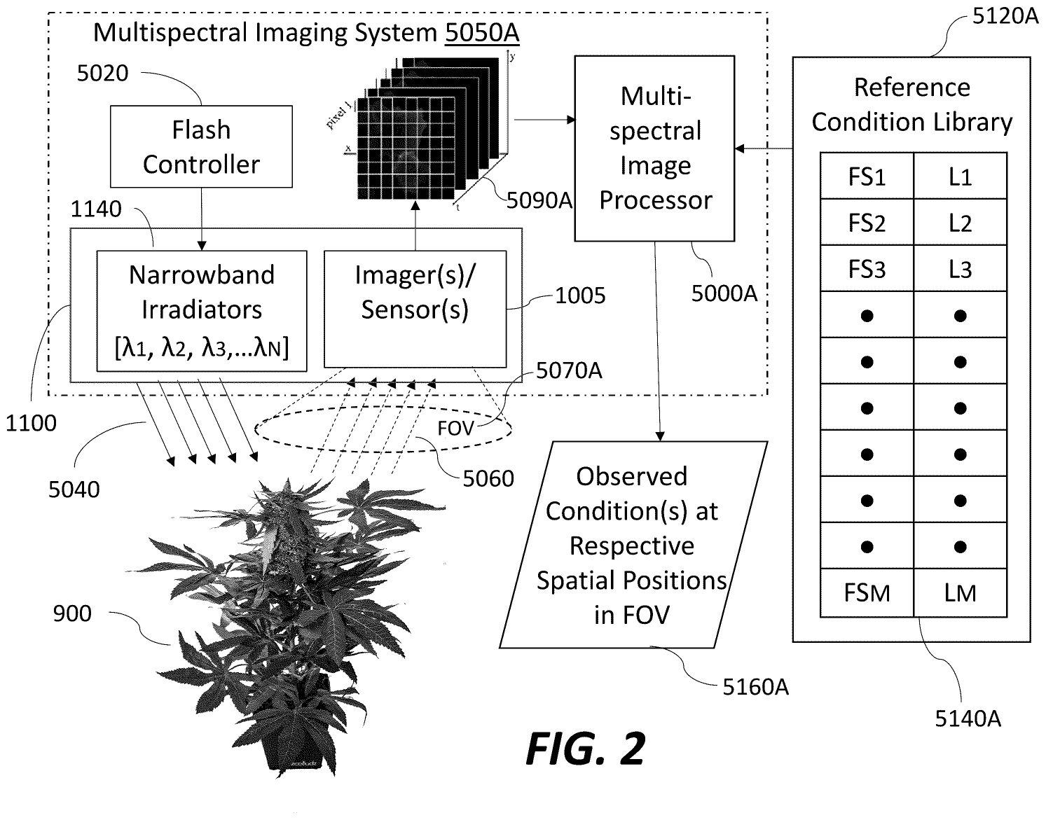

FIG. 2 shows an exemplary implementation of a multispectral imaging system 5050A that can acquire imagery 5090A and/or sensory data at various wavelengths of interest. The system may generally include at least one flash controller 5020, at least one narrowband irradiator 1140 to emit narrowband radiation 5040, at least one imager/sensor 1005 to acquire imagery 5090A and/or collect measurements, at least one image processor 5000A (processor 5000A) to process the acquired imagery 5090A and/or collected measurements to determine the presence of an observable condition 5160A using a reference condition library 5120A. The narrowband irradiators 1140 and imager(s)/sensor(s) 1005 may be integrated into an imaging engine module 1100.

The flash controller 5020 (e.g., a microprocessor) may regulate the narrowband irradiators 1140. The flash controller 5020 may be configured so that each narrowband irradiator in the imaging system 5050A can be individually controlled. The flash controller 5020 may also be configured so that each narrowband irradiator can be activated for a brief period. In this manner, the flash controller 5020 may provide a means to sequentially flash or pulse each narrowband irradiator in the plurality of narrowband irradiators 1140. In some implementations, the flash controller may be configured so that more than one narrowband irradiator may be activated for at a time. In this manner, the flash controller 5020 may provide a means to flash or pulse narrowband irradiators together or separately.

The flash controller 5020 may be programmed to automatically activate one or more narrowband irradiators 1140 at set time intervals, or at certain times of day, for a set period of time. The flash controller 5020 may also be configured to receive communications from a remote device (e.g., a computer, a server, a tablet, or a smartphone) to determine narrowband irradiator control.

The flash controller 5020 and/or the image processor 5000A (e.g., a Raspberry Pi processor) may include one or more WiFi antennas and accompanying electric circuits (e.g., chipsets, processors) to facilitate wireless communication with the narrowband irradiators 1140 and other devices. In some implementations, the flash controller 5020 and/or the image processor 5000A may include a transmitter and/or a receiver to communicate with one or more lighting fixtures, environmental controllers, or remote devices (e.g., a computer, a server, a tablet, a smartphone, or lighting fixture controllers). In some implementations, the flash controller 5020 and/or the image processor 5000A may be communicatively coupled with one or more lighting fixtures or environmental controllers via one or more cable-type couplers. In these manners, the flash controller 5020 and/or the image processor 5000A may control and/or coordinate with the lighting fixtures or other environmental controllers so that the imaging system 5050A can acquire images and/or collect information in a particular environmental setting. For example, the flash controller 5020 and/or the image processor 5000A may be configured to activate narrowband irradiators 1140 under dark conditions with the lighting fixtures turned off momentarily while measurements/images are acquired by the imaging system 5050A. As another example, the flash controller 5020 or the image processor 5000A may be configured to stop HVAC or fan operation during image acquisition so that objects are as still as possible.

The flash controller 5020 and/or the image processor 5000A may include a receiver to receive a signal from a remote device (e.g., a computer, a server, a tablet, a smartphone, or a lighting fixture controller), which may include a command to adjust the operation of the narrowband irradiators 1140. Commands may include, but are not limited to, adjusting the time interval between images acquired and/or information sensed, the length of time of irradiation, the intensity of irradiation, the order of irradiation if more than one narrowband irradiator is to be flashed, and/or determining which irradiators are activated for a particular measurement/acquisition.

The flash controller 5020 and/or the image processor 5000A may supply power to the irradiator. The flash controller 5020 and/or the image processor 5000A may receive electrical power directly from an electrical power grid, or indirectly from another device. For example, the flash controller 5020 and/or the image processor 5000A may receive electrical power from one or more lighting fixtures, or via a portable energy storage device, such as a rechargeable battery.

The flash controller 5020 and/or the image processor 5000A may also regulate the one or more imagers/sensors 1005 so that the imagers/sensors acquire imagery and/or collect measurements at times relevant to irradiation. As an example, the flash controller 5020 and/or the image processor 5000A may simultaneously activate a narrowband irradiator and an imager so that imagery is acquired while the narrowband irradiator is activated. In another example, the flash controller 5020 and/or the image processor 5000A may activate the narrowband irradiator and the imager at different times. The imager may acquire imagery after the narrowband irradiator has been activated. In another implementation, the narrowband irradiators 1140 may be controlled by the flash controller 5020 and the imagers/sensors 1005 may be controlled by the processor 5000A. In this manner, the flash controller 5020 and the image processor 5000A may be coupled to coordinate the activation times of the irradiators 1140 and the imagers/sensors 1005.

The narrowband irradiators 1140, controlled by the flash controller 5020, provide radiation at wavelengths within one or more spectral ranges including the UV band (e.g., wavelengths between 10 nm and 400 nm), the visible band (e.g., wavelengths between 400 nm and 700 nm), the near infrared (NIR) band (e.g., wavelengths between 700 nm and 1.4 μm), the mid infrared (MIR) band (e.g., wavelengths between 1.4 μm and 8 μm), and the far infrared (FIR) band (e.g., wavelengths greater than 8 μm). Each narrowband irradiator may provide relatively narrowband radiation. For example, the spectral bandwidth may be about 2 nm to about 40 nm. In another implementation, each narrowband irradiator may provide substantially monochromatic radiation. The narrowband irradiators 1140 may be configured to turn on or off quickly and/or to respond quickly to signals from the flash controller 5020, so that each narrowband irradiator may provide a brief flash or pulse of radiation. Each brief flash may be up to 10 seconds in length.

In some implementations, the narrowband irradiators 1140 may be an array of LEDs elements. The spectral range of the LED array may include approximately 275 nm to approximately 4600 nm. In this manner, respective wavelengths of essentially monochromatic LED elements may include, but are not limited to, 275 nm, 365 nm, 440 nm, 450 nm, 475 nm, 500 nm, 530 nm, 620 nm, 630 nm, 660 nm, 696 nm, 730 nm, 760 nm, 850 nm, 860 nm, 940 nm, 950 nm, 1450 nm, 1610 nm, 2060 nm, and 4600 nm. More than one LED element of a particular wavelength may be position around the imager/sensor 1005 to provide more uniform irradiation. For example, LED elements of a particular wavelength may be positioned on opposing sides of the imager/sensor 1005.

The irradiation profile for different narrowband irradiators may be substantially uniform. In some implementations, an optical element, such as a diffuser, or lens may be used to change the irradiation profile. In some implementations, each narrowband irradiator may provide radiation to substantially the same area. In this manner, the narrowband irradiators 1140 irradiating area may overlap with at least part of the collective field of view 5070A of the imagers/sensors 1005.

The narrowband irradiators 1140 may provide radiation to image and/or acquire information from one or more plants 900 or plant zones. In some implementations, it may be preferable for the narrowband irradiators 1140 to emit radiation with a sufficient intensity to acquire images/information at a desired quality (e.g., the signal-to-noise ratio of the image/information is above a pre-defined threshold) without causing chemical and/or morphological changes to the plant(s) (e.g., photomorphogenesis). In this manner, the various images/information acquired by the imager(s)/sensor(s) 1005 are representative of the plant(s) in their non-illuminated state. For example, LED irradiators 1140 may have a wattage rating less than about 6 Watts (the wattage rating may be correlated to the radiation output from the LED irradiators).

In some implementations, the narrowband irradiators 1140 may activate as a flash or brief pulse with a sufficient length to acquire images/information at a desired quality. This may be preferable in cases where it is desirable to reduce the time to acquire multiple images (e.g., ensuring the images are acquired at the same conditions). Short flashes may also prevent unwanted photochemical modifications to the plant, which may alter its optical properties.

The imaging system 5050A may generally include one or more imagers and/or one or more sensors 1005 to acquire imagery, video and/or spectra, respectively, of an object and/or an environment. In some implementations, the imagers/sensors 1005 may acquire imagery and/or sensory data from an object and/or an environment within a field of view 5070A of the imagers/sensors. In general, the imagers/sensors may acquire 2D imagery and/or 3D imagery (e.g., Lidar, a pan-tilt-zoom (PTZ) camera) of the environment. The camera/sensor may also have a field of view that ranges between a portion of the environment that includes one or more plants to an entire room of the environment. Note the environment may contain multiple rooms.

The imagers/sensors may acquire imagery and/or sensory data in response to irradiation of a plant zone 900 in a CEH system by the narrowband irradiators 1140. In some implementations, the imagers/sensors 1005 may acquire imagery and/or sensory data while one or more narrowband irradiators is activated. In some implementations, the imagers/sensors 1005 may acquire imagery and/or collect information immediately following irradiation by one or more narrowband irradiators 1140.

In some implementations, the imagers/sensors 1005 may acquire imagery and/or sensory data from plants 900 within a field of view 5070A without irradiation of the plant by the narrowband irradiators 1140. For example, images/sensory data may be collected using emitted radiation from plants 900 without any irradiation. As another example, images/sensory data may be collected using other sources of irradiation in the CEH system, such as lighting fixtures emitting photosynthetically active radiation, or sunlight.

The imager(s)/sensor(s) 1005 may generally acquire imagery/spectra at wavelengths in the UV, visible, NIR, SWIR, and LWIR regimes. For example, the imagers/sensors 1005 may include cameras that acquire imagery in various spectral bands including, but not limited to the ultraviolet band (e.g., wavelengths between 10 nm and 400 nm), the visible band (e.g., wavelengths between 400 nm and 700 nm), the near infrared (NIR) band (e.g., wavelengths between 700 nm and 1.4 μm), the mid infrared (MIR) band (e.g., wavelengths between 1.4 μm and 8 μm), and the far infrared (FIR) band (e.g., wavelengths greater than 8 μm). The imagers/sensors may preferably acquire imagery/spectra at wavelengths between approximately 275 nm to approximately 2060 nm and between approximately 8 μm to approximately 14 μm. In some implementations, the imaging system 5050A may include a first camera to acquire imagery from the UV to short wavelength infrared (SWIR) regimes and a second camera to acquire thermal imagery using the long wavelength infrared (LWIR) regime. In some implementations, the second camera may continually acquire LWIR thermal imagery while the first camera is periodically activated in combination with the narrowband irradiators 1140 to acquire UV-SWIR imagery.

The imaging system may acquire imagery/spectra under various lighting conditions. As described above, imagery may also be acquired while other radiation sources in the environment are deactivated. For example, light sources in a lighting fixture may be turned off while acquiring imagery/spectra with the imaging system. In some implementations, imagery may be acquired while other radiation sources are active. In some implementations, a background subtraction may be applied to remove the radiation emitted by the other radiation sources.

In some implementations, one or more of the imagers may be cameras with sufficiently high pixel resolution (e.g., an 8-megapixel camera, imagery is acquired at 4K resolution). The imager(s)/sensor(s) may also have a spectral resolution between about 2 nm to about 40 nm. In other implementations, two or more imagers/sensors with different spectral resolutions may be used.

The imager(s)/sensor(s) 1005 may acquire the spectral information from an object and/or an environment within the field of view 5070A at different wavelengths by adjusting the wavelength of light irradiating plants 900 in a growing zone. For example, the narrowband irradiators 1140 may illuminate the plants 900 with substantially monochromatic radiation 5040, the imagers/sensors 1005 may acquire images and/or spectra corresponding to reflected light 5060 reflected from the plants 900, thus the imagery/spectra 5090A acquired may correspond to the particular wavelength of the radiation. This process may be repeated sequentially with radiation with several narrowband irradiators 1140. In this manner, the imaging system 5050A may acquire a series of narrowband images, each narrowband image corresponding to a particular narrowband irradiation 5040. Here, the imagers/sensors 1005 may acquire multisensory imagery without the use of spectral filters.

The imagery and/or sensory data collected by the imaging system 5050A may include at least one pixel, where a pixel is the smallest element that can be individually processed. A narrowband image may include a plurality of pixels, where each pixel in the narrowband image represents a radiation value at a spatial position in the field of view 5070. As discussed in greater detail below in An Exemplary Multispectral Imaging System Using a Distributed Sensor Grid, data collected from point sensors may represent single pixels.

The imaging system 5050A may include one or more image processors 5000A. The image processor 5000A may be coupled to the imagers/sensors 1005 to receive imagery and sensory data 5090A acquired by the imagers/sensors 1005. In some implementations, the image processor 5000A may process several narrowband images 5090A to produce a multispectral image. In some implementations, the image processor 5000A may process imagery and/or sensory data to observe one or more conditions 5160A at respective spatial positions in the field of view 5070A. A reference condition library 5120A and/or an algorithm may be used to observe conditions 5160A in the imagery and/or sensory data. Image processing may extract morphological data from the acquired imagery and/or sensory data and integrate it for a wide range of applications. These concepts are described in greater detail below.

In some implementations, the camera(s)/sensor(s) 1005 may be configured to acquire sensory data proximate to the portion of the plants and/or other subjects of interest in the environment in the CEH system irradiated by the narrowband irradiators 1140. In some example implementations employing multiple imagers/sensors 1005, the multiple imagers/sensors 1005 may be co-located (e.g., in sufficient proximity to one another) such that the respective fields of view (FOV) of the cameras and/or sensors are substantially overlapping or substantially the same. In this manner, different types of sensory data may correspond to the same region of the environment, thus enabling a more comprehensive analysis of the environment. In some implementations, the portion of the plants and/or other subjects of interest irradiated by the narrowband irradiators 1140 may be further subdivided into subregions that are each characterized by corresponding sets of cameras/sensors 1005 disposed on/integrated in the imaging engine 1100.

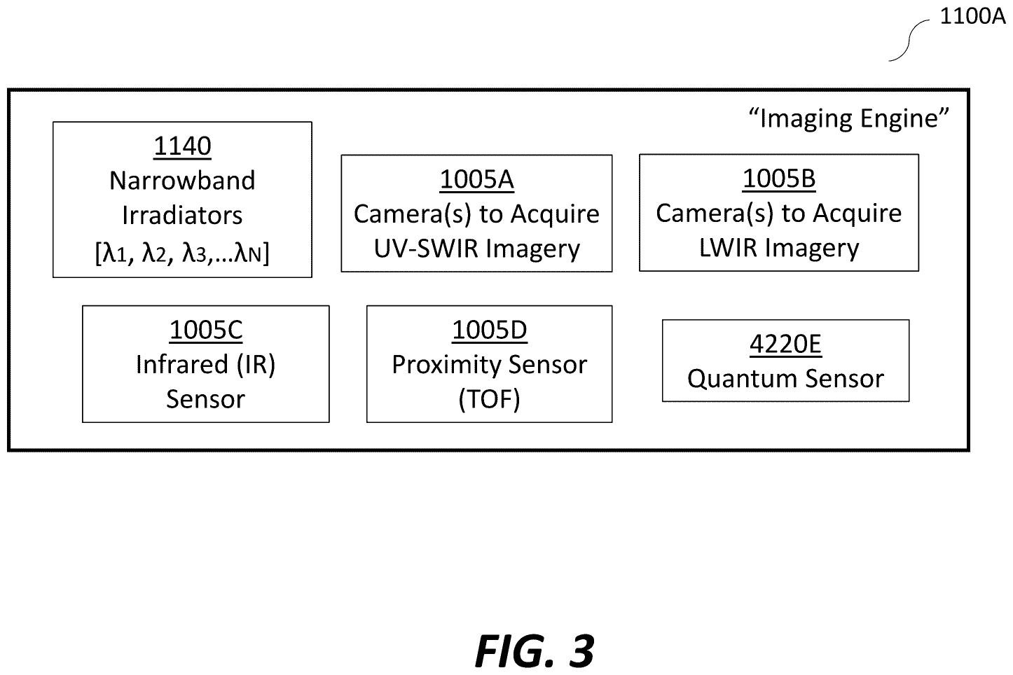

FIG. 3 shows a block diagram of a multispectral imaging engine 1100A according to an inventive implementation. The narrowband irradiators 1140 and imager(s)/sensor(s) 1005 may be integrated into an imaging engine module 1100A. In some implementations, one or more of the components of the imaging engine 1100A are packaged together as a module for ease of assembly and/or installation. The module may also protect various components from exposure to water and/or moisture in the environment.

The imaging engine 1100A may include one or more cameras, other imaging devices (e.g., a thermal imager), or other sensors (collectively referred to with reference number 1005) disposed in or on (integrated with) the imaging engine 1100A. The imager(s)/sensor(s) 1005 may be used to acquire various information about the agricultural environment including, but not limited to imagery (video imagery or still imagery, as well as thermal imagery) of the plants and/or other subjects of interest in the environment in the CEH. Examples of various types of sensors that may be included in the imager(s)/sensor(s) 1005 include, but are not limited to, one or more cameras responsive to radiation in a range of at least visible wavelengths and/or IR wavelengths, an air temperature sensor, a near infrared (NIR) leaf moisture sensor, a relative humidity sensor, a hyperspectral camera, a carbon dioxide sensor, an infrared (IR) leaf temperature sensor, an airflow sensor, and a root zone temperature sensor.

In some implementations, the imaging engine 1100A in FIG. 3 may include camera(s) to acquire UV-SWIR imagery 1005A, cameras to acquire LWIR thermal imagery 1005B, an infrared (IR) sensor 1005C, and a proximity sensor (TOF) 1005D. The imaging engine 1100A may additionally include other sensors, such as a quantum sensor 4220E. The proximity sensor may be a laser range finder. The proximity sensor (TOF) is used to measure the distance from the imaging engine to the plants in the zone/FOV and may be used to construct 3D images. The quantum sensor is used to measure PAR at various points within the CEH, including but not limited to at the canopy level, above the canopy and PAR light reflect at the lighting fixture level. The IR sensor is used to measure surface temperature at a point.

One example of the camera/sensor 1005A includes, but is not limited to, the Raspberry Pi Camera Module v2. The v2 Camera Module has a Sony IMX219 8-megapixel sensor and may be used to acquire high-definition video and/or still photographs. The sensor supports 1080p30, 720p60, and VGA90 video modes in addition to still capture. The sensor attaches to the camera serial interface (CSI) port on the Raspberry Pi via a 15 cm ribbon cable. The camera works with various Raspberry Pi models including, but not limited to the Raspberry Pi 1, 2, and 3 (image processor 5000A). The camera 1005A may be accessed and controlled using the multimedia abstraction layer (MMAL) and video for Linux (V4L) API's. Additionally, numerous third-party software libraries may be used to control the camera 1005A in various software environments (e.g., Python using the Picamera Python library).

Another example of the camera/′sensor 1005A includes, but is not limited to, the infrared Camera Module v2 (Pi NoIR). The v2 Pi NoIR has a Sony IMX219 8-megapixel sensor, which is the same as the camera used in the Raspberry Pi Camera Module v2. The difference is that the Pi NoIR does not include an infrared filter (NoIR=No Infrared) and is thus able to acquire imagery of at least a portion of the infrared spectrum (e.g., NIR), In some implementations, the Pi NoIR may be used together with a square of blue gel to monitor the health of green plants. Similar to the Pi Cam, the Pi NoIR may with various Raspberry Pi models including, but not limited to the Raspberry 1, 2, and 3 (image processor 5000A), Also, the Iii NoIR camera may also be accessed and controlled in software using the MMAL and V4L API's as well as third-party libraries (e.g., Python using the Picamera Python library).

The camera/sensor 1005B may be a longwave IR thermal imager responsive to wavelengths in a range from approximately 8 micrometers to approximately 14 micrometers (LWIR). One example of such a thermal imager includes, but is not limited to, the FLIR Lepton 3.5 micro thermal imager, which provides 160×120 pixels of calibrated radiometric output.

One example of the IR single point sensor 1005C includes, but is not limited to, the Melexis MLX90614 infrared thermometer for non-contact temperature measurements. An IR sensitive thermopile detector chip and the signal conditioning application-specific integrated circuit (ASIC) are integrated in the same TO-39 can. The MLX90614 also includes a low noise amplifier, 17-bit analog-digital converter (ADC), and a powerful digital signal processor (DSP) unit to achieve a high accuracy and resolution for the thermometer. The thermometer may be factory calibrated with a digital SMBus output providing access to the measured temperature in the complete temperature range(s) with a resolution of 0.02° C. The digital output may be configured to use pulse width modulation (PWM). As a standard, the 10-bit PWM is configured to continuously transmit the measured temperature in range of −20° C. to 120° C., with an output resolution of 0.14° C.

One example of the proximity sensor 1005D includes, but is not limited to, the VL53L1X time-of-flight proximity sensor. This sensor is a single point laser rangefinder with a field of view of 27°. The proximity sensor has a 940 nm emitter and a single photon avalanche diode. It has a programmable region-of-interest (ROI) size on the receiving array, allowing the sensor field of view to be reduced. The programmable ROI position on the receiving array provides multizone operation.

One example of the quantum sensor 4220E includes, but is not limited to, an Apogee SQ-520 or LI-190R. The quantum sensor is used to measure photosynthetically active radiation (PAR) at various points in the CEH, including, but not limited to above the grow canopy, at the grow canopy and reflected PAR. The Apogee SQ-520 is a full spectrum PAR sensor. The SQ-500 series quantum sensors consist of a cast acrylic diffuser (filter), interference filter, photodiode, and signal processing circuitry mounted in an anodized aluminum housing, and a cable to connect the sensor to a measurement device. SQ-500 series quantum sensors are designed for continuous PPFD measurement in indoor or outdoor environments.

Although FIG. 3 shows 5 imagers/sensors on an imaging engine 1100A, it should be appreciated that different numbers of cameras/sensors 1005 and different types of cameras/sensors may be included in imaging engine 1100A according to the inventive concepts described herein, and that one or more cameras/sensors may be disposed on or otherwise integrated with the multispectral imaging system 5050A at various locations and/or positions within the CEH. Other sensors that may be integrated with or disposed on the imaging engine 1100A may include sensors for UV (UVA, UVB, and/or UVC bands), ambient visible light, near IR, shortwave IR, longwave IR, RFID, UHRFID, and LiDAR. Other cameras that may be integrated with or disposed on the imaging engine 1100D may include a shortwave IR camera and a monochrome camera.

In one exemplary method, the imagery/spectra at different wavelengths may be acquired in a serial manner utilizing the following steps: (1) activating an LED element in the LED array of the imaging system to irradiate the plants with radiation at a first wavelength, (2) acquiring imagery/spectra using the camera(s)/sensor(s) in the imaging system, and (3) deactivating the LED element. These steps may be performed in sequence to acquire imagery/spectra at different wavelengths. For example, the imaging system may acquire images for the following cases: (1) illumination under 275 nm and 365 nm radiation, (2) illumination under visible radiation corresponding to various photosynthetic and terpene compound peaks, (3) illumination under NIR at 940 nm and 1450 nm to assess water content, (4) illumination under SWIR for detection of gases and other compounds, and (5) a LWIR heat map, which may be a acquired without activation of a light source.

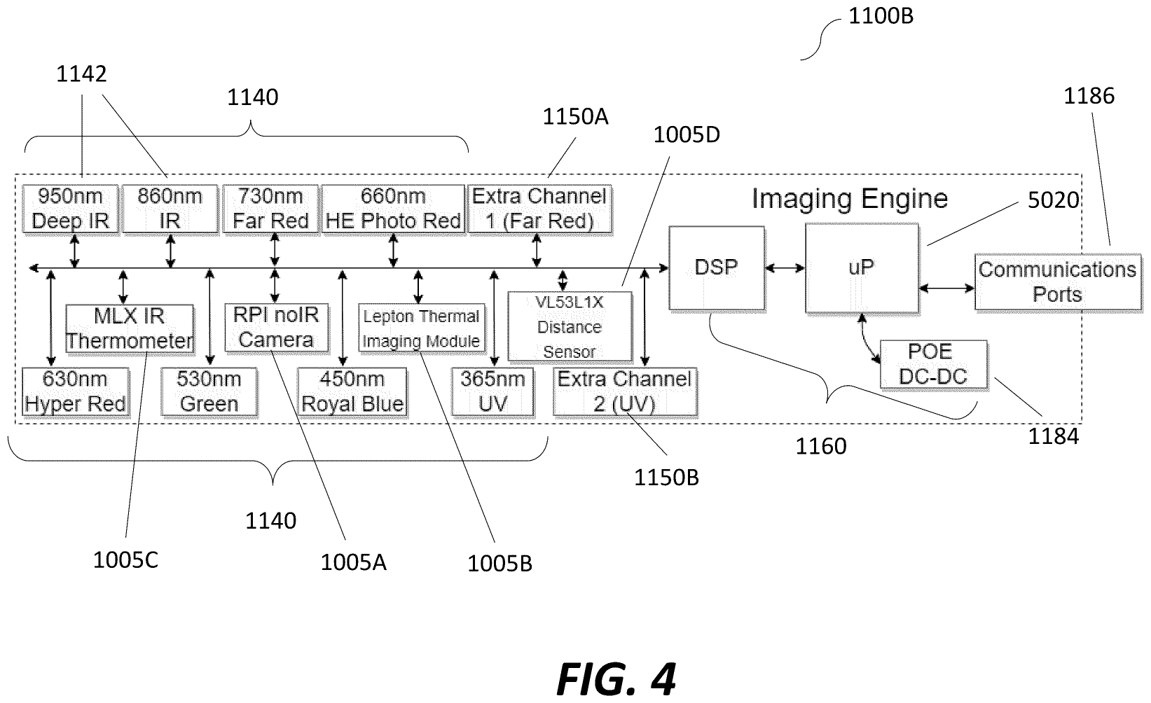

FIG. 4 shows a block diagram of a multispectral imaging engine 1100B according to an inventive implementation. The imaging engine 1100B may include a camera to acquire UV-SWIR imagery 1005A, a camera to acquire LWIR thermal imagery 1005B, an infrared (IR) sensor 1005C, and a proximity sensor (TOF) 1005D. In addition to the imagers/sensors 1005A-1005D, the imaging engine 1100B includes a plurality of narrowband irradiators 1140. The narrowband irradiators are an array of LEDs used to irradiate the plants 900 with radiation at various wavelengths to facilitate acquisition of one or more corresponding narrowband images (in which radiation reflected or otherwise emitted by the subject plant(s) is sensed/captured by one or more of the cameras/sensors upon exposure to one or more flashes from an LED/LEDs having particular wavelength(s) of radiation). The narrowband irradiators 1140 are provided with wavelengths of 365 (near UV), 450 (Blue), 530 (Green), 630 (Red), 660, 730, 860, and 950 nm (NIR). Thus, the imaging system 1100B provides both multispectral irradiation and sensing in a single, self-contained device.

The LED array 1140 includes one or more LED elements 1142. Each LED element 1142 of the array 1140 may emit radiation at a particular band of wavelengths or an essentially monochromatic wavelength and may be controlled independently from the other LED elements 1142. When one or more LED elements 1142 are operated to irradiate a desired portion of the environment (e.g., the plants below a lighting fixture in a CEH system) with relatively narrow band or substantially monochromatic radiation, one or more of the cameras/sensors 1005 (e.g., camera 1005A) acquires a corresponding image that contains radiation reflected or otherwise emitted by the plant subjects in the field of view in response to exposure to radiation at the corresponding wavelength(s) of the operated LED element(s). Different LED elements 1142 may be activated to illuminate the desired portion of the environment with radiation at different wavelengths and the cameras/sensors 1005, in turn, may acquire corresponding images or other sensed information relating to reflected and/or emitted radiation resulting from the respective different wavelengths/wavelength bands of the activated LED elements. In some example implementations, after acquiring images and/or other information at multiple wavelengths/wavelength bands, a multispectral image may be formed by aligning and superimposing the respective acquired images onto each another. In this manner, the multi spectral image may include spatial and spectral information regarding the desired portion of the environment (e.g., each pixel of the multispectral image contains corresponding spectra).

The imaging system 5050A may be designed to be operated remotely or automatically. Narrowband irradiator elements 1142 of the same wavelength may switch on at the same time automatically at certain preprogrammed time intervals. Alternatively, narrowband irradiator elements 1142 of the same wavelength may be activated remotely. The flash controller 5020, either alone or in communication with a remote device, may control automatic and/or remote narrowband irradiator activation. An image may be acquired (and/or information may be collected) automatically using imager(s)/sensor(s) 1005 each time narrowband irradiators are activated. Supplemental illumination in the CEH may be turned off automatically when images are acquired. The imaging system may acquire an image at each available narrowband or combinations of narrowbands at each measurement interval. Alternatively, the imaging system may acquire a subset of images at only some of the available narrowbands or combinations of narrowbands at each measurement interval.

In some implementations, the LED elements 1142 respectively may be activated for a relatively short time period (i.e., turning on and off quickly) in succession (and optionally according to some pattern or order), thus exposing the plants to a brief “flash” of light when acquiring various information relating to reflected radiation using the camera(s)/sensor(s) 1005. For example, the LED elements 1142 may emit radiation for a duration of less than about 1 second. Activating the LED elements 1142 in this manner may have multiple benefits including, but not limited to (1) reducing the time delay between acquiring images/information at different wavelengths so that the multiple images/information acquired are representative of the same environmental conditions and (2) reducing the duration in which the plants and/or other imaging subjects are exposed to radiation. In some implementations, the camera(s)/sensor(s) 1005 may be synchronized with the LED elements 1142 such that the camera(s)/sensor(s) 1005 is/are triggered to acquire an image/information when the LED elements 1142 are activated. In this manner, a series of images/information may be collected by sequentially flashing the plants with radiation from different LED elements 1142 and capturing an image/information during each flash using the camera(s)/sensor(s) 1005. In yet other implementations, multiple LEDs having different spectral outputs may be activated together while one or more images and/or other information is acquired relating to radiation absorbed and/or reflected by the irradiated plants and/or other subjects.

The imaging engine 1100B may also include supplementary LED arrays 1150A and 1150B (collectively referred to as supplementary LED array 1150) to augment the LED array 1140 and/or to alter the chemical/morphological properties of the plants. The imaging engine 1100B may also include power electronic circuitry 1160 to support the operation of the LED arrays 1140 and 1150 and cameras/sensors 1005. The imaging engine 1100B may also include a flash controller 5020 (e.g., a microprocessor) to control the LED arrays 1140 and 1150 and/or the cameras/sensors 1005. The imaging engine may also include one or more Power over Ethernet (PoE) ports 1184 and/or one or more Universal Serial Bus (USB) ports as power ports. The imaging engine may also include one or more PoE or USB communications ports 1186.

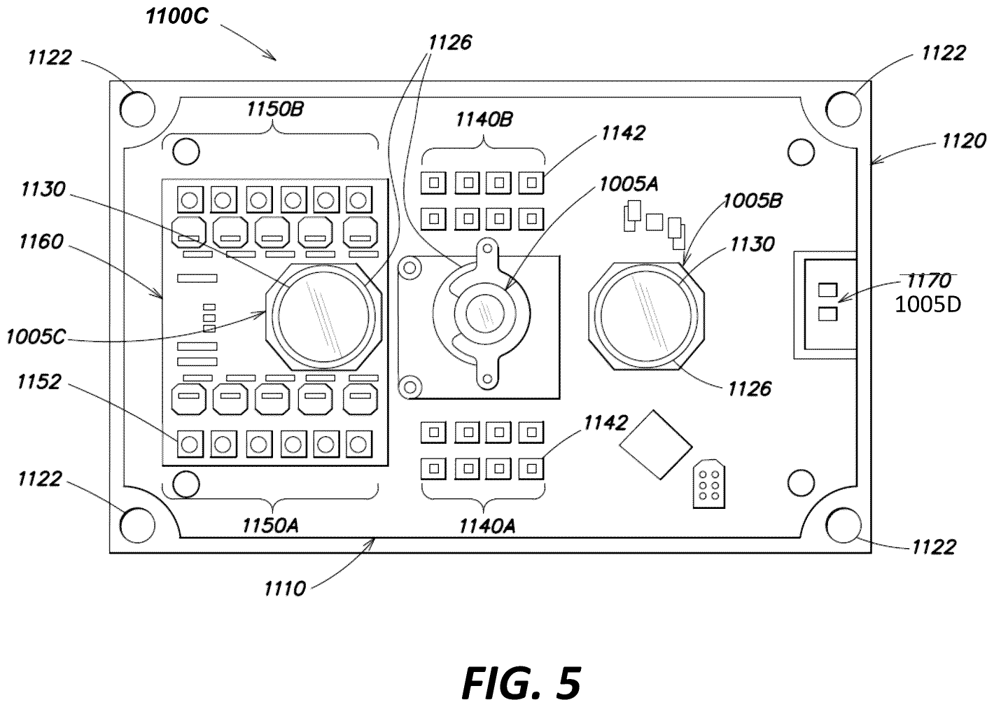

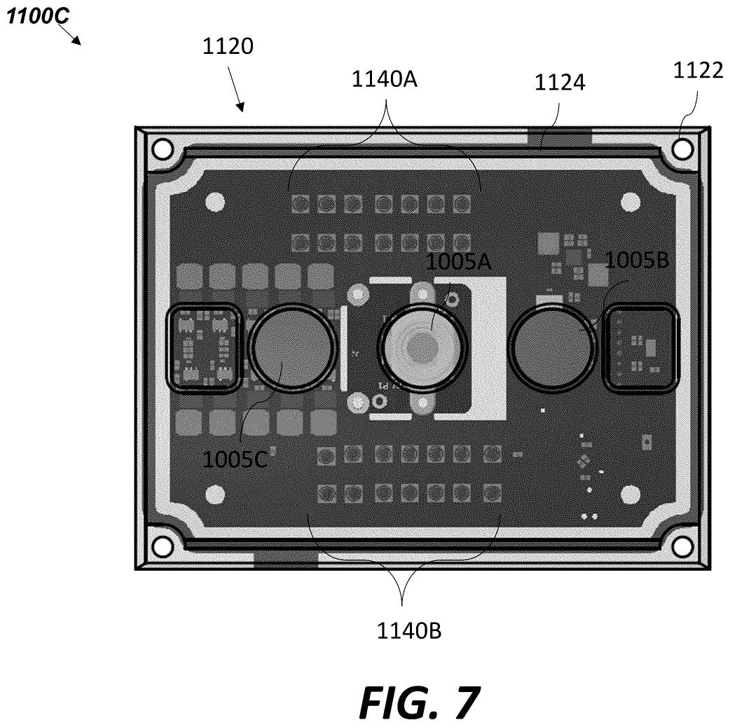

FIGS. 5-9 show several views of the multispectral imaging engine 1100C, according to example inventive implementations without and with a housing 1120, and with a network board 1180, respectively. As shown, the imaging engine 1100C may include a circuit board 1110 that supports the cameras/sensors 1005A, 1005B and 1005C previously described. The imaging engine 1100C may also include LED arrays 1140A and 1140B (collectively referred to as LED array 1140) to irradiate the plants with radiation at various wavelengths to facilitate acquisition of one or more corresponding multispectral images (in which radiation reflected or otherwise emitted by the subject plant(s) is sensed/captured by one or more of the cameras/sensors upon exposure to one or more flashes from an LED/LEDs having particular wavelength(s) of radiation). The imaging engine may also include a proximity sensor 1005D (e.g., a single point laser rangefinder). The circuit board 1110 may include power electronic circuitry 1160 to support the operation of the LED arrays 1140 and 1150, cameras/sensors 1005, laser rangefinder 1005D, and other components of the imaging engine 1100C. The imaging engine 1100C may include the housing 1120 to protect the cameras/sensors 1005A, 1005B, 1005C, and 1005D; the LED arrays 1140 and 1150; and other electronics from the surrounding environment.

The imaging engine 1100C may generally include one or more LED arrays 1140. Each LED array 1140 may include one or more LED elements 1142. For instance, each LED array 1140 may include between about 1 to about 100 LED elements 1142. The LED elements 1142 in the LED array 1140 may be disposed proximate to each other on the circuit board 1110. The LED arrays 1140 may be arranged on the circuit board 1110 to provide a desired illumination profile. For example, the LED arrays 1140A and 1140B may include the same type of LED elements 1142, thus providing multiple radiation sources that emit radiation at the same wavelength. FIG. 5 shows the LED arrays 1140A and 1140B may be disposed on opposing sides of the camera 1005A. By irradiating the plants and/or their surroundings with radiation from opposing sides of the camera 1005A, the camera 1005A may acquire images under more uniform irradiation. Other illumination profiles may be achieved with different arrangements and/or using an optical element (e.g., shaping a portion of the housing 1120 in front of the LED array 1140, placing a separate diffuser or lens onto the LED array 1140).

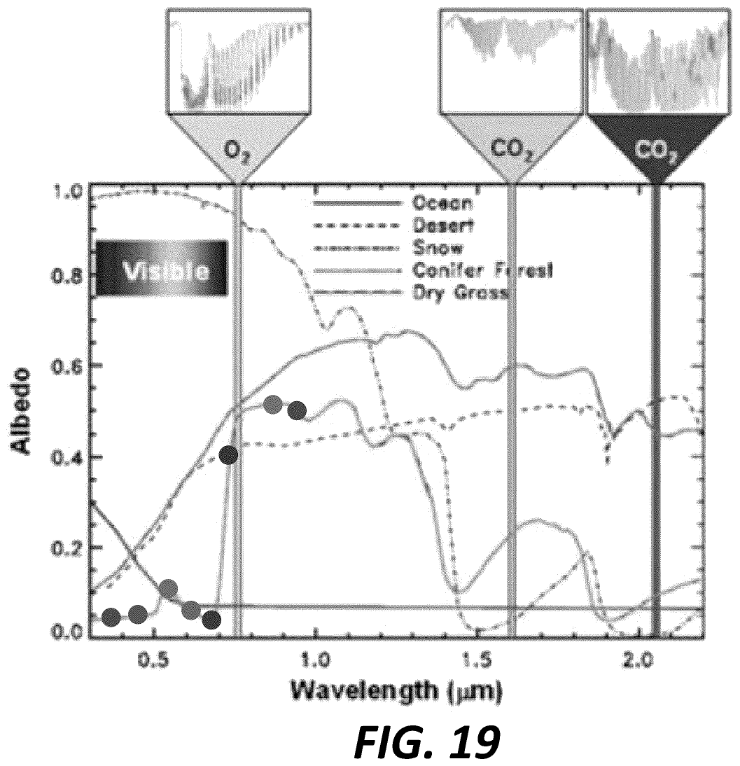

The LED array 1140 may generally include LED elements 1142 that respectively emit radiation at different wavelengths. For example, the LED elements 1142 may emit radiation at wavelengths ranging between about 200 nm to about 2 μm. The number of LED elements 1142 and the wavelengths at which they emit light may be chosen, in part, based on known spectral absorption and/or reflection peaks of various chemical compounds associated with the plants (see FIGS. 19-21) and/or other subjects of interest in the CEH system. For example, the LED elements 1142 may be chosen to cover the absorption peaks of several different types of compounds from the UV to the NIR wavelength ranges. In some implementations, it may be preferable to use LED elements 1142 with a smaller spectral bandwidth (e.g., essentially monochromatic radiation) in order to provide greater spectral resolution when acquiring multispectral images of the plants and/or other subjects. For example, the spectral bandwidth of one or more of the LED elements 1142 considered to be essentially monochromatic may be less than about 50 nm. Other LED elements 1142 may emit radiation in a broader range of wavelengths; for example, one or more of the LED elements 1142 may be a white LED in which the generated radiation covers a band of wavelengths and may be specified as corresponding to a particular color temperature.

The respective wavelengths of the radiation emitted by the LED elements 1142 may cover UV, visible, NIR, SWIR, and LWIR regimes. In one example implementation, respective wavelengths of essentially monochromatic LED elements 1142 of the LED array 1140 may include, but are not limited to, 275 nm, 365 nm, 440 nm, 450 nm, 475 nm, 500 nm, 530 nm, 620 nm, 630 nm, 660 nm, 696 nm, 730 nm, 760 nm, 850 nm, 860 nm, 940 nm, 950 nm, 1450 nm, 1610 nm, 2060 nm, and 4060 nm. More generally, the LED elements 1142 of the LED array 1140 may have radiation wavelengths between approximately 275 nm to approximately 2060 nm.

The supplementary LED array 1150 may include additional LED elements 1152. The LED elements 1152 may have one or more of the same features as the LED elements 1142 described above. In one example, the LED elements 1152 may emit radiation at one or more of the same wavelengths as the LED elements 1142 in order to increase the overall intensity of radiation when acquiring images/information relating to the irradiated plants/other subjects (i.e., both LED elements 1142 and 1152 are activated). In some implementations, the LED elements 1152 may provide a radiation output greater than the LED elements 1142. For example, the LED elements 1152 may have a wattage rating greater than about 6 Watts. The higher radiation output provided by the LED elements 1152 may be used, in part, to intentionally induce chemical and/or morphological changes to plants in the environment. For example, the LED elements 1152 may provide a higher radiation output at 730 nm in order to alter the day/night cycle of the plants (e.g., changing when the plant blooms). In another example, the LED elements 1152 may provide UV light to ward off pests in the environment.

The housing 1120 may be used, in part, to enclose and protect the various components of the imaging engine 1100C and to facilitate installation of the imaging engine 1100C onto the frame of a lighting fixture in the CEH. In some implementations, the housing 1120 may form a substantially sealed enclosure in order to prevent moisture and/or water from contacting the various electronics, cameras, and sensors on the circuit board 1110. The housing 1120 may include a groove along its periphery to support a gasket 1124. When the housing 1120 is installed in the CEH system, the gasket 1124 may deform to form a seal. In some implementations, the housing 1120 may form a substantially watertight seal. The housing 1120 may include through-mounting holes 1122 for ease of installation.

The housing 1120 may be formed from various plastic and/or ceramic materials. In some implementations, the housing 1120 may be formed from a material that is substantially transparent to light at wavelengths corresponding to at least the emission wavelengths of the LED elements 1142 and 1152. Thus, radiation emitted by the LED elements 1142 and 1152 may transmit through the housing 1120 when irradiating the plants and/or the surrounding environment. In some implementations, the housing 1120 may be shaped to redirect radiation emitted by the LED elements 1142 and 1152 along a desired direction. For example, the housing 1120 may be shaped to redirect radiation emitted at wider angles towards the plants disposed directly below the imaging engine 1100C in order to more efficiently use the radiation for imaging/information acquisition. In some implementations, the surface finish of the housing 1120 may be altered to disperse radiation (e.g., a substantially smooth finish to provide specular illumination or a substantially rough finish to provide diffuse illumination).

In some implementations, the housing 1120 may be formed from a material that is not sufficiently transparent across the wavelength range of interest. For example, the camera 1005A may acquire imagery/information from the UV to SWIR ranges while the camera 1005B may acquire imagery/information in the LWIR range. Materials are typically not transparent across such a large wavelength range. Furthermore, in some instances parasitic absorption by the housing 1120 may affect the data collected by the camera(s)/sensor(s) 1005. In view of the foregoing, the housing 1120 may include multiple openings 1126 disposed near the camera(s)/sensor(s) 1005 that are shaped to support various optical elements tailored for the appropriate wavelength ranges of each camera/sensor 1005.

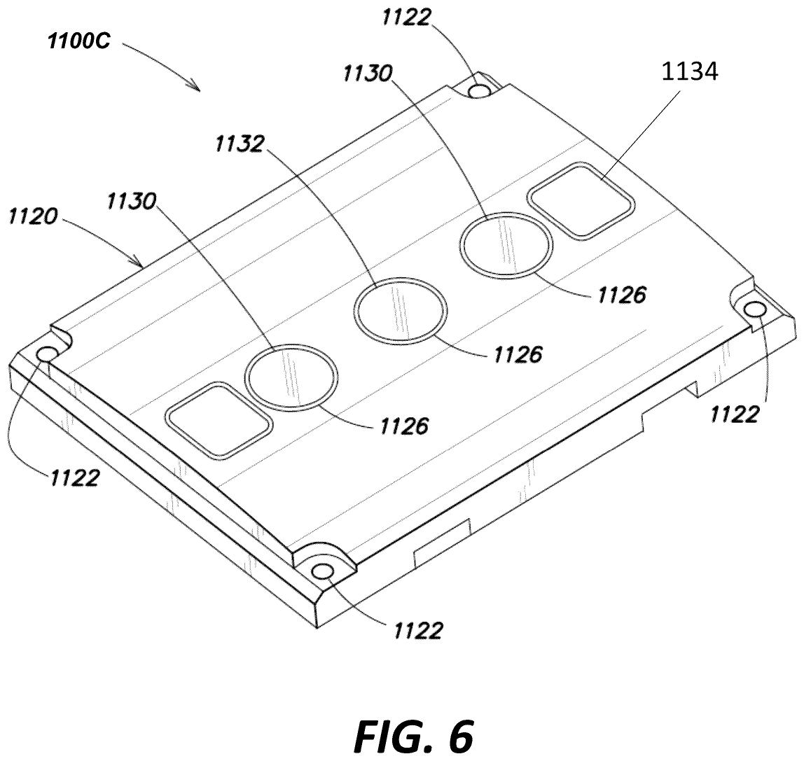

For example, FIG. 6 shows a germanium (Ge) window 1130 may be installed into the openings 1126 located directly above the camera 1005B and the sensor 1005C in the imaging engine housing. The Ge window 1130 may be used, in part, as an infrared filter that substantially reduces (attenuates) the transmission of higher frequency (shorter wavelength) radiation, thus ensuring the camera 1005B and the sensor 1005C receive infrared light in the MIR and FIR ranges. Similarly, a glass window 1132 may be disposed in the opening 1126 located directly above the camera 1005A to transmit UV to NIR radiation. In some implementations, the Ge window 1130 and glass window 1132 may include an anti-reflection coating to increase the amount of light transmitted and detected by the respective camera(s)/sensor(s) 1005. It should be appreciated that the Ge window 1130 and glass window 1132 are two exemplary materials and may be substituted with other materials suitable for the respective wavelength range(s) of interest. For example, a zinc selenide (ZnSe) window may be used for the IR range. Magnesium fluoride (MgF₂), sapphire (Al₂O₃), and calcium fluoride (CaF₂) may be used for the UV and NIR ranges. In some implementations, the imaging engine includes a LiDAR sensor, and the housing includes a LIDAR lens 1134.

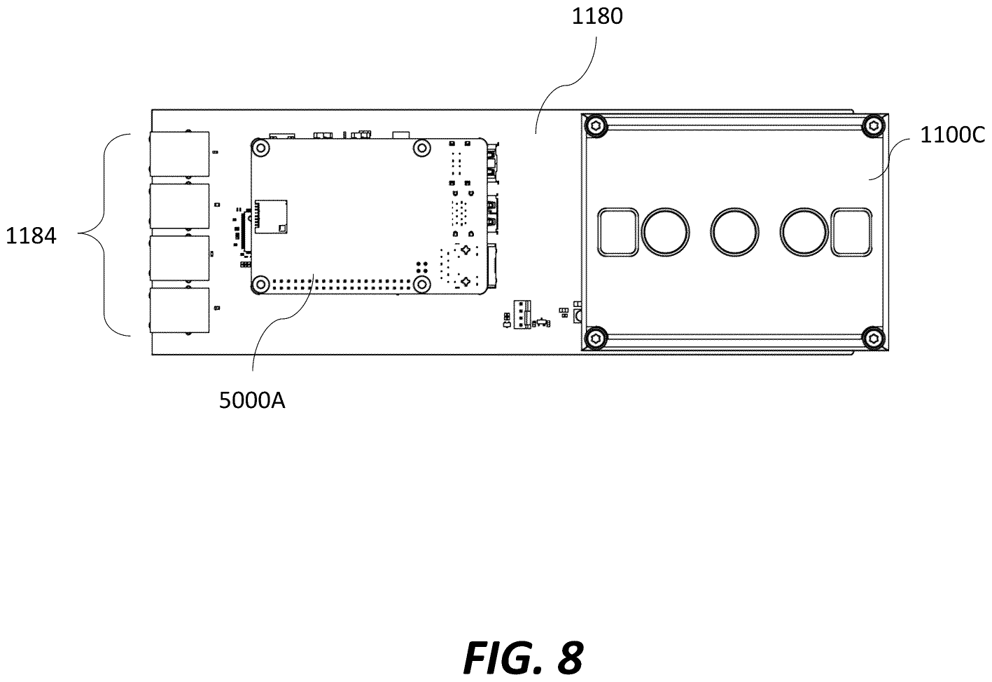

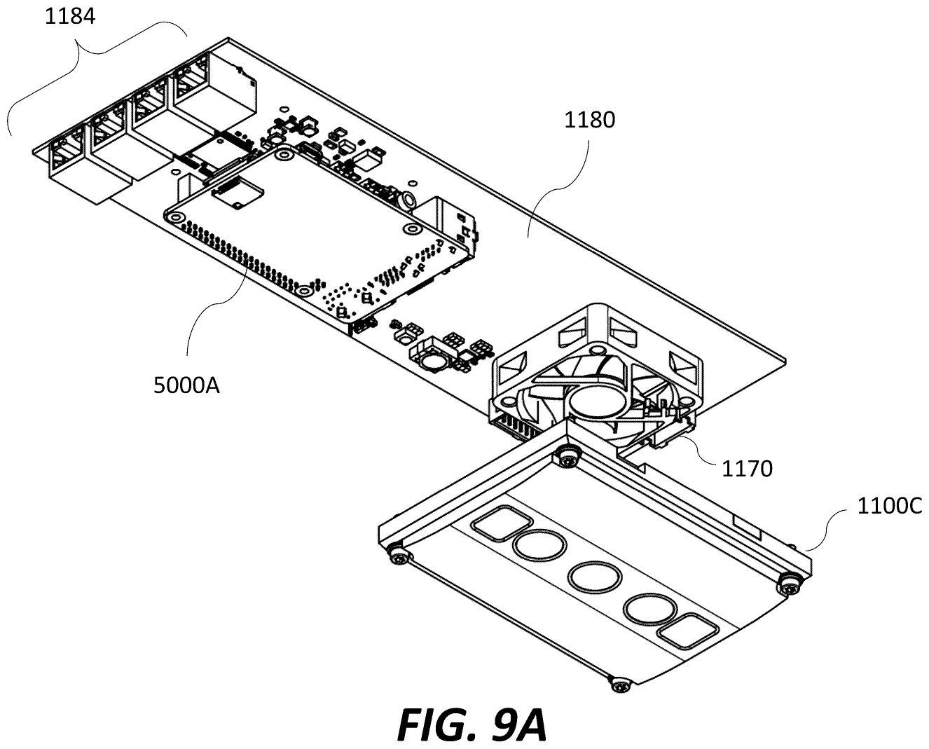

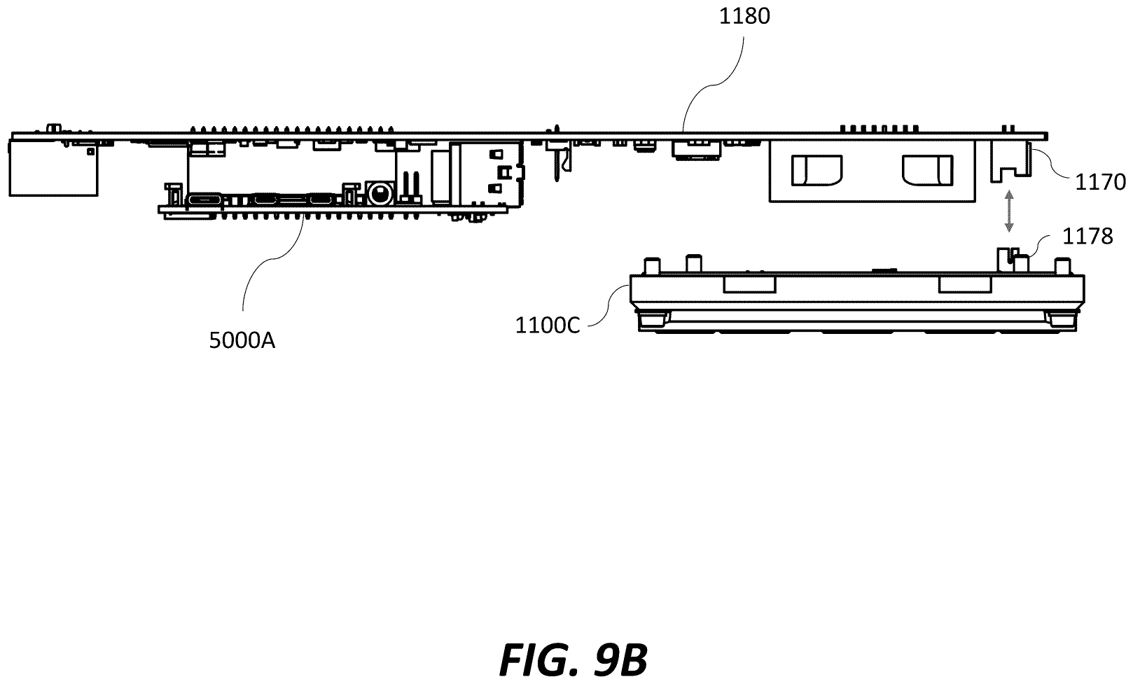

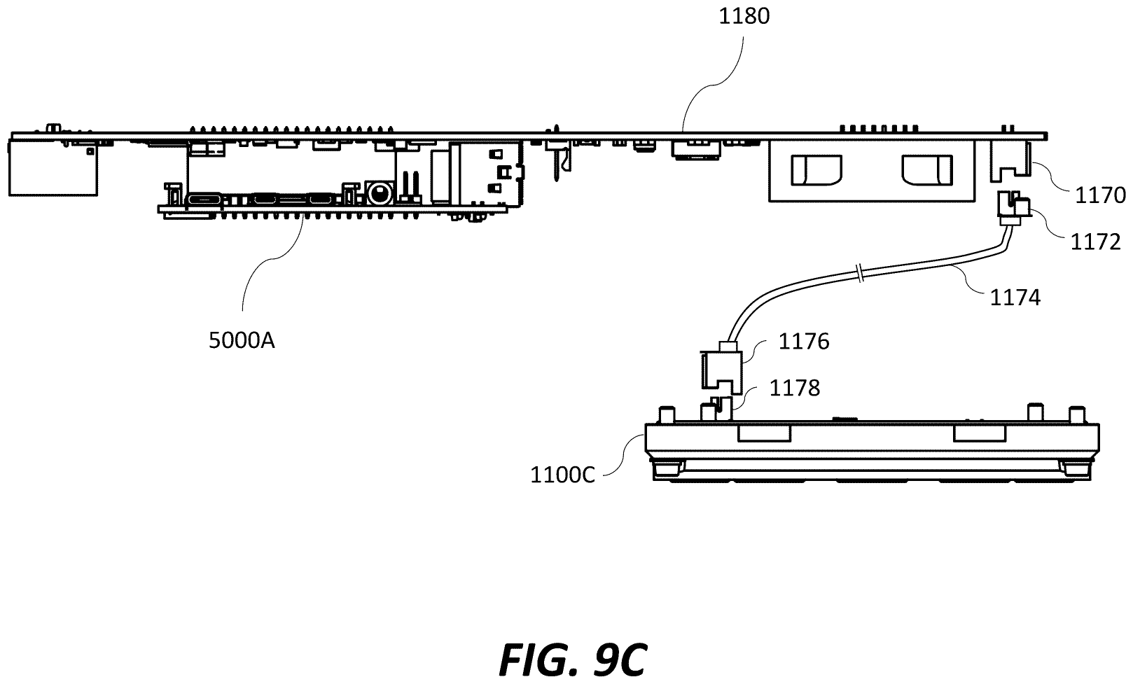

FIGS. 8-9C show various implementations of an imaging engine 1100C coupled to a carrier board 1180. In some implementations, the carrier board 1180 may be disposed in or on the housing of a lighting fixture or in or on the housing of another device (e.g., a “stand-alone” imaging engine and processor). The carrier board 1180 may support the imaging engine 1100C. The carrier board 1180 supports an image processor 5000A (e.g., a Raspberry Pi processor) and provides operable coupling between the imaging engine 1100C and the image processor 5000A. The carrier board also supports one or more Power over Ethernet (PoE) ports 1184 and/or one or more Universal Serial Bus (USB) ports as communication and/or power ports for communicatively coupling the image processor 5000A and/or the imaging engine 1100C with another device (e.g., a lighting fixture or a remote device). In some implementations, the image processor 5000A may also act as the flash controller 5020. In other implementations, a separate flash controller 5020 may also be supported by the carrier board. The carrier board may provide power conversion and mounting for the imaging engine, the image processor, and communications ports.

The processor 5000A may also be used to manage data communications (e.g., wired communication via Ethernet cables or wireless communication, including sending control signals to the imagers/sensors 1005 and receiving imagery and sensory data measured by the imagers/sensors 1005 for processing and/or transmission to a remote device (e.g., a remote computer or server). Acquired images and/or sensory data may be stored locally or on a remote server.

FIG. 9B illustrates coupling between the imaging engine 1100C and the carrier board 1180. A connector 1170 on the carrier board 1180 may couple directly to the complimentary mating connector 1178 on the imaging engine 1100C. In some implementations the connector 1170 on the carrier board 1180 may be coupled to the connector 1178 on the imaging engine 1100C via a cable 1174. The cable 1174 includes connectors 1172 and 1176 to couple to connectors 1170 and 1178, respectively, as shown in FIG. 9C. Each connector may be designed in accordance with a standard size and/or connector type to facilitate complimentary mating connection. The length of the cable 1174 may vary based on the desired distance between the carrier board 1180 and the imaging engine 1100C, and/or the desired field of view of the imaging engine 1100C. The connectors coupling the carrier board 1180 and the imaging engine 1100C may transmit sensor signals measured by the imaging engine 1100C to the carrier board 1180 and the processor 5000A. The connectors may also provide electrical power to the imaging engine 1100C to power the imaging engine 1100C.

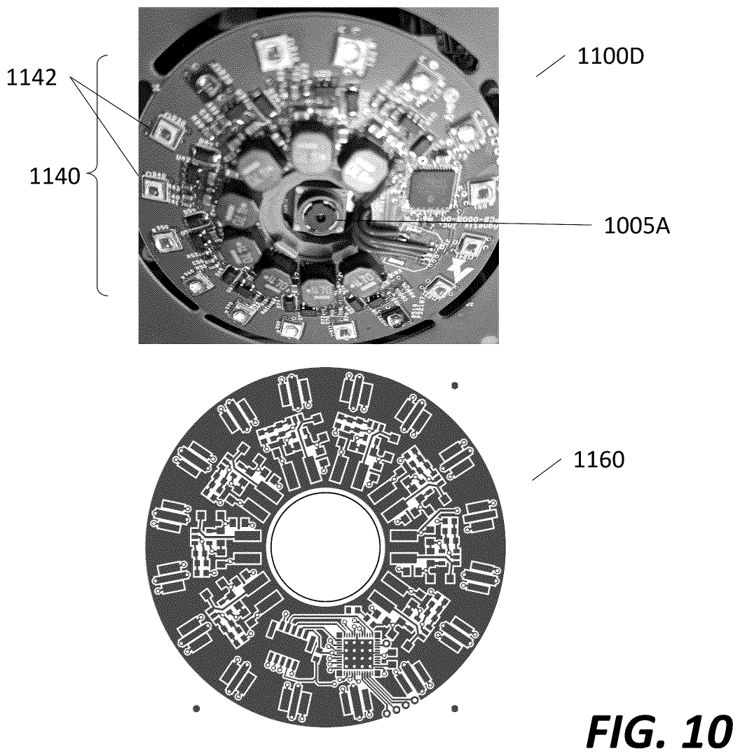

FIG. 10 shows a multispectral imaging engine 1100D according to one example implementation. In one implementation the imaging engine 1100D is mounted in a stationary position within a CEH system. In another implementation, imaging engine 1100D is a handheld portable device. The imaging engine 1100D includes a single camera 1005A to acquire UV-SWIR imagery and an LED array 1140 disposed in a circle around the camera 1005A. The LED array 1140 includes a plurality of LED elements 1142. The LED array 1140 may provide irradiation in the UV, visible, NIR, SWIR, and LWIR regimes. The arrangement of LED elements 1142 around the camera 1005A may provide more uniform irradiation. For example, LED elements emitting the same narrowband may be placed on opposite sides of the camera to provide more uniform irradiation. The camera 1005A may be a Pi NoIR. The imaging engine 1100D includes electronic circuitry 1160 to support the operation of the LED arrays 1140 and the camera 1005A.

The image processor 5000A acquires images and sensory data from imagers/cameras 1005. The image processor processes and stores these images and sensory data. In one implementation the image processor may transfer images and sensory data to a remote server for storage.

The image processor 5000A may perform one or more image processing steps. In some implementations, the imaging system 5050A may use one or more calibration references to facilitate calibration or background subtraction by the image processor 5000A of imagery and/or sensor data acquired by camera(s)/sensor(s) 1005. For example, a phantom may be used to calibrate imagery/spectra in the UV, visible, NIR, and SWIR regimes. The phantom may be an object with known optical properties including, but not limited to a known emissivity, absorptivity, and reflectivity at various wavelengths. In general, the phantom may have optical properties that vary as a function of wavelength or optical properties that remain substantially unchanged at different wavelengths. The phantom may have various shapes including, but not limited to a sphere, a polyhedron, a plant, a fungus, and an animal (e.g., a mammal, a fish). The phantom may also be dimensioned to have an overall size that is smaller, comparable, or larger than the plants being imaged.

By placing a phantom near the plants being imaged, the phantom can calibrate both the magnitude and wavelength of the imagery/spectra being measured. In some implementations, multiple phantoms may be deployed within the field of view of the camera(s)/sensor(s) to provide multiple references. For such cases, the multiple phantoms may be used to correct for image distortion (e.g., spherical aberration of the image) and/or the angle at which radiation is received by the camera(s)/sensor(s) (e.g., the camera/sensor may have a responsivity that varies as a function of the angle of incidence of the detected radiation).

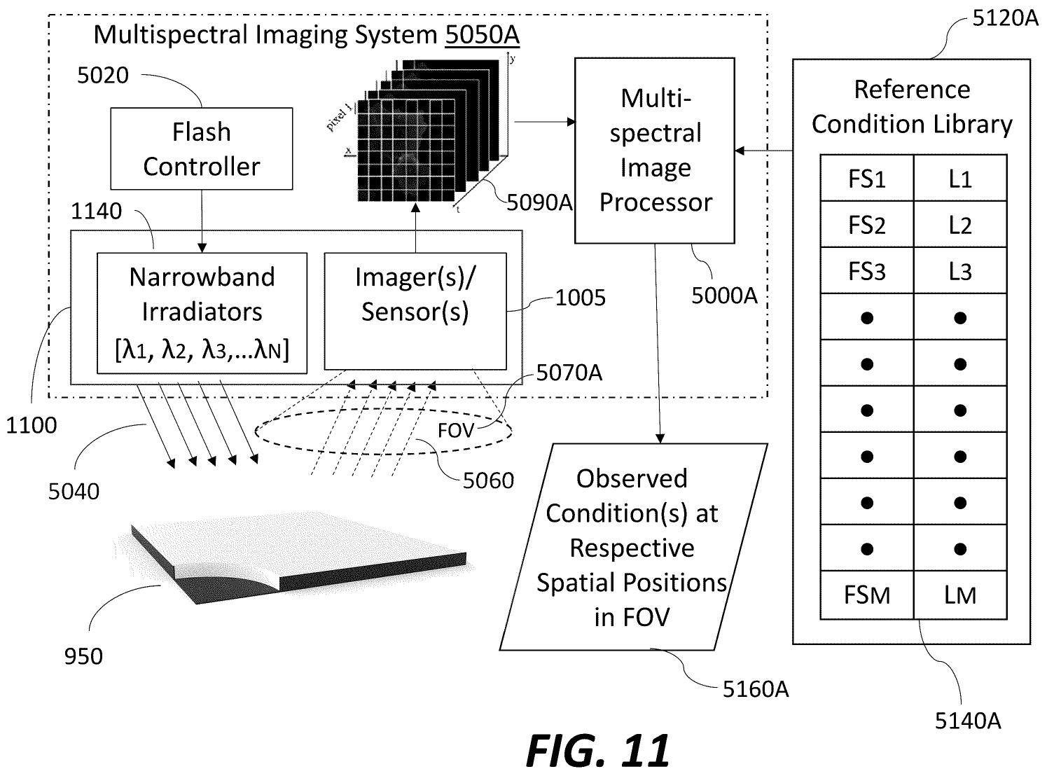

FIG. 11 illustrates calibration of the UV-SWIR camera(s) using a reference reflectance target 950 as a phantom. This calibration may be used to calibrate narrowband images 5090A acquired by the multispectral imaging system 5050A. Calibration in the form of radiometric correction may, for example, compensate for changing incident light conditions during imaging. Radiometric correction may provide absolute reflectance values and make it possible to compare reflectance information from several sources. The reference reflectance target 950 may reflect a known amount of incident light uniformly at every wavelength band. For example, the reference target 950 may reflect 99% of incident light. Narrowband reflectance values may be corrected using a correction factor determined using the reference reflectance target 950. The correction factor may be a ratio of the highest possible reflectance divided by the reflectance of the reference target 950.

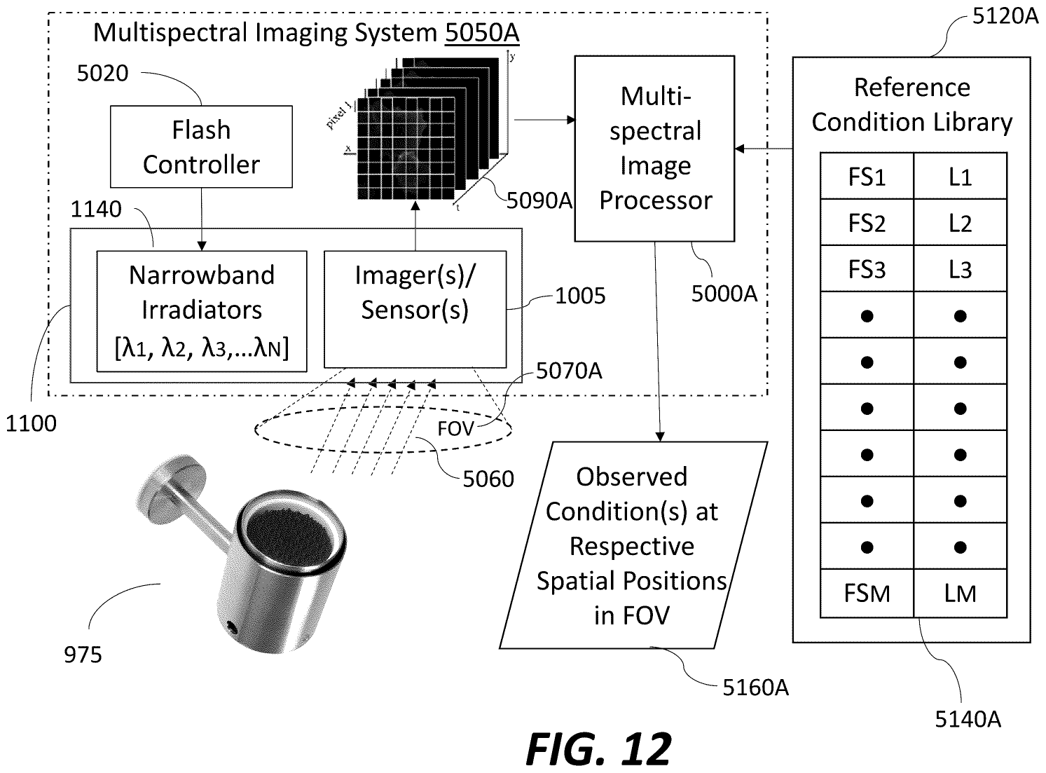

FIG. 12 illustrates calibration of the LWIR thermal camera(s) 1005B using a blackbody radiator 975. A blackbody radiator 975 may be used to calibrate thermal imagery/spectra in the LWIR regime. The blackbody radiator may be an object that is heated to a known temperature. For example, the blackbody radiator may include a resistive heater and a temperature sensor (e.g., a thermistor, a thermocouple). The blackbody radiator may thus be used to calibrate the temperature measured in the thermal imagery. Similar to the phantom 950, the blackbody radiator may have various shapes including, but not limited to a sphere, a polyhedron, a plant, a fungus, and an animal (e.g., a mammal, a fish). The blackbody radiator may also be dimensioned to have an overall size that is smaller, comparable, or larger than the plants being imaged.

As another example, thermal images acquired by the LWIR thermal camera(s) may be corrected using the crop water stress index (CWSI). CWSI may be extracted from a thermal image and may assist in compensating variability in the environmental parameters. Air temperature measurements using a more precise temperature sensor are used to calculate CWSI. CWSI is defined as:

$$CWSI = \frac{( {T}_{c} - {T}_{a} ) - ( {T}_{c , max} - {T}_{a} )}{( {T}_{c , min} - {T}_{a} ) - ( {T}_{c , max} - {T}_{a} )}$$

where T_{c} is the average temperature in the region of interest, Tₐ is the air temperature measured by the more precise temperature sensor, T_{c,min} is the lowest pixel temperature within the region of interest in the thermal image, and T_{c,max} is the highest pixel temperature within the region of interest in the thermal image. The resulting CWSI values may be used to sense transpiration and/or stomatal conductance.

In some implementations, a background subtraction may be applied to remove the radiation emitted by the other radiation sources. For example, imagery/spectra may be acquired with and without radiation from the LED element in the LED array of the imaging system. If the radiation does not cause substantial changes to the plant's optical properties (e.g., alters the photochemistry of the plant), the portion of light reflected by the radiation from the LED element may be extracted by taking a difference between the two images/spectra. In another example, imagery/spectra may be acquired with and without radiation from other lighting fixtures in the CEH system. The lighting fixtures may have known radiation spectra based, in part, on the number and type of lighting elements (e.g., LEDs) used. The spectra may be calibrated according to various standards and/or guidelines in plant research (e.g., the International Committee for Controlled Environment Guidelines). If the location and orientation of the lighting fixtures relative to the plants and the imaging system are known, the radiation from the lighting fixtures may be subtracted directly from the imagery/spectra acquired when the LED element of the LED array 1140 and the lighting fixture's lighting elements are both active.

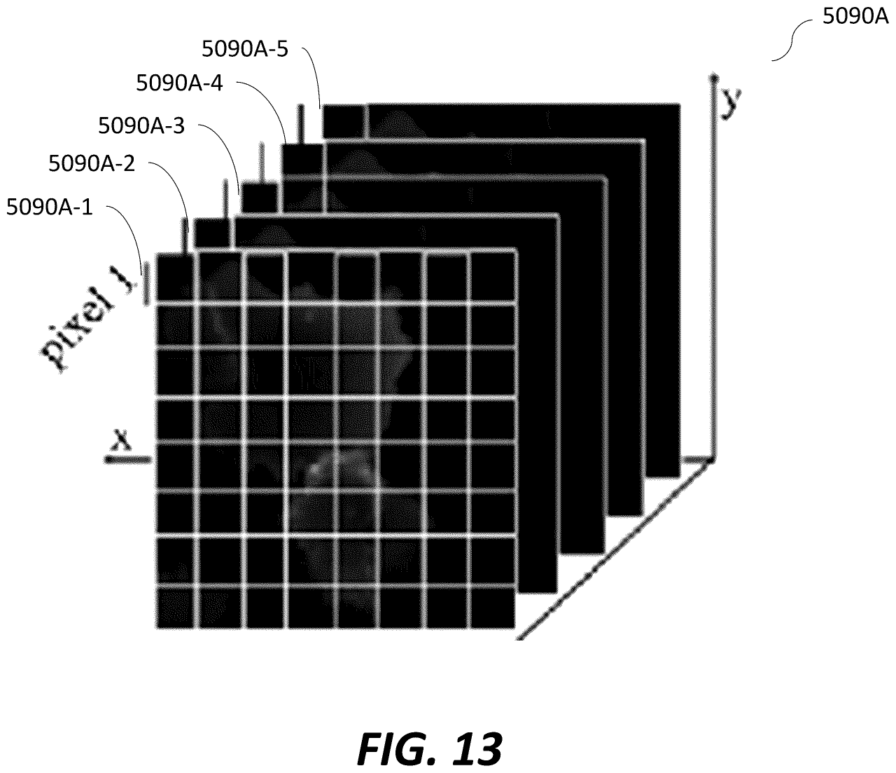

FIG. 13 shows a set of narrowband images 5090A-1-5090A-5 acquired by the multispectral imaging system 5050A. These discrete images 5090A-1-5090A-5 may be overlaid to produce a multispectral image. Multispectral images acquired by the imaging system 5050A may include a plurality of pixels, where each pixel is digitally indexed (addressed) by pixel coordinate representing a spatial position (e.g., in an x, y plane) in the field of view and corresponds to a measured value or spectrum. For example, the imaging system may acquire four narrowband images using the UV-SWIR camera 1005A, and a thermal image using the LWIR camera 1005B. In this case, there may be four narrowband spectral values and a thermal value for every pixel. FIG. 13 shows four discrete narrowband images and a LWIR heat map overlaid to make a multispectral image. In other implementations, any number of narrowband images can be acquired by the imaging system 5050A, depending on the number of radiation wavelengths of the narrowband irradiators 1140 and the spectral ranges of the imager(s)/sensor(s) 1005.

Cameras and/or sensors in the imaging engine 1100 may have different resolutions. In one implementation, the size of pixels in a multispectral image may be defined by the highest resolution camera. In this manner, imagery from a lower resolution camera may be transparent at certain pixels. Images and/or sensory data acquired by two different cameras/sensors may have a substantially overlapping field of view so that they may be easily overlaid.

Generally, a multispectral image generated by the imaging system 5050A includes a plurality of pixels. Each pixel has a vector of values. The vector of values for a particular pixel may include spectral measurements or other sensory measurements. The values may include reflectance measurements at different narrowband irradiator wavelengths. The vector of values for a particular pixel may also represent a temperature corresponding to the LWIR heat map.

The vector of values may provide the basis for a feature set used by the image processor 5000A to non-destructively identify conditions of interest. A machine learning or deep learning algorithm may be used to facilitate identification of conditions of interest 5160A. Each pixel is digitally indexed (or “addressed”) by pixel coordinates representing a spatial position in the field of view. Values measured at each pixel may be featurized to create a feature set suitable for input into the algorithm. In other words, the measured values may be represented by a set of structured mathematical representations called features. In the example with four narrowband spectral images and a thermal heat map, each pixel in the resulting multisensory image may correspond to a feature set that corresponds to measured values for four narrowband spectral images and a thermal heat map.

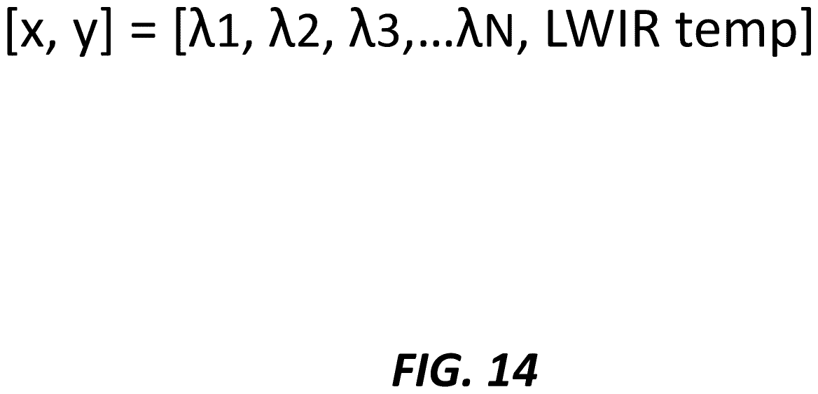

FIG. 14 shows an example feature set using all available irradiation wavelengths (λ₁, λ₂, λ₃, . . . λₙ) and temperature measurements from thermal imaging (LWIR temp). For an imaging engine with eight narrowband radiation wavelengths 5040, the resulting feature set at each pixel includes nine elements (eight elements for each narrowband wavelength image and one element for thermal imaging). For a given use-case, any subset of the available features may be picked to define a feature set for a given measurement exercise. In other words, the feature set may have 2, 3, 4, or more elements. In this way, not all measurements may be needed to identify a condition of interest.

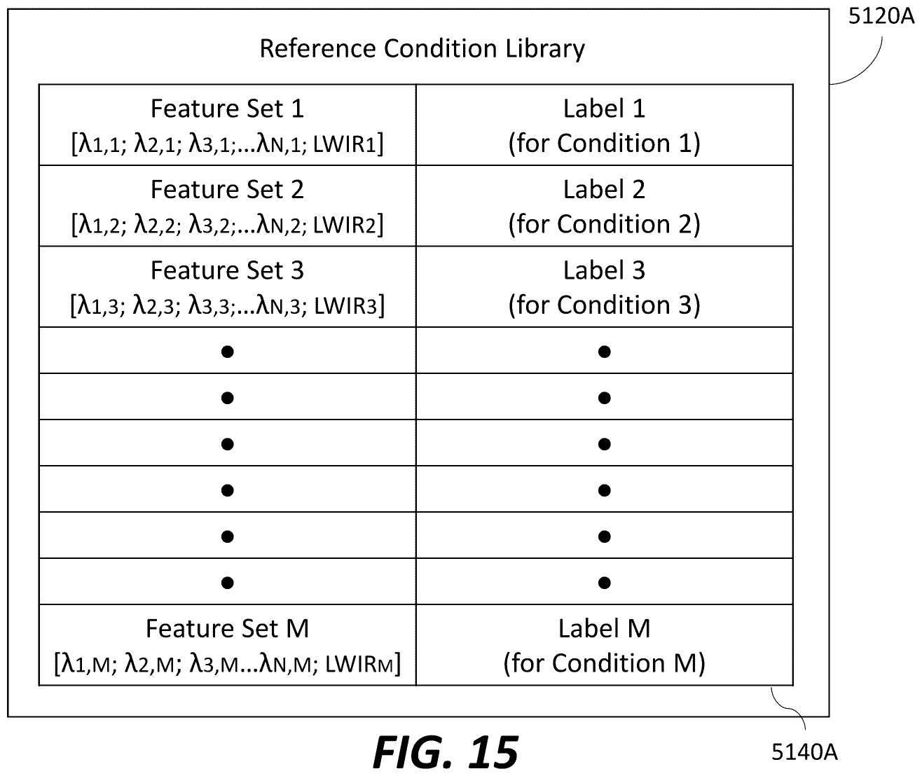

FIG. 15 shows a reference condition library 5120A including a collection of labelled conditions 5140A corresponding to respective feature sets, which may be used to observe or identify conditions 5160A. The reference condition library 5120A may include a plurality of labeled feature sets corresponding to various reference conditions. The reference condition library may include any number of prospectively useful reference conditions that may be of interest. The image processor 5000A may use machine learning to match the feature sets at each pixel to one or more conditions of interest 5160A in the reference condition library 5120A. A feature set representing a known condition of interest can be labeled (“annotated”) and thereby facilitate model training for use in machine learning matching (e.g., with a confidence value) to identify conditions of interest observed in real time measurements of an object (e.g., plant(s)).

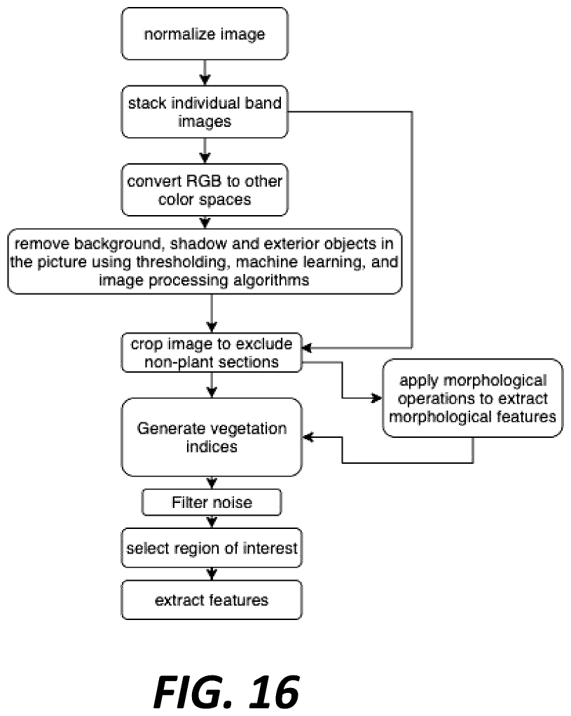

FIG. 16 shows image processing methodology that may be performed by the image processor 5000A, including radiometric correction, that may be used to prepare a multispectral image for input into a machine learning or deep learning algorithm. One or more of the following image processing operations may be performed prior to featurizing the vector of values at each pixel. The image processor 5000A may normalize imagery and/or sensory data acquired by the imaging system 5050A. For example, reflectance data from narrowband images 5090A may be normalized according to the following equation:

$$Normalized {R}_{i} = \frac{{R}_{i}}{\sqrt{{R}_{1}^{2} + {R}_{2}^{2} + {R}_{3}^{2} + … + {R}_{n}^{2}}}$$

where Rᵢ is a reflectance value from a pixel at a particular wavelength, and R₁, R₂, R₃ . . . Rₙ are the reflectance values from the pixel at each wavelength in the multisensory image. The image processor 5000A may convert the color spaces of imagery and/or sensory data. Each color space defines color with different attributes that can provide information for different applications. Different color spaces present this information in ways that are more convenient for different calculations. Images may appear brighter and easier to distinguish using a particular color space. For example, imagery acquired using a RGB color space may be converted to another color space, such as HSV, HIS, or LAB. The image processor 5000A may process images acquired by the imaging system 5050A to remove background, shadow, and/or exterior objects in the images using thresholding, machine learning, and/or image processing algorithms. This process includes linear and non-linear image filtering for smoothing, sharpening, measuring texture, denoising, image compression, and image registration. Morphological operations are performed to change the foreground region via union operations. This process cleans up the results from thresholding. Structuring elements such as masks may also be used for morphology determination. Blobs or connected components may be extracted.

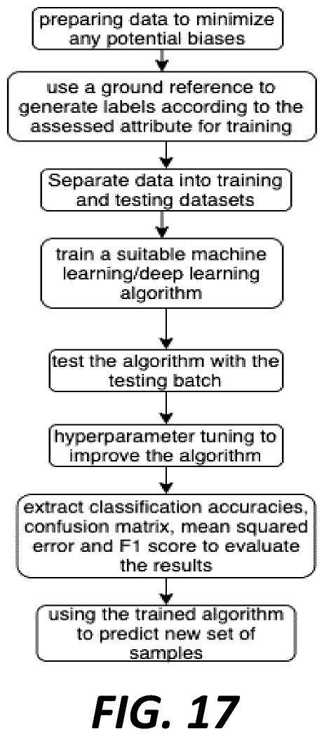

FIG. 17 shows additional image processing methodology that may be used to prepare a multispectral image for input into a machine learning or deep learning algorithm. The imaging system 5050A may use labeled feature sets of known conditions to generate labeled conditions 5140A for the reference condition library 5120A. Images and sensory data collected by the imaging system 5050A may be used to populate or refine labeled conditions 5140A in the reference condition library 5120A. Images and sensory data collected by the imaging system 5050A may also be used to train a machine learning or deep learning algorithm. Once trained using data from the imaging system 5050A, the algorithm may more accurately predict conditions of interest in the multi spectral images.

In some implementations, the image processor 5000A may determine vegetative indices (VIs) using the narrowband images 5090A. In this way, each pixel in a multispectral image may have one or more feature sets with one or more VI value. For example, the image processor 5000A may generate normalized difference spectral indices (NDSIs) that represent every possible coupled combination of narrowband reflectance wavelengths according to:

$$NDSI [ i , j ] = \frac{{R}_{i} - {R}_{j}}{{R}_{i} + {R}_{j}}$$

where R is the measured reflectance, and i and j refer to specific spectral bands. NDSIs may be novel combinations of spectral bands generated by spectral ratios. Other VIs may be generated, including NDVI, GNDVI, RNDVI, NNIR, MCARI, and RENDVI.

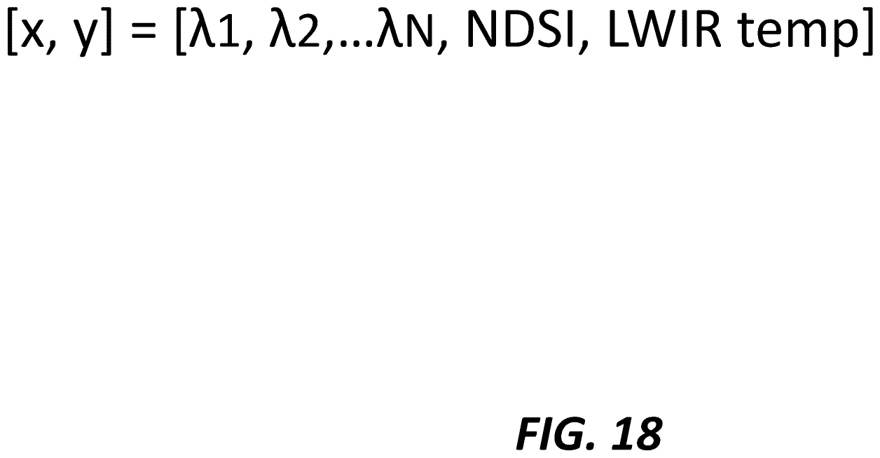

FIG. 18 shows an example feature set using measured values from all available narrowband irradiation wavelengths (λ₁, λ₂, λ₃, . . . λₙ), temperature measurements from thermal imaging (LWIR temp), and an NDSI value generated using two or more narrowband images. The reference condition library 5120A may include labeled feature sets with one or more VI acting as features in the feature set.

The reference condition library 5120A can include labeled feature sets corresponding to known conditions of interest. The reference condition library 5120A may include labelled feature sets with features corresponding to respective spectra of chemical constituents of interest. The values corresponding to respective features in a labeled feature set may be discreet reflectance (or absorbance) values extracted from known spectra at particular narrowband wavelengths at which reflectance measurements correspond to features in the feature set (e.g., the wavelengths of the narrowband irradiators 1140). The known spectra may be albedos (reflectance) or absorbance spectra. Known absorbance spectra may be converted to reflectance spectra using conversions known in the art (e.g., Reflectance=(1/Absorbance)). Values from known spectra may also be processed (e.g., normalized, discretized) before use as a labeled feature set in the reference condition library.

FIG. 19 shows an example of known albedo spectra that may be discretized to provide a labeled feature set for the reference condition library 5120A. The albedo values at wavelengths or wavelength bands corresponding to the narrowband wavelengths of the irradiators 1140 may be extracted from one of the spectrums in FIG. 19 to create a labeled feature set for a condition of interest. For example, with a multispectral imaging system with eight monochromatic narrowband irradiator wavelengths (365 nm, 450 nm, 530 nm, 630 nm, 660 nm, 730 nm, 860 nm, and 950 nm), image processor 5000A may extract discrete albedo values from the spectrum corresponding to a known condition at each of the same wavelengths. Circles in FIG. 19 indicate wavelengths at which albedo values were extracted to create a feature set corresponding to a reference label called “Conifer Forest”. Extracting albedo measurements corresponding to “Conifer Forest” at wavelengths 365 nm, 450 nm, 530 nm, 630 nm, 660 nm, 730 nm, 860 nm, and 950 nm results, respectively, in a vector of values, [x, y]=[0.05, 0.05, 0.11, 0.05, 0.04, 0.41, 0.52, 0.50]. This labeled feature set for “Conifer Forest” may be used to identify the presence of conifer forests in images or sensory data acquired by the imaging system.

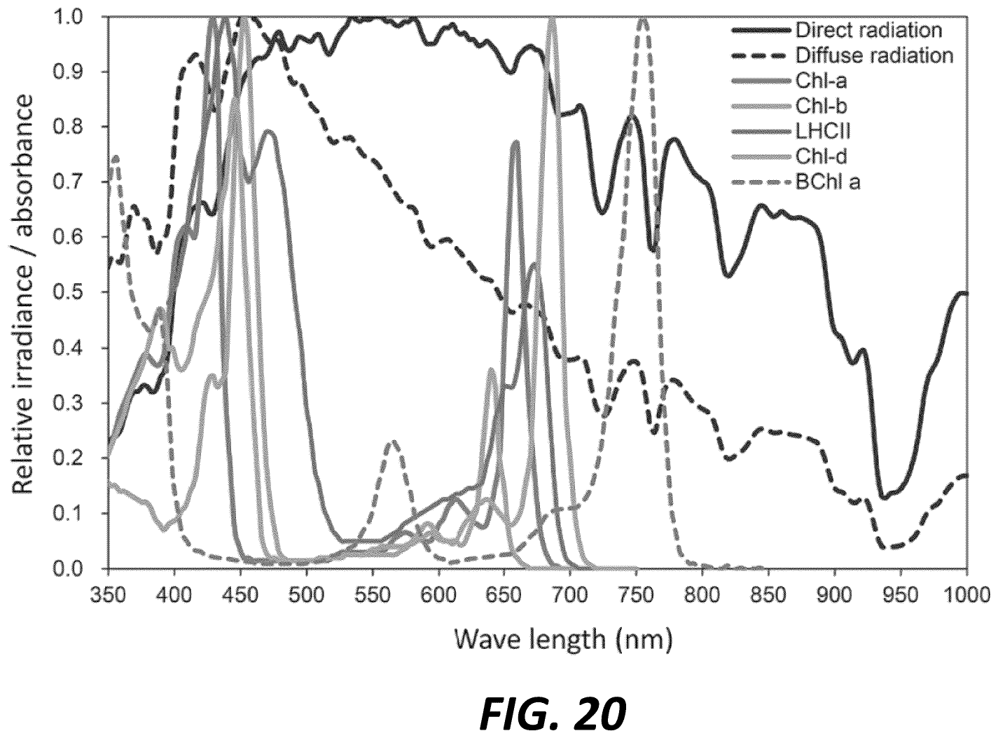

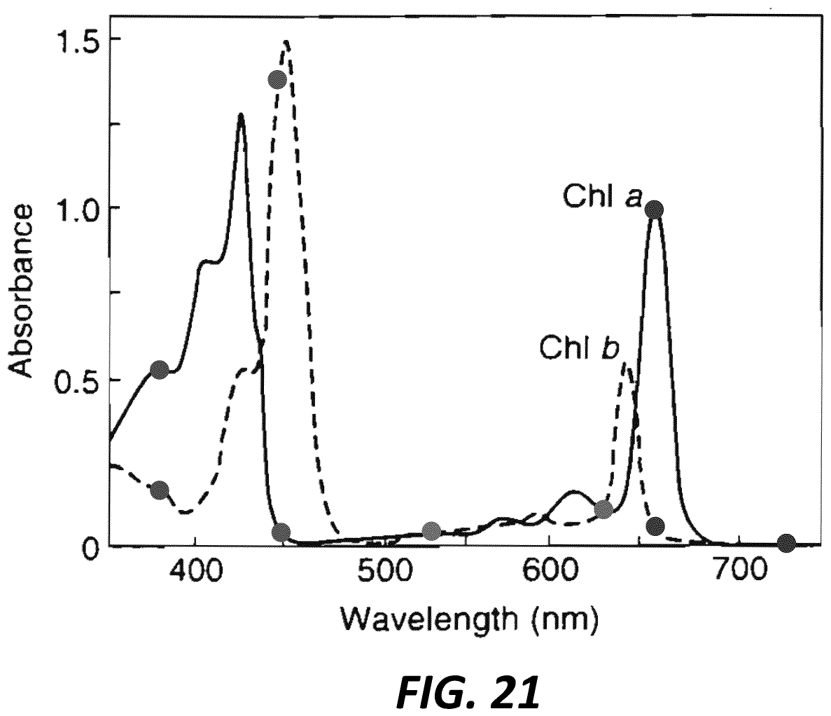

The method of extracting discrete values from known spectra to create labelled feature sets may be applied to any known spectra of interest. For example, FIG. 20 shows relative absorbance values for various plant-related compounds, including chlorophyll a (Chl-a), chlorophyll b (Chl-b), light harvesting complex II (LHCII), chlorophyll d (Chl-d), and bacteriochlorophyll a (BChl a). As shown, the various chemical compounds exhibit different absorption spectra, which may be used to identify and distinguish between the compounds. FIG. 21 shows a plot of absorbance values for chlorophyll a (Chl a) and chlorophyll b (Chl b) from Hartmut K. Lichtenthaler and Claus Buschmann, Current Protocols in Food Analytical Chemistry, 2001, F4.3.1-F4.3.8. Circles in FIG. 21 indicate the absorbance values that were extracted from the spectra corresponding to six narrowband irradiator wavelengths (365 nm, 450 nm, 530 nm, 630 nm, 660 nm, and 730 nm), resulting in a vector of values [x, y]=[0.52, 0.01, 0.05, 0.18, 1.00, 0] for chlorophyl a, and a vector of values [x, y]=[0.20, 1.33, 0.05, 0.18, 0.10, 0] for chlorophyl b. The extracted vectors may be converted to reflectance data and featurized to create feature sets for the presence of chlorophyll a and chlorophyll b. As shown, the extracted vectors for chlorophyl a and chlorophyl b are easily distinguishable.

The image processor 5000A may detect various conditions of interest using the acquired imagery and/or sensory data and the reference condition library. Spectral and sensory values measured by the imaging system 5050A may represent certain plant properties. These measured values may be used to characterize the plants by comparing them to labeled feature sets. The measured values may be matched with reference conditions in the reference condition library 5120A. For example, the image processor 5000A may identify conditions such as plant type, growth stage, disease, nutrient deficiencies, nutrient related traits, chemical composition, chlorophyll estimation, and biotic and abiotic stresses. Certain plant structures (e.g., flowering sites) and/or morphological characteristics may also be identified in an image. This list in non-exhaustive and one may appreciate that any number of conditions of interest may be identifiable using these methods.

As another example, the image processor 5000A may detect various chemical compounds based on their respective peak absorptance and/or peak reflectance including, but not limited to, mold, mildew, photosynthetic compounds, water, NO₃, NO₂, P₄, K⁺, C₂H₄, CH₄, O₂, CO₂, and thermal radiation (e.g., LWIR radiation). The presence of these compounds may vary between different plant species. For a particular plant species, the amount of these compounds relative to a nominal baseline, as measured by the imaging system 5050A, may provide valuable information on various aspects of the plant's development including, but not limited to, the stage of development, prospective crop yield, appearance, nutritional composition, structural integrity, flowering, and pollination.

The data collected by the imaging system 5050A may be used to monitor the development of plants and/or to provide feedback to adjust other components of the CEH (e.g., the total intensity or spectral intensity of the light emitted by the illuminating light sources) in order to improve the health and growth of the plants. For example, if the imaging system 5050A detects damage to the plants caused by pests, the illuminators may be adjusted to illuminate the plants with more UV light as a form of repellant. In another example, the imaging system 5050A may detect the presence of mildew in the environment. In response, illuminators may change humidity levels in the CEH system as a countermeasure. In another example, the imaging system 5050A may acquire data over time to assess changes to the plant during a typical day/night cycle (e.g., blooming for short day/long day plants). This information may be used to alter when the plant blooms by adjusting the illuminators to illuminate the plants with more/less near infrared light (e.g., 730 nm light). In this manner, plants may be grown at a faster rate. The imaging system 5050A may also characterize the morphology of the plants, which in turn may be modified by illuminating the plants with radiation at different wavelengths (e.g., 730 nm wavelength radiation).

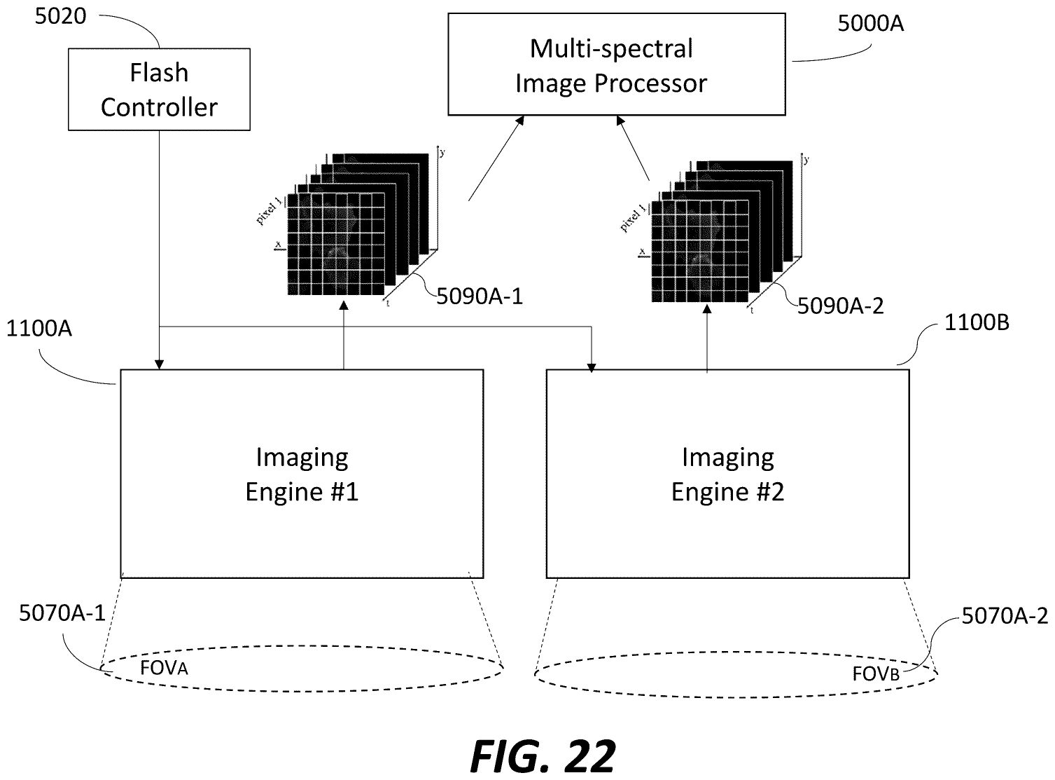

The imaging system 5050A may include more than one imaging engine 1100 to image/sense a greater portion of the environment. For example, FIG. 22 illustrates an imaging system with two imaging engines 1100A and 1100B, respectively. Each imaging engine may be controlled by the same or different flash controllers 5020. Each imaging engine may include at least one imager/sensor 1005 that defines each imaging engine's field of view 5070. The two imaging engines may have separate fields of view, 5070A-1 and 5070A-2, respectively. The two imaging engines may have partially overlapping fields of view. In this case, the image processor 5000A may easily overlay and/or stitch together images 5090A-1 and 5090A-2, respectively, acquired by each imaging engine with a high level of accuracy. Overlapping fields of view may provide a higher resolution, more continuous multispectral image. Alternatively, the fields of view 5070A-1 and 5070A-2 may not overlap. In this case, the imaging system may provide a larger collective field of view including a larger portion of the environment. As a tradeoff, the resulting images may have lower resolution and/or have areas of discontinuity.

In some implementations, the various camera(s)/sensor(s) 1005 may acquire imagery 5090 at different fields of view 5070. Thus, the images may be orthographically corrected prior to stitching to ensure the multisensory image does include distortions cause by the different fields of view. Said in another way, the images may be orthographically corrected to ensure each of the images represents a substantially similar orthographic view of the imaged object(s) and/or environment.

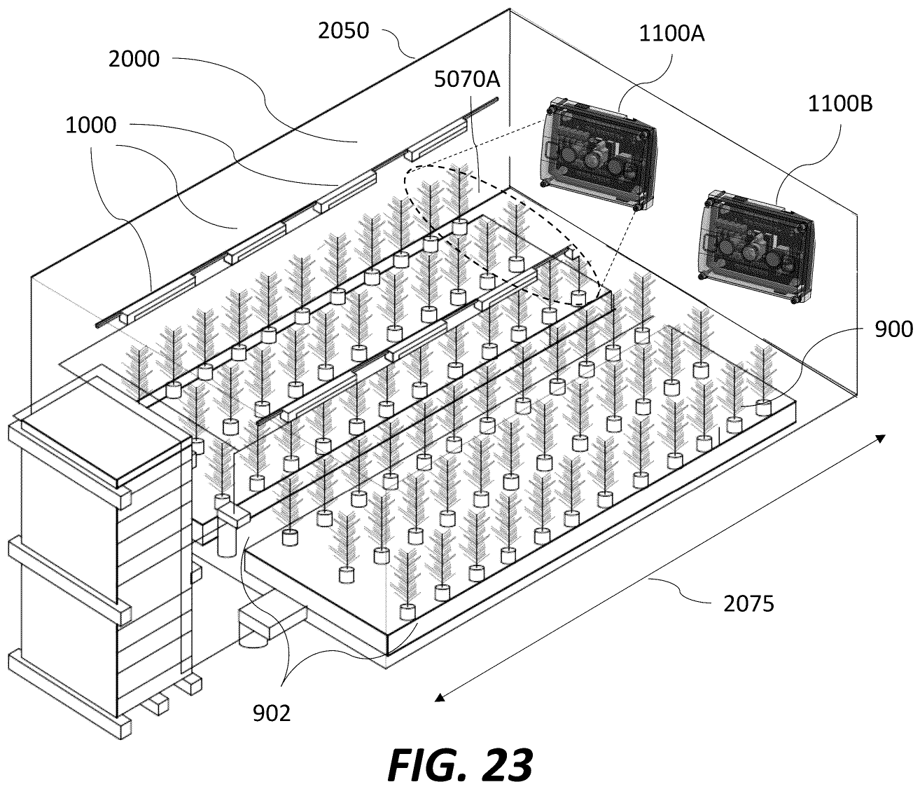

In one implementation, the one or more imaging engines 1100 may be stand-alone modules integrated into the CEH. In another implementation, the one or more imaging engines may be integrated with other components of the CEH system (e.g., lighting fixtures, HVAC, humidifiers). FIG. 23 shows an implementation with two imaging engines 1100A and 1100B integrated with a CEH system 2000, where imaging engines are mounted in the CEH system 2000 transverse to a long wall 2075 so that the field of view 5070A includes a plurality of plants 900 on a shelf support structure 902. However, imaging engines may be mounted anywhere within a CEH system, such as on any wall, floor, ceiling, shelf or other support, HVAC system, or lighting fixture.

The CEH system 2000 may be enclosed, at least in part, by a building structure such as a greenhouse, a grow room, or a covered portion of a field in order to provide some degree of control over environmental conditions. One or more artificial lighting systems are often used in such CEH systems to supplement and/or replace natural sunlight that may be obstructed by the building structure or insufficient during certain periods of the year (e.g., winter months). The use of an artificial lighting system may also provide a measure of control where the intensity and spectral characteristics of the lighting system may be tailored to improve the photosynthetic rates of plants. Various types of artificial lighting systems may be used including, but not limited to, a high intensity discharge lamp, a light emitting diode (LED), and a fluorescent lamp.

Artificial lighting systems, however, generate heat, which when dissipated into the environment may contribute significantly to the cooling load of the controlled agricultural environment. Conventional CEH systems may include a dehumidifier to manage the relative humidity of the environment and an air conditioner, which may include a fan coil, compressor, and condenser to maintain the controlled agricultural environment within a desired temperature envelope. Other CEH systems may include a fluid cooling system integrated into the lighting fixture such that a substantial portion of the heat generated by one or more illuminators in the lighting fixture is captured by the fluid cooling system. In this manner, the amount of heat transferred to the environment by the lighting fixture may be substantially reduced, thus decreasing the cooling load and the energy input for any air conditioning systems that may be in the controlled agricultural environment. In some implementations, the fluid cooling system may be coupled to a hydronics system to distribute waste heat from the lighting fixture to control the temperature of the growing area or a separate interior space (e.g., a residential building). In some implementations, two or more lighting fixtures may be connected in series, or “daisy-chained,” where electrical and piping connections are shared to support a continuous electrical circuit and coolant circuit. The lighting fixture may also provide electrical connections to power one or more sensors/imagers in the multisensory imaging system 5050 to monitor various environmental conditions. In this manner, the fluid-cooled LED-based lighting fixture may also function as an integrated sensor platform for the multisensory imaging system 5050.

One or more imaging engines may be integrated with or disposed on lighting fixtures 1000 providing artificial lighting in a CEH system 2000. In this case, the lighting fixtures 1000 may define a (x,y) coordinate plane that may be used to index the position of each imaging engine and the acquired imagery. Alternatively, an imaging engine may be otherwise disposed in the CEH and coupled to a lighting fixture 1000 via a wired or wireless connection. For example, an imaging engine may be coupled to the ports of a lighting fixture 1000 via a PoE cable or USB cable. In another example, the imaging engine may be coupled to a remote device (e.g., a computer, a server) that controls one or more illuminators via a separate wired connection. The imaging engine and the lighting fixtures may have WiFi antennas and accompanying electric circuits to facilitate wireless communication.

In one aspect, a stand-alone imaging engine may provide greater ease in installation and replacement. For example, the imaging engine may be readily connected (or disconnected) from a lighting fixture 1000. The plug-and-play configuration allows the imaging engine to be installed at any desired lighting fixture 1000 in the CEH system 2000. In some implementations, the imaging engine may also be disconnected from a lighting fixture for maintenance or replacement with an updated and/or different imaging engine.

In another aspect, the imaging engine may provide greater flexibility in terms of deployment in an environment. For example, the imaging engine may be installed for a subset of the lighting fixtures 1000 present in the environment depending on the desired coverage of the environment. The imaging engine may also be installed without being constrained to the locations of lighting fixtures in the CEH system. Thus, the coverage provided by the lighting fixture and the imaging engine may be decoupled. Additionally, the imaging engine may be oriented such that the field of view covers the environment from different perspectives (e.g., a side view of the plant stems, a top-down view of the plant leaves). Different perspectives may provide a means for acquiring 3D imagery.

In some implementations, the image processor 5000A can be a computer or a server, which processes and stores various data from the imagers/sensors 1005. The image processor 5000A may also include a human-machine interface (HMI) that allows users to monitor and control various aspects of the agricultural environment. For example, users may access various images and sensory data obtained by the imagers/sensors 1005, view and display various images, sensory data, vectors of values, and conditions of interest. The users may also implement or modify imaging processing, and control one or more control systems in the CEH, e.g., lighting, heating, air flow, hydronics, and humidity conditioning systems.

In some implementations, the HMI may enable users to select one or more pixels from a multispectral image acquired by the multispectral imaging system and display the data collected at the one or more pixels. The HMI may also enable users to select one or more pixels from a multispectral image and display conditions 5160A identified by the image processor 5000A. To facilitate selection of pixels, the HMI may include a representation of the agricultural environment. For example, various top and side views of different arrangements of plants in the agricultural environment may be shown by the HMI. The representation of the agricultural environment may be overlaid with images and/or data recorded by various imagers/sensors 1005A in the multispectral imaging system. The HMI may also display operating parameters of various control systems (e.g., power draw from lighting fixtures 1000, pump power in a hydronics system) and environmental parameters (e.g., air temperature, leaf temperature, air flow rate, relative humidity, PPFD, pH level). The HMI may also allow users to select different growing areas or rooms in an environment, views of the environment (e.g., top view, side view, perspective view), and control systems coupled to the images/sensors 1005 (e.g., various lighting fixtures 1000). Data can also be updated in real-time, selected from list of recorded times, or displayed as an average over a period of time.

The HMI may allow users to display historical images, data, or conditions of interest 5160A determined by the processor 5000A as a function of time. For instance, multispectral imagery may be recorded and displayed over a period of several days. Data can be recorded continuously in real-time or incrementally over set time increments (e.g., every 30 minutes, 60 minutes, and 3 hours).

The HMI may also allow users to adjust control systems (e.g., adjusting the output of a lighting fixture 1000 to simulate a sunrise and sunset). In some implementations, the processor 5000A may automate, at least in part, various controllable environmental parameters based on conditions determined by the processor 5000A and user-defined criteria (e.g., set temperature, relative humidity, CO2 concentrations).

An Exemplary Multisensory Imaging System Using a Distributed Sensor Grid

In some implementations, a multisensory imaging system may provide an array of sensors integrated into the CEH system to collect various types of measurements. The sensors may be arranged spatially within the CEH system to collect measurements from a large portion of the CEH system.

In one exemplary implementation, multiple sensors are distributed in a CEH system as a distributed sensor grid. The distributed sensor grid includes one or more node arrays, where each node array divides at least a portion of the controlled agricultural environment into nodes, e.g., discrete points in space which have a known location (e.g., absolute or relative) in the environment. In various aspects, a given node array of a distributed sensor grid may be one dimensional, two dimensional, or three dimensional (e.g., based at least in part on the distribution of growing areas and/or crops in the controlled agricultural environment). For example, in some implementations, a given node array may include multiple nodes arranged in a substantially linear or curvilinear fashion spaced along a row of plants to provide a one-dimensional (1D) node array. Another type of node array may include multiple nodes arranged in a horizontal plane substantially parallel to a floor or a ceiling in the CEH system to provide a two-dimensional (2D) node array. Yet another type of node array may include multiple nodes arranged in multiple horizontal planes substantially parallel to the floor or ceiling in the CEH system, wherein the respective horizontal planes of nodes constitute multiple vertical levels corresponding to different zones of interest in the controlled growing environment (e.g., the soil, the plant, the lighting canopy, and the ambient environment) to provide a three-dimensional (3D) node array.

Generally, each node in a 1D, 2D, or 3D array may include a number of discrete sensors. In this manner, the node array includes a spatial arrangement of sensors, with each sensor positioned at respective indexed/addressable positions (pixels) in a 1D, 2D, or 3D spatial arrangement. Thus, each sensor measurement that is sensed at a given sensor node can be represented as a pixel value of a pixel in an image.

The distributed sensor grid may act as a compound-eye in the CEH system. Each sensor node may act as a spatially-indexed pixel, and together the pixels may form a compound-eye multisensory image. The dimensionality of the node array determines the dimensionality of the multisensory image. For example, a node array arranged in a substantially linear fashion along a row of plants provides a 1D multisensory image. A node array arranged in a horizontal plane substantially parallel to a floor in the CEH system provides a 2D multisensory image. A node array arranged in multiple horizontal planes substantially parallel to the floor in the CEH system provides a 3D multisensory image.

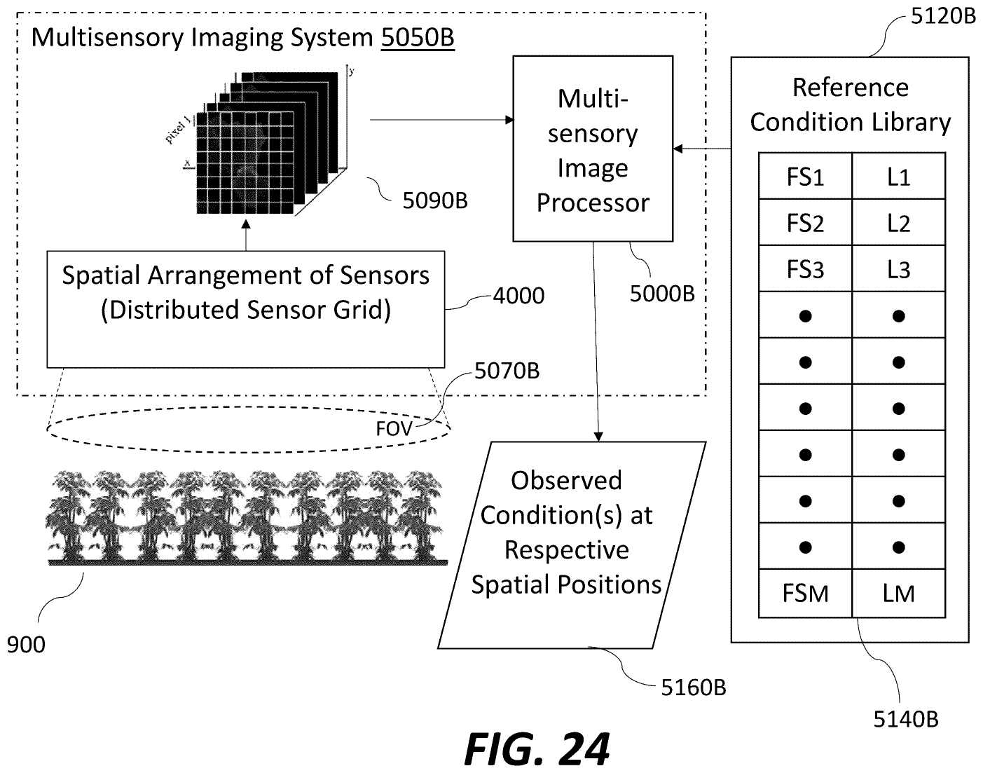

FIG. 24 shows an exemplary implementation of a multisensory imaging system 5050B with a distributed sensor grid 4000. The multisensory imaging system 5050B may collect various types of sensory data at each node in the distributed sensor grid 4000. The spatial arrangement of the node array defines the collective field of view 5070B. The size of the collective field of view 5070B may range in size between a portion of the environment that includes one or more plants 900 to an entire room of the environment. The imaging system 5050B may generally include a multisensory image processor 5000B (“processor 5000B”). The multisensory image processor 5000B may compile collected measurements from a particular type of sensor to generate a compound-eye mono-sensory imagery. The image processor may overlay a series of mono-sensory images 5090B to generate a multisensory image. The image processor 5000B may process acquired mono-sensory images 5090B to determine the presence of one or more observable conditions 5160B using a reference condition library 5120B.

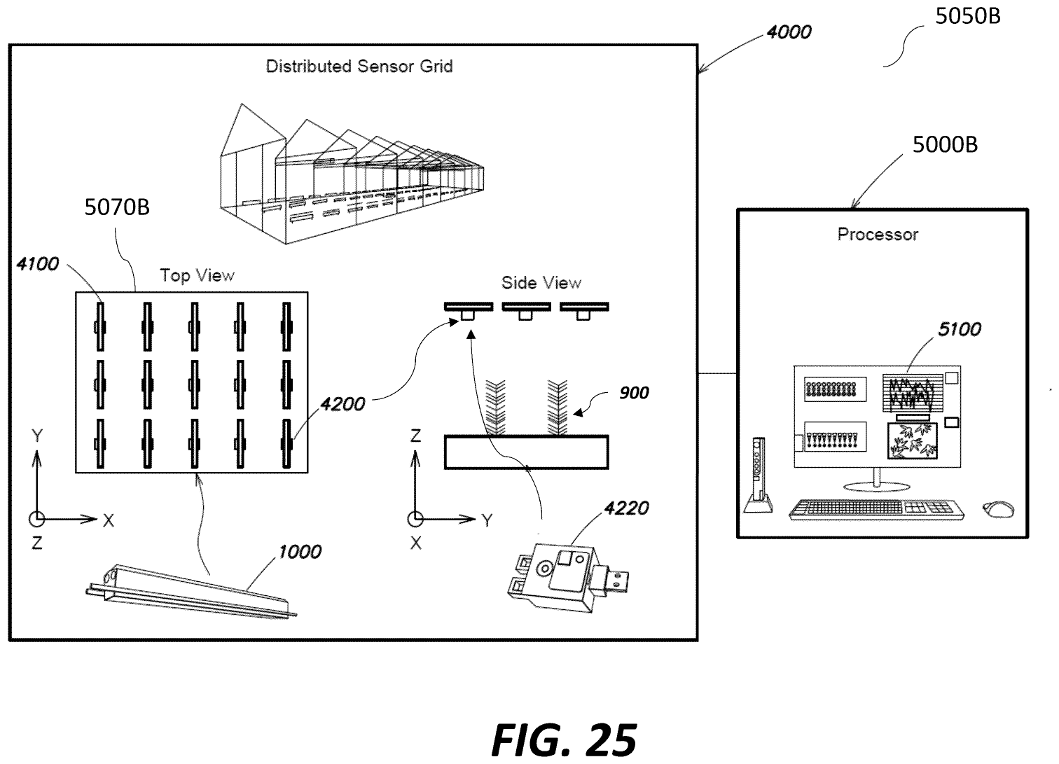

FIG. 25 shows an exemplary implementation of the multisensory imaging system 5050B in a CEH system. The distributed sensor grid 4000 includes one or more node arrays 4100, and each node array contains multiple nodes 4200 respectively positioned at corresponding coordinate locations (e.g., x, y, and z coordinates) in the controlled agricultural environment. At a given node 4200, the distributed sensor grid further includes one or more sensors 4220 deployed at the node to monitor growth conditions in proximity to the node. In the example illustrated in FIG. 25, the distributed sensor grid is arranged as a two-dimensional node array, in which an arrangement of lighting fixtures 1000 constitutes a horizontal plane of nodes defined by an x-axis and a y-axis of the node array (see “Top View”).

Each node array 4100 covers at least a portion of an agricultural environment. In some controlled agricultural environments, one node array may be sufficient given a particular number and arrangement of plants in a growing area, while in other environments multiple node arrays may be employed to flexibly configure a distributed sensor grid (in some instances over multiple growing areas in the environment with different layouts and/or different crops). For example, in vertical farming (in which different growing areas are stacked one on top of another in a vertical arrangement), one or more node arrays 4100 can be used for each vertically-stacked growing area in the environment. In another example, an agricultural environment can be divided into separate climate-controlled rooms with each room having one or more node arrays 4100. Each node array 4100 divides the covered portion of the agricultural environment into a grid of nodes 4200, where each node 4200 is a discrete point with a known coordinate location within the node array 4100. As noted above, respective nodes 4200 can include one or more sensors 4220 to monitor growth conditions proximate to a given node (e.g., in a volume of space around the node, which may depend in part on the type(s) of sensor(s) deployed at the node). In some implementations, the number of nodes 4200 in a node array 4100 can depend upon the constraints imposed on or by the agricultural environment.

The coordinate location of each node 4200 can include one or more coordinate components to describe the location of a node 4200 in the agricultural environment. In some implementations, the coordinate location of a node 4200 can correspond to a physical location in the agricultural environment with reference to a spatial origin. For example, the corner of a growing area can be set as the origin of the coordinate system and nodes 4200 can be defined at known and/or defined distances from the origin along one or more axes (e.g., respective x, y, and z axes). In some implementations, the coordinate location can correspond to an indexed location related to one or more aspects of the physical arrangement of the agricultural environment (e.g., dimensions and/or shape of one or more growing areas, arrangement of plants in a given growing area, arrangement of control systems in a given growing area). In one implementation, the coordinate location can correspond to an indexed location related to the spatial arrangement of lighting fixtures.

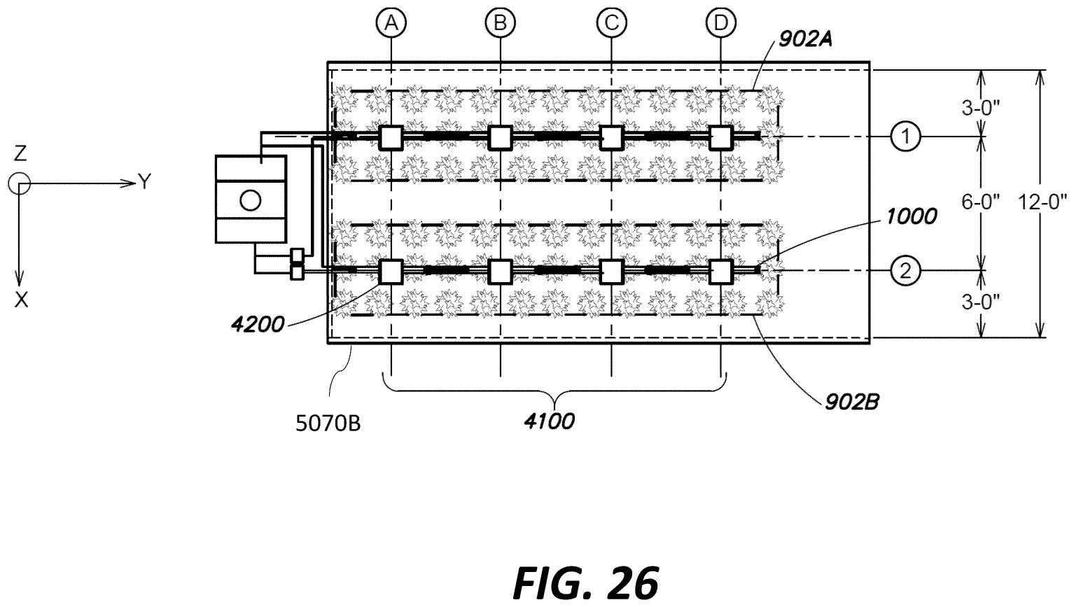

FIG. 26 shows a top-down view of a 2D node array 4100 of an imaging system 5050B indexed according to x and y coordinates. Spatially indexed nodes may act as pixels in compound-eye multisensory imagery. FIG. 26 illustrates an agricultural environment that includes two elongated shelves 902A and 902B disposed proximate to each other at a spacing in a growing area. Three rows of plants are positioned next to each other on each shelf along the long length of the shelf. Above each shelf, positioned generally over the middle row of the three rows of plants, are four lighting fixtures 1000. In this example, a y-axis for the node array is chosen parallel to the long length of the shelves 902A and 902B (and, accordingly, the x-axis is parallel to the short width of the shelves). The center lines of the shelves themselves along the length (e.g., halfway across the width of a shelf) define indexed positions 1 and 2 along the x-axis, and the four lighting fixtures 1000 disposed above each of the shelves 902A and 902B respectively define indexed positions A, B, C, and D along the y-axis (e.g., the centers of the lighting fixtures may correspond with the indexed positions A through D). As discussed in greater detail below, it should be appreciated that the example node array of FIG. 26 based on two shelves of plants, four lighting fixtures per shelf, and four vertical levels is provided primarily for purposes of illustration, and that other node array configurations are contemplated according to the present disclosure. For example, one can easily envision a 1D sensor array arranged in a similar fashion.

One or more environmental sensors 4220 can be deployed at a particular node 4200 to monitor parameters relevant to growth conditions. The sensors 4220 can include, but are not limited to, a visible light sensor, a UV light sensor, an air temperature sensor, a relative humidity sensor, an airflow sensor, a CO2 sensor, an IR temperature sensor, a volatile organic compound sensor, a pH sensor, a particulate matter (PM2.5) sensor, and cameras configured to capture still images or videos of the agricultural environment with various spectral qualities, as described above. In some implementations, multiple sensors 4220 can be packaged into an integrated sensor assembly to simplify wiring and ease of installation. Each node 4200 in a node array 4100 can also include different combinations of sensors 4220 pertinent to the region of the environment the node 4200 is located in. For example, different types of sensors 4220 may be deployed according to the object of interest in an environment.

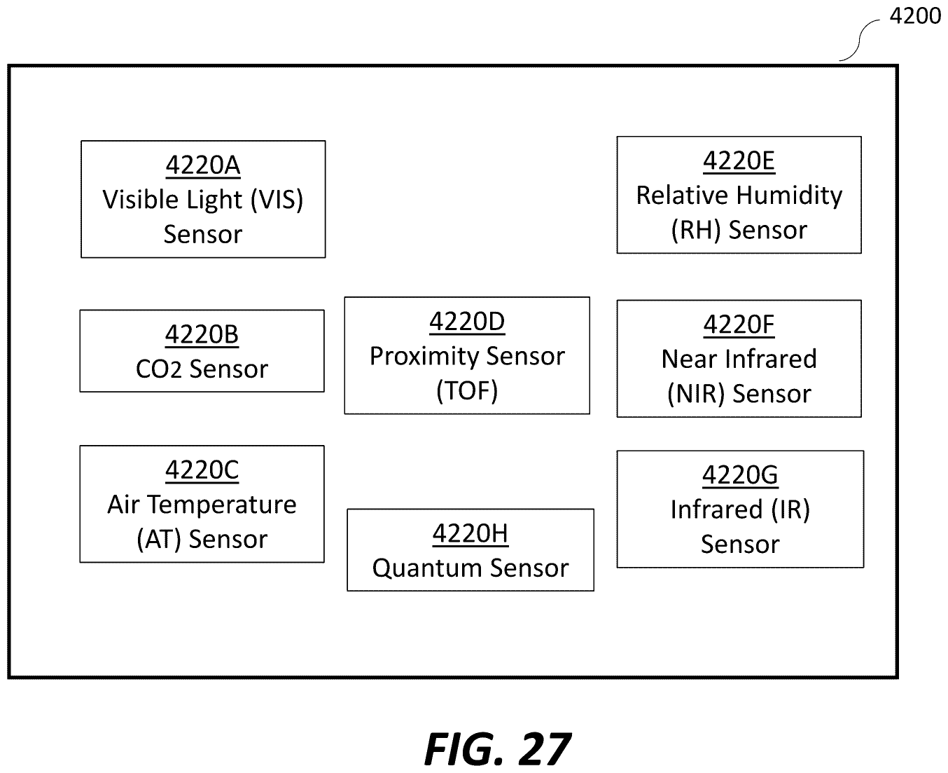

FIG. 27 shows a block diagram of sensors 4220 at a particular node 4200 to measure various conditions in the CEH according to an exemplary implementation. A particular node 4200 may include a visible light sensor 4220A, a CO₂ sensor 4220B, an air temperature sensor 4220C, a proximity sensor 4220D, a relative humidity sensor 4220E, a near infrared (NIR) sensor 4220F, an infrared sensor 4220G, and a quantum sensor 4220H.

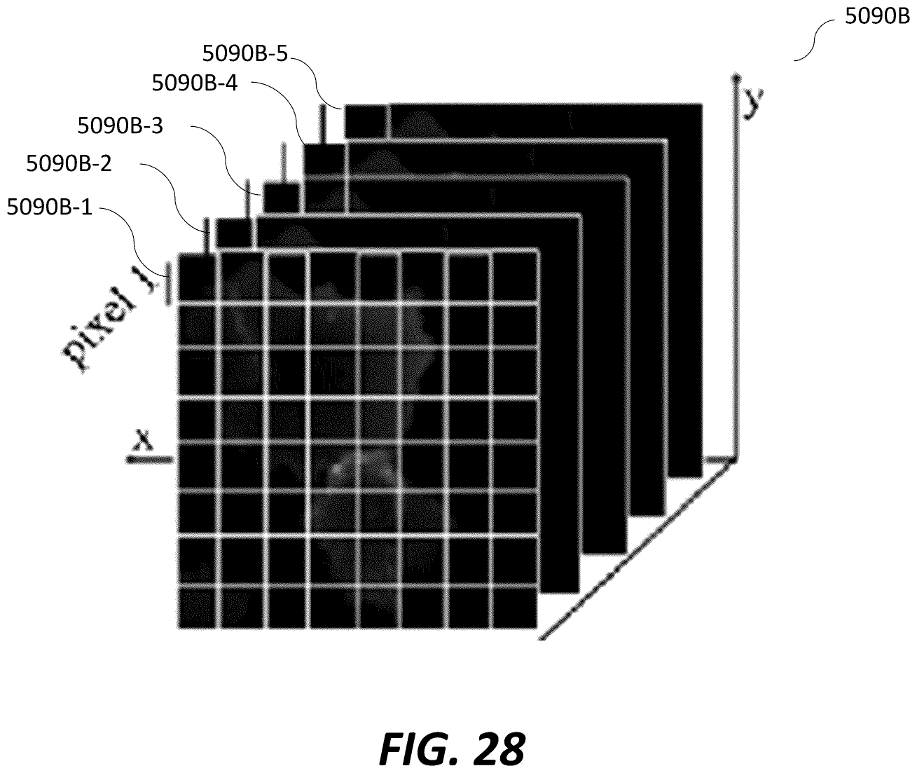

FIG. 28 shows an exemplary set of 2D mono-sensory compound-eye images 5090B-1-5090B-5 acquired by the multisensory imaging system 5050B. Each sensor node 4200 has a measured value for each sensor 4220. Each sensor node acts as a spatially-indexed pixel, and together the plurality of pixels form a compound-eye image. FIG. 28 shows an exemplary set of compound-eye images corresponding to measurements from different sensors. Image 5090B-1 corresponds to measurements using the CO₂ sensor 4220B. Image 5090B-2 corresponds to measurements using the relative humidity sensor 4220E. Image 5090B-3 corresponds to measurements using the proximity sensor 4220D. Image 5090B-4 corresponds to measurements using the NIR sensor 4220E. Image 5090B-5 corresponds to measurements using the visible light sensor 4220A. These mono-sensory images 5090B-1-5090B-5 may be overlaid to produce a 2D multisensory image. FIG. 28 shows five discrete mono-sensory images corresponding to five types of sensor measurements in the space occupied by the set of nodes. However, any number of compound-eye mono-sensory images could be acquired by the imaging system 5050B, depending on the number of different sensors 4220 present.

Generally, the multisensory image generated by the imaging system 5050B includes a plurality of pixels (nodes). Each pixel has a vector of values, each value corresponding to a different type of sensor. The vector of values may provide the basis for a feature set used by the image processor 5000B to non-destructively identify conditions of interest. A machine learning or deep learning algorithm may be used to facilitate identification of conditions of interest 5160B. Each pixel is digitally indexed (or “addressed”) by pixel coordinates representing a spatial position in the collective field of view 5070B. Values measured at each pixel may be featurized to create a feature set suitable for input into the algorithm. In other words, the measured values may be represented by a set of structured mathematical representations called features. In the example shown in FIG. 28, each pixel in the resulting multisensory image may correspond to a feature set that corresponds to measured values for five sensors (CO₂ sensor 4220B, relative humidity sensor 4220E, proximity sensor 4220D, NIR sensor 4220E, and visible light sensor 4220A).

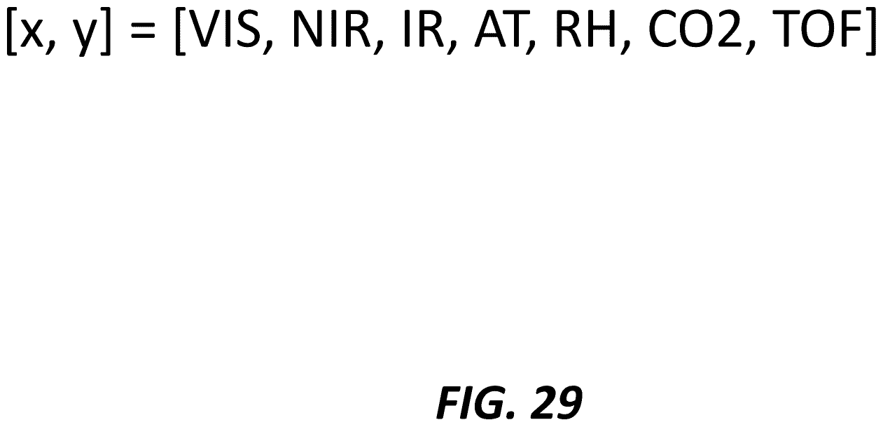

FIG. 29 shows an example feature set of seven values received as sensor signals measured by seven sensors indexed in two dimensions in the multisensory imaging system 5050B. The feature set includes values for measures of visible radiation (VIS), near infrared radiation (NIR), infrared radiation (IR), air temperature (AT), relative humidity (RH), carbon dioxide (CO₂), and distance (TOF). For a given use-case, any subset of the available features may be picked to define a feature set for a given measurement exercise. In other words, the feature set may have 2, 3, 4, or more elements. Not all measurements may be needed to identify the condition of interest.

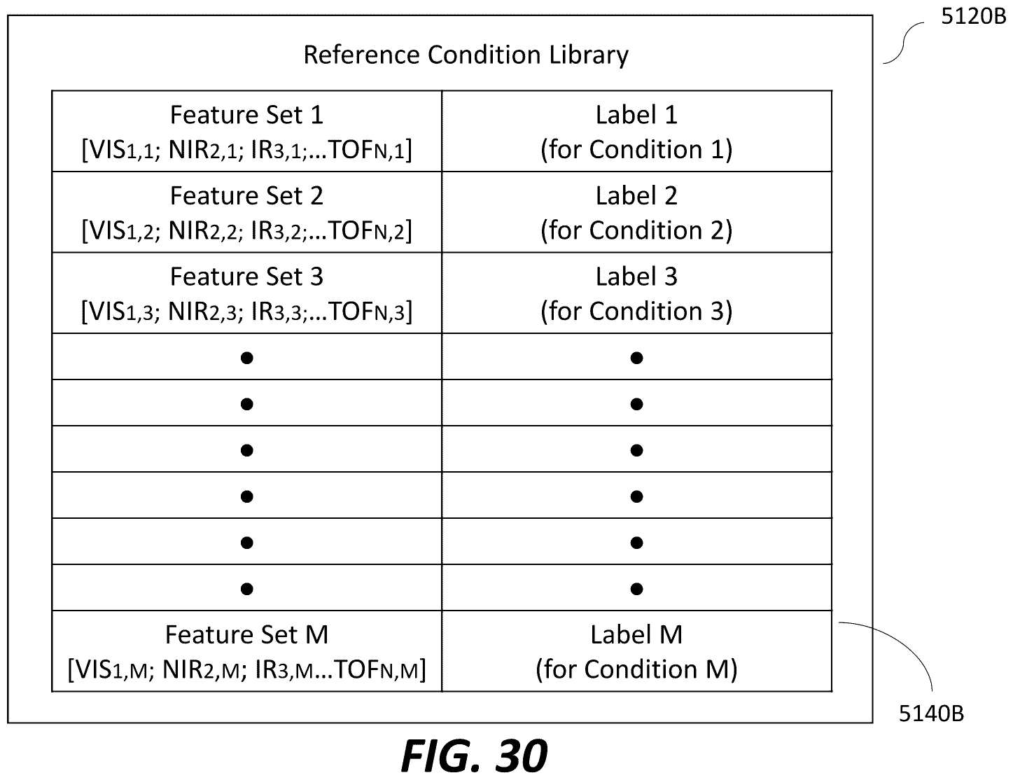

FIG. 30 shows a reference condition library 5120B including a collection of labeled conditions 5140B corresponding to respective feature sets, which may be used to observe conditions 5160B. The reference condition library 5120B may include a plurality of labeled feature sets corresponding to various reference conditions. The reference condition library may include any number of prospectively useful reference conditions that may be of interest. The image processor 5000B may use machine learning to match the feature sets at each pixel to one or more conditions of interest 5160B in the reference condition library 5120B. A feature set representing a known condition of interest can be labeled (“annotated”) and thereby facilitate model training for use in machine learning matching (e.g., with a confidence value) to identify conditions of interest observed in real time measurements of an object (e.g., plant(s)).

It should be appreciated the example combinations of sensory data described above to evaluate and determine a condition of interest are each non-limiting examples. More generally, any combination of sensory data from one or more sensors described herein may be used in conjunction with a reference condition library to identify and evaluate various conditions of interest. Further, sensors configured to measure radiation at one or more irradiation wavelengths may also be used in combination with other sensor types to identify and evaluate various conditions of interest.

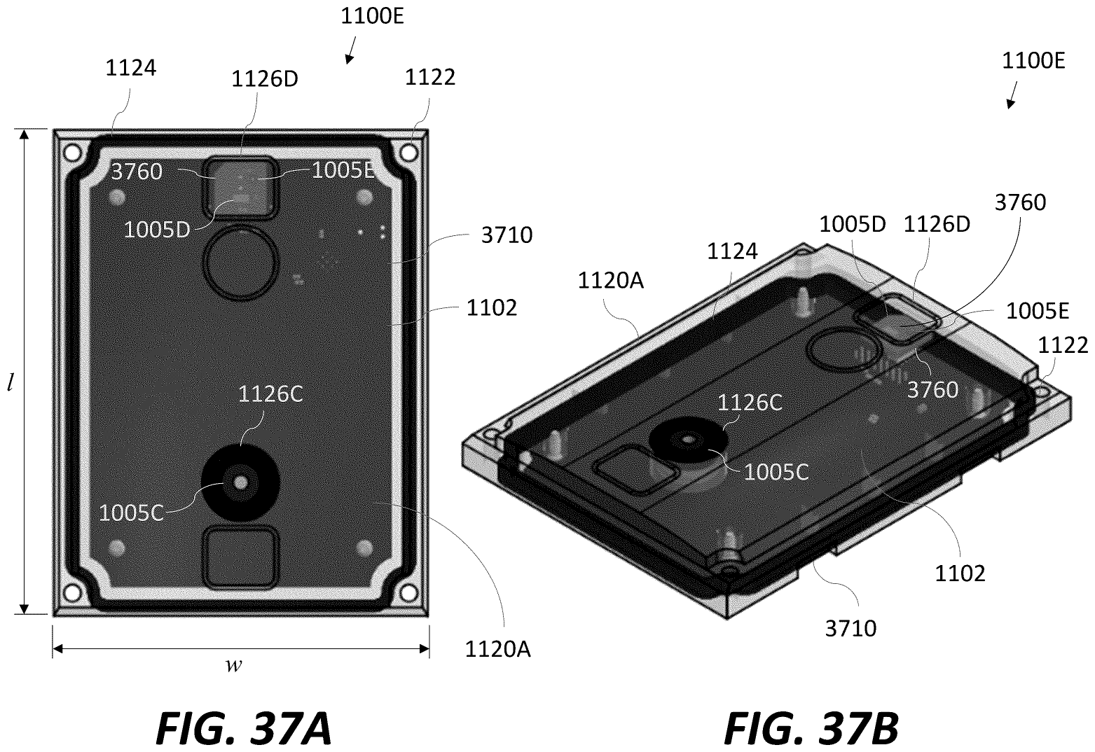

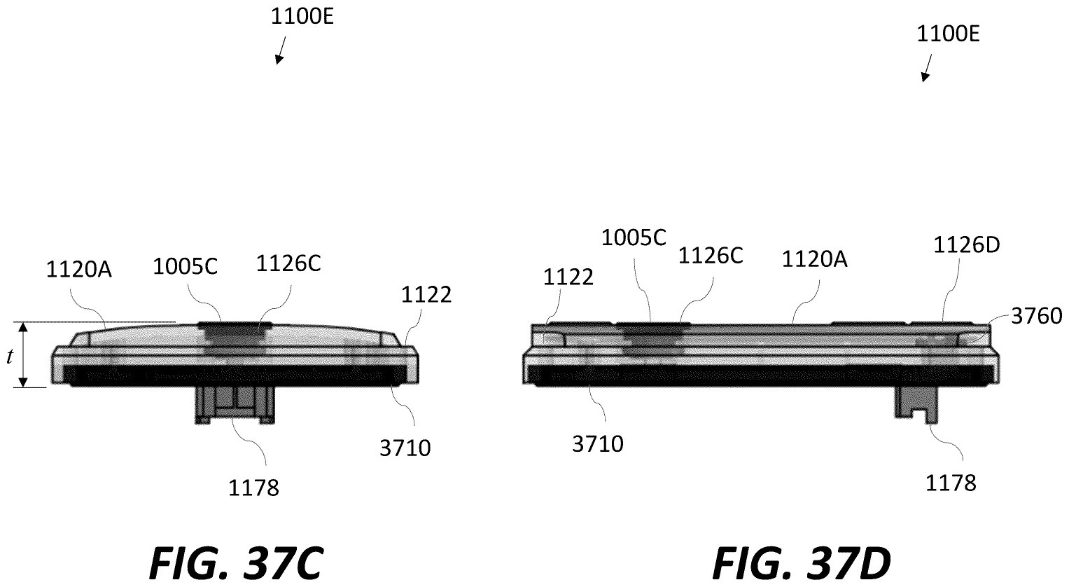

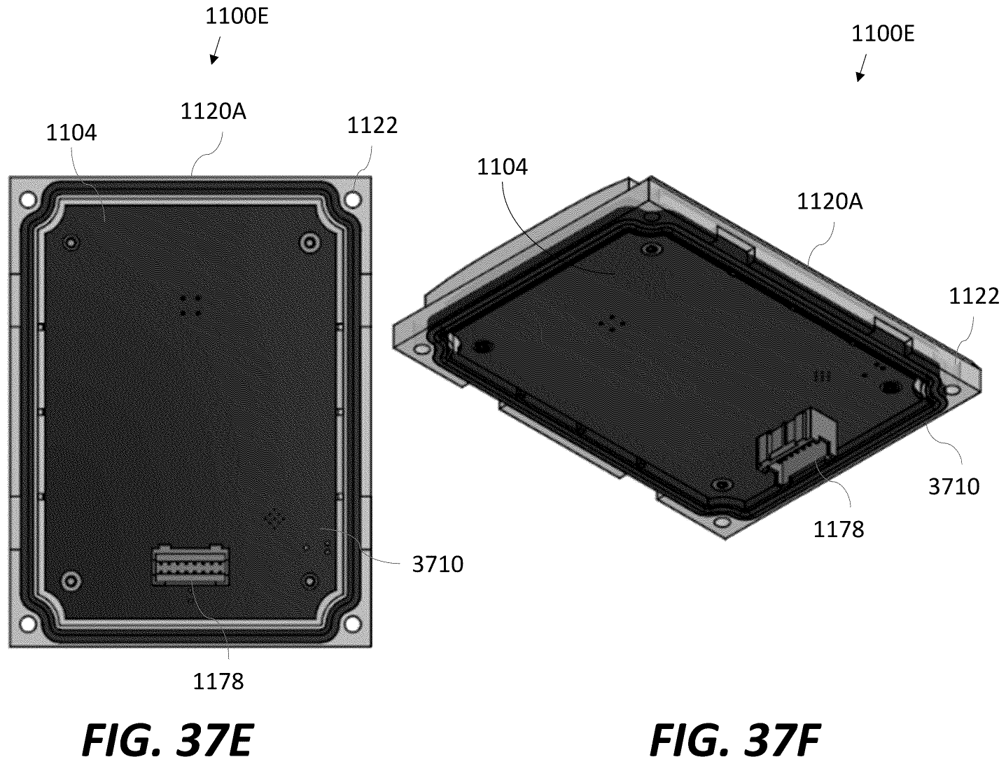

For example, an imaging engine may include an infrared thermal sensor to measure ambient temperature via infrared thermal radiation, a color light sensor to measure visible light reflected and/or emitted by the plants, and a time-of-flight sensor to measure the distance between the plants and the imaging engine (see, for example, the imaging engine 1100E shown in FIGS. 37A-37F). A processor operably coupled to the imaging engine may receive respective sensor signals from each of the three sensors where the sensory data obtained from the sensor signals represents three different measurable conditions of the CEH environment. The processor may thereafter process the sensor signals, in part, by using a reference condition library to evaluate whether the sensor signals correspond to a condition of interest. Specifically, the reference condition library may include one or more labeled feature sets that each correspond to a condition of interest where at least one labeled feature set includes reference values representing the three conditions measured by the three sensors. If the particular combination of sensor signal values corresponds to a labeled feature set of the reference condition library, the processor may then estimate or determine that a condition of interest is present in the CEH system.

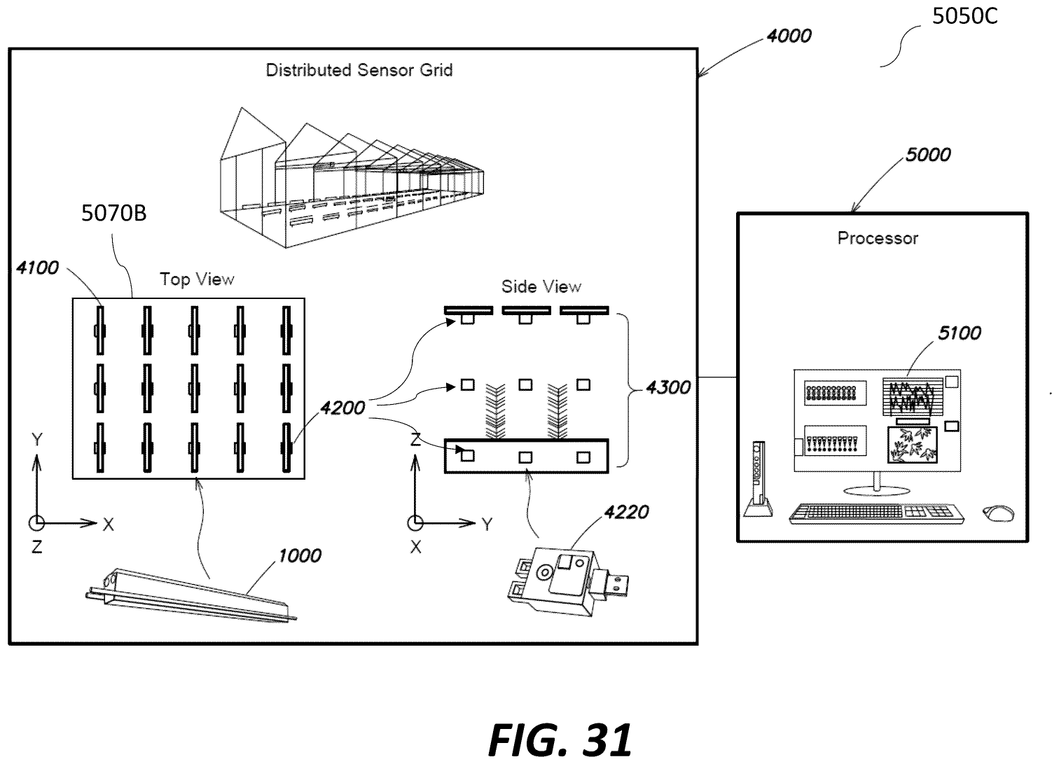

In the example illustrated in FIG. 31, the distributed sensor grid is arranged as a three-dimensional node array, in which an arrangement of lighting fixtures 1000 constitutes a horizontal plane of nodes defined by an x-axis and ay-axis of the node array (see “Top View”) and the node array also includes multiple vertical levels 4300 along a z-axis (e.g., respectively corresponding to a soil level, a plant level, and a light canopy level; see “Side View”). One or more sensors 4220 may be placed at multiple nodes or each node of the node array to comprehensively monitor growth conditions in the environment.

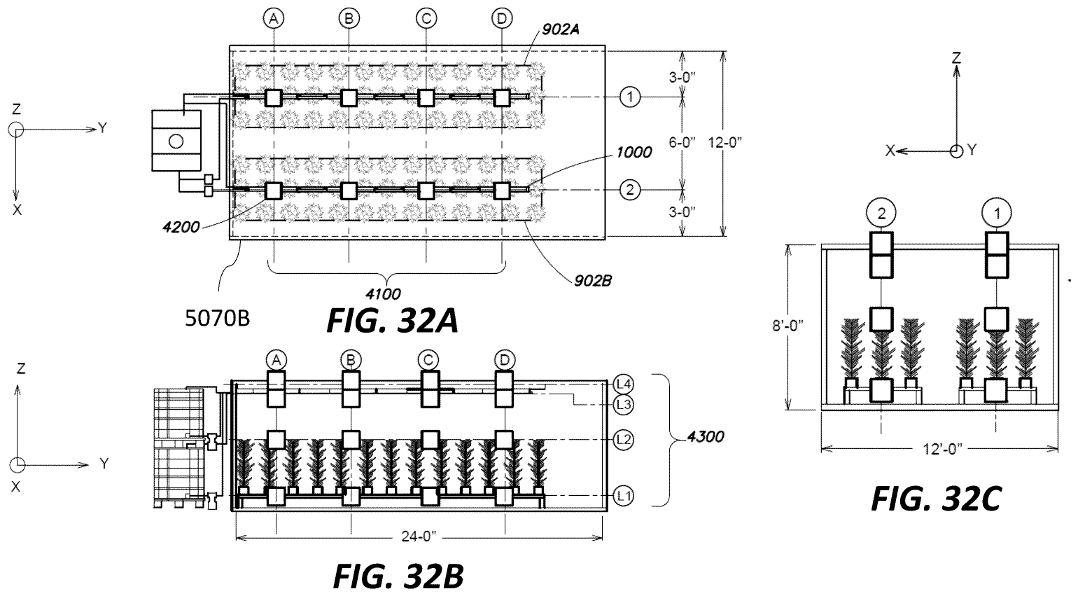

FIG. 32A shows a top-down view of a 3D node array 4100 of an imaging system 5050B indexed according to x, y, and z coordinates. FIGS. 32A-32C illustrate various views of an agricultural environment that includes two elongated shelves 902A and 902B disposed proximate to each other at a spacing in a growing area. Three rows of plants are positioned next to each other on each shelf along the long length of the shelf. Above each shelf, positioned generally over the middle row of the three rows of plants, are four lighting fixtures 1000. In this example, a y-axis for the node array is chosen parallel to the long length of the shelves 902A and 902B (and, accordingly, the x-axis is parallel to the short width of the shelves). The center lines of the shelves themselves along the length (e.g., halfway across the width of a shelf) define indexed positions 1 and 2 along the x-axis, and the four lighting fixtures 1000 disposed above each of the shelves 902A and 902B respectively define indexed positions A, B, C, and D along the y-axis (e.g., the centers of the lighting fixtures may correspond with the indexed positions A through D). The z-axis for the node array is taken along the vertical height of the environment and is divided in the example of FIG. 32 into four indexed positions or “levels” 4300 (respectively labeled as L1, L2, L3 and L4). Thus, in the example shown in FIGS. 32A-32C, there are a total of 32 nodes 4200 in the node array 4100 of the distributed sensor grid.

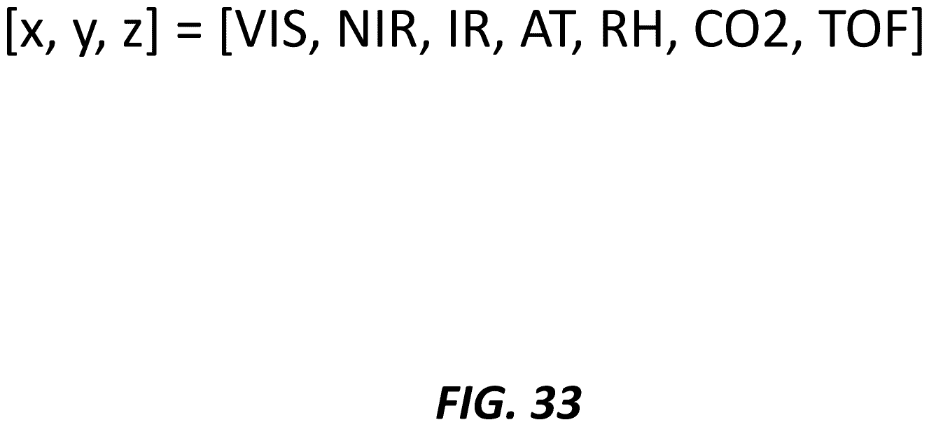

FIG. 33 shows an exemplary feature set of seven values measured by seven sensors indexed in three dimensions in the multisensory imaging system 5050B. The feature set includes values for measures of visible radiation (VIS), near infrared radiation (NIR), infrared radiation (IR), air temperature (AT), relative humidity (RH), carbon dioxide (CO₂), and distance (TOF). The feature set may have any number of features for any number of available sensor types. For a given use-case, any subset of the available features may be picked to define a feature set for a given measurement exercise. In other words, the feature set may have 2, 3, 4, or more elements. Not all measurements may be needed to identify a condition of interest. The reference condition library 5120B and a machine learning algorithm may be used to determine if one or more reference conditions are present in the 3D image in any particular pixel. The reference condition library 5120B in FIG. 30 can be used in a similar fashion as described above for observing conditions in three-dimensional imagery.

The nodes 4200 in the node array 4100 can be configured to share power and network connections to simplify the integration of multiple sensors 4220 in the distributed sensor grid 4000. In some implementations a plurality of lighting fixtures 1000 can be used as a connectivity platform for the distributed sensor grid 4000. Sensors 4220 can couple to PoE ports or the USB ports for power and networking using cables or dongles. In some implementations, multiple sensors 4220 located at various levels 4300 can be connected to a single lighting fixture 1000. For example, a soil sensor can be connected via a long USB extension cable dangled from a USB port 1012B and a lighting sensor can be connected directly to a PoE port. By connecting the plurality of lighting fixtures 1000 together, the sensors 4220 can also be connected thus forming a distributed array of sensors.

It should be appreciated that the example node array of FIG. 32 is provided primarily for purposes of illustration, and that other node array configurations are contemplated according to the present disclosure. For example, in some implementations in which the lighting fixtures 1000 serve as a connectivity platform for a distributed sensor grid, the number of nodes 4200 supported in a node array 4100 is based at least in part on the number of power and network ports available for connection with sensors 4220 deployed at respective nodes. For example, in the configuration of FIG. 32, each lighting fixture 1000 includes USB ports that may be employed to couple one or more integrated sensor assemblies to each fixture (wherein the assemblies serve as the sensors 4220 deployed at respective nodes; also, lighting fixtures 1000 may be equipped with one or more additional USB ports for this purpose). Each lighting fixture also includes PoE ports, any one or more of which ports may be employed to couple one or more sensors to each fixture.

In some implementations, the number of nodes 4200 can be determined by a user-defined density and/or coverage area in the agricultural environment. For example, an IR temperature sensor 4220G can have a finite field of view. An array of integrated sensor assemblies, each corresponding to a node 4200, can thus be installed and spaced apart such that the respective fields of view of the IR temperature sensors 4220G sufficiently overlap to effectively provide sensing coverage for the plants in the environment.

The distribution of nodes 4200 in the node array 4100 can also vary spatially and quantitatively. In some implementations, the nodes 4200 can be uniformly distributed. For example, a uniform array of lighting fixtures 1000 can be deployed with an integrated sensor assembly connected to USB ports on each lighting fixture 1000, as described above. In some implementations, the nodes 4200 distributed in the node array 4100 can be non-uniform. For example, the number of nodes 4200 may vary according to each level 4300 of a plant system where, for example, more nodes 4200 can be used to monitor soil quality than the ambient environment conditions due to variations in coverage by each type of sensor. In another example, an agricultural environment can include different plant species of varying size. The nodes 4200 can be more closely spaced for smaller-sized plants and sparser for larger-sized plants. Additionally, a node 4200 may not include a sensor 4220. Such empty nodes 4200 can be used to define a non-uniform distribution of sensors 4220 with a uniform distribution of nodes 4200. For example, soil quality sensors can occupy every node 4200 at the bottom level 4300 and ambient environment sensors can occupy every other node 4200 at the top level 4300 with empty nodes 4200 in between.

As described above, the node array 4100 can include multiple levels 4300 (e.g., along a z-axis) that correspond to various zones of interest in the controlled growing environment. Zones of interest in a plant system may include a soil level, a plant level, a light canopy level, and an ambient environment level. The soil level can provide data on soil conditions, such as pH value and chemical composition. The plant level can provide data on the leaf temperature or CO2 concentrations near the plant. The light canopy level can provide data on the illumination source, e.g., PPFD, air temperature, relative humidity, or heat dissipation or electrical power for the lighting fixture 1000. The ambient environment level can provide data on air circulation or the temperature of the walls or ceiling of the agricultural environment.

Human Machine Interface

In some implementations, the distributed sensor grid is be connected to a multi-sensory image processor 5000B, as shown in FIG. 25. The image processor 5000B can be a computer or a server, which processes and stores various data from the sensors 4220 in the distributed sensor grid. The image processor 5000B may also include a human-machine interface (HMI) 5100, an exemplary implementation of which is shown on a computer in FIG. 31, that allows users to monitor and control various aspects of the agricultural environment. For example, users may access various data obtained by the sensors 4220, view and display various data and sensory imager, and control one or more control systems, e.g., lighting, heating, air flow, hydronics, and humidity conditioning systems.

In some implementations, the HMI 5100 may enable users to select one or more nodes 4200 from an array 4100 in the distributed sensor grid and display the data collected by these nodes 4200. The HMI may also enable users to select one or more nodes 4200 from an array 4100 in the distributed sensor grid and display conditions 5160B identified by the image processor 5000B at these nodes. To facilitate selection of nodes 4200, the HMI 5100 may include a representation of the agricultural environment. For example, FIG. 32 shows various top and side views of different arrangements of plants. The representation of the agricultural environment may be overlaid with data recorded by various sensors disposed in the distributed sensor grid. The data shown may include, but is not limited to, the operating parameters of various control systems (e.g., power draw from lighting fixtures 1000, pump power in a hydronics system) and environmental parameters (e.g., air temperature, leaf temperature, air flow rate, relative humidity, PPFD, pH level). The HMI 5100 may also allow users to select different node arrays 4100 (e.g., separate growing areas or rooms in an environment), views of the environment (e.g., top view, side view, perspective view), and control systems coupled to the sensors 4220 (e.g., various lighting fixtures 1000). Data can also be updated in real-time, selected from list of recorded times, or displayed as an average over a period of time.

In some implementations, the HMI 5100 may enable users to select and display mono-sensory compound eye images collected by the multisensory imaging system 5050B. In some implementations, the HMI 5100 may enable users to select and display multisensory compound eye images collected by the multisensory imaging system 5050B. The HMI 5100 may also enable users to select and display compound eye images of conditions of interest 5160B identified by the image processor 5000B. The HMI 5100 may allow the users to select and display images of an entire growing area in an agricultural environment or a subsection of the growing area, such as a single plant.

The HMI 5100 may allow users to display historical data, images, or conditions 5160B as a function of time. For instance, the environment temperature, relative humidity, electrical power, temperature of a lighting fixture 1000, carbon dioxide concentration, and hydronic system temperature over a period of several days. Data can be recorded continuously in real-time or incrementally over set time increments (e.g., every 30 minutes, 60 minutes, and 3 hours).

The HMI 5100 may also allow users to adjust control systems (e.g., adjusting the output of a lighting fixture 1000 to simulate a sunrise and sunset). In some implementations, the processor 5000B may automate, at least in part, various controllable conditions based on data from one or more sensors 4420, conditions determined by the processor, and user-defined criteria (e.g., set temperature, relative humidity, CO2 concentrations).

An Exemplary Multi-Resolution Multisensory Imaging System

One or more imaging engines 1100 may be coupled to the distributed sensor grid 4000 to provide a multi-resolution multisensory imaging system. In some implementations, the one or more imaging engines may acquire multispectral imagery while the sensor grid 4000 acquires sensor data for compound-eye multisensory imagery. In some implementations, the multispectral imagery and the multisensory imagery may have different scales and/or resolutions.

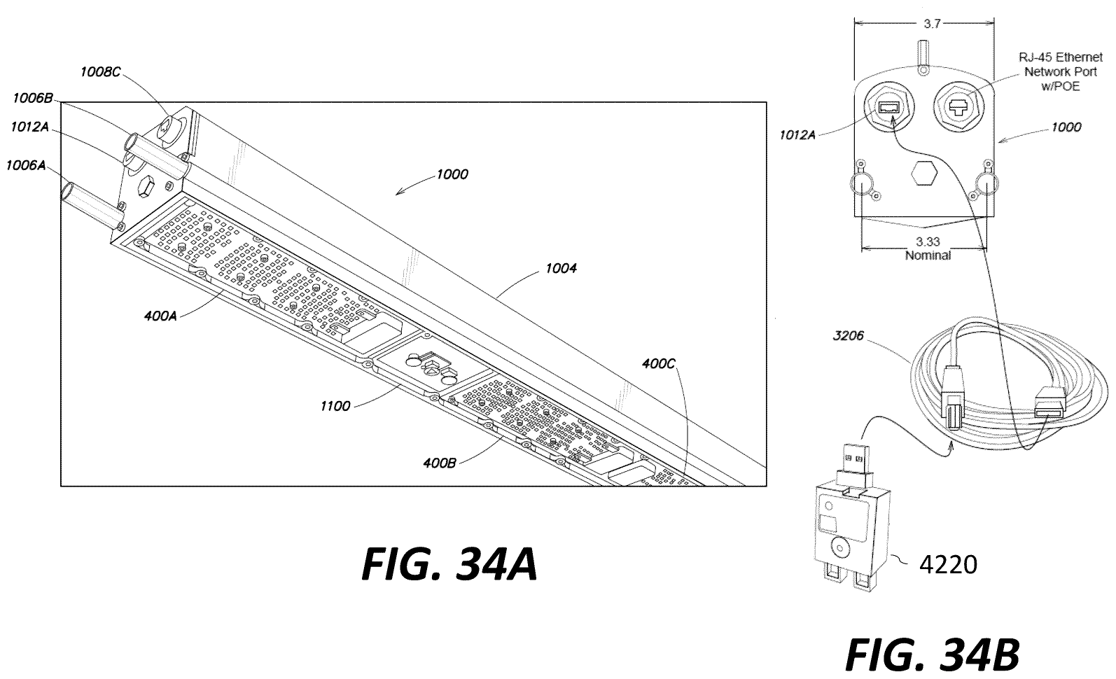

FIGS. 34A and 34B show an exemplary implementation of a multi-resolution multisensory imaging system's sensor assembly integrated into a lighting fixture 1000 in a CEH system. The sensor assembly includes an imaging engine 1100 as described above with respect to the exemplary multispectral imaging system 5050A, as well as distributed point sensors 4220 as described above with respect to the exemplary multisensory imaging system 5050B.

FIG. 34A shows a lighting fixture 1000 equipped with cameras/sensors integrated as a module serving as a multispectral imaging engine 1100 (also referred to herein as the “imaging engine 1100”). The imaging engine 1100 may define a node in the node array. As shown in the figure, in one example implementation the imaging engine 1100 may be directly mounted to the frame 1004 between the LED light sources 400A and 400B. The lighting fixture 1000 may also include onboard cooling (e.g., cooling pipes 1006A and 1006B) and various communication ports (PoE ports 1008A-1008C, USB ports 1012A) for data transfer between the lighting fixture 1000 and another device (e.g., another lighting fixture 1000, distributed point sensors 4220, a remote device, an accessory). In some implementations, the imaging engine 1100 may be electrically coupled to other components of the lighting fixture 1000 (e.g., control circuitry boards) to receive power and/or to transfer data to/from the imaging engine 1100.

FIG. 34B shows a sensor 4220 coupled to a side or end USB port 1012A of the lighting fixture 1000 shown in FIG. 34A via one or more cable-type USB couplers/extenders 3206, according to some implementations of the disclosure. The sensor 4220 may be coupled to one end of a USB cable extender 3206, and the other end of the cable extender 3206 may be coupled to the USB port 1012A of the lighting fixture. Various lengths of cable extenders may be employed for the extender 3206 so as to position the sensor assembly 4220 at different distances below the lighting fixture 1000. The cable extender 3206 may be used alone, or together with one or more other cable extenders, one or more gooseneck-type extenders, one or more adjustable angle-type extenders, one or more other types of extenders, or combinations of the foregoing.

In some implementations, multiple sensors 4220 located at various levels can be connected to a single lighting fixture 1000. For example, a soil sensor can be connected via a long USB extension cable dangled from a USB port 1012A and a lighting sensor can be connected directly to a PoE port. By connecting a plurality of lighting fixtures 1000 together, the sensors 4220 can also be connected thus forming a distributed array of sensors. In this way, sensors may be digitally indexed (or “addressed”) by the coordinates of the lighting fixtures.

The distributed sensor grid includes one or more node arrays arranged in a 1D, 2D, or 3D arrangement. Each node array contains multiple nodes 4200 respectively positioned at corresponding coordinate locations (e.g., x, y, and z coordinates) in the controlled agricultural environment. At a given node 4200, the distributed sensor grid further includes one or more sensors 4220 deployed at the node to monitor growth conditions in proximity to the node. In one example, the distributed sensor grid is arranged as a two-dimensional node array, in which an arrangement of lighting fixtures 1000 constitutes a horizontal plane of nodes defined by an x-axis and a y-axis of the node array. In another example, the distributed sensor grid is arranged as a three-dimensional node array, in which an arrangement of lighting fixtures 1000 constitutes one horizontal plane of nodes defined by an x-axis and a y-axis of the node array, and the distributed grid has several horizontal planes of nodes constituting multiple vertical levels (along a z-axis of the node array) defined by the height of the sensor node 4200 with respect to the lighting fixtures.

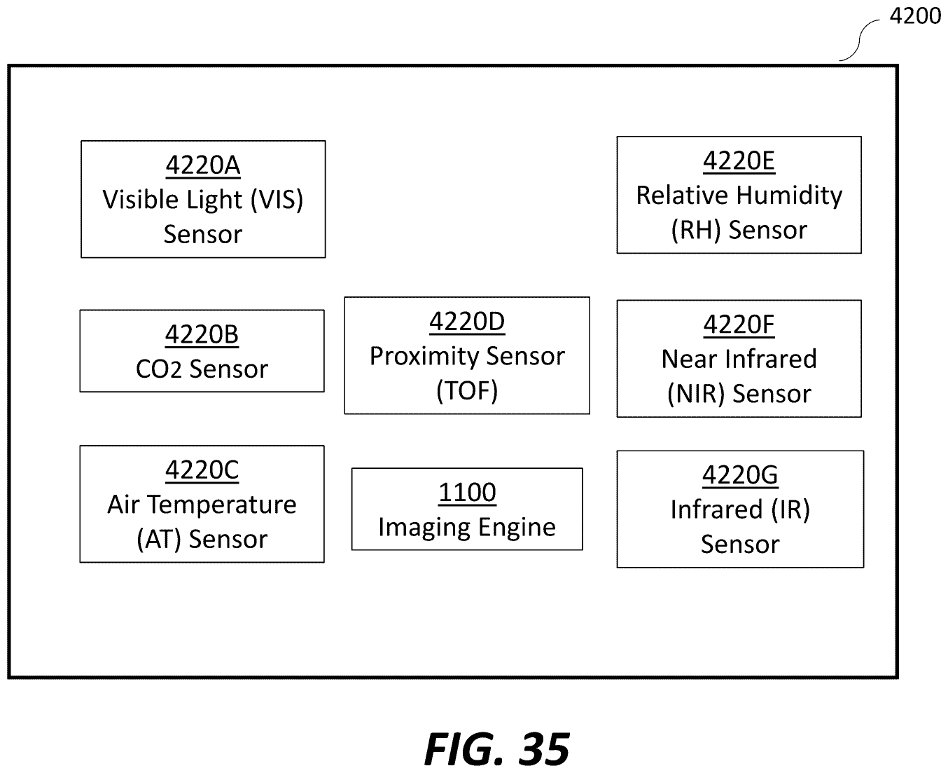

FIG. 35 shows an exemplary block diagram of sensors and cameras at a node in a multi-resolution multisensory imaging system. The multisensory imaging system may include an imaging engine 1100 to acquire multispectral imagery, a visible light sensor 4220A to measure visible radiation, a CO₂ sensor 4220B to measure CO₂, an air temperature sensor 4220C to measure air temperature, a proximity sensor 4220D to determine a distance, a relative humidity sensor 4220E to measure relative humidity, a near infrared (NIR) sensor 4220F to measure NIR radiation, and an infrared sensor 4220G to measure infrared radiation. In other implementations, the multi-resolution multisensory imaging system may include more or fewer imager/sensors and different types of imagers/sensors at each node.

Each node can include one or more sensors. For example, a node may include, but is not limited to, a visible light sensor, a UV light sensor, an air temperature sensor, a relative humidity sensor, an airflow sensor, a CO2 sensor, an IR temperature sensor, a volatile organic compound sensor, a pH sensor, a particulate matter (PM2.5) sensor, and cameras (e.g., multispectral imaging engine 1100), as described above. In some implementations, multiple sensors 4220 can be packaged into an integrated sensor assembly to simplify wiring and ease of installation. Each node 4200 in a node array 4100 can also include different combinations of sensors 4220 pertinent to the region of the environment the node 4200 is located in. For example, different types of sensors 4220 may be deployed according to the object of interest in an environment. Likewise, an imaging engine 1100 may be disposed at one, several, or every sensor node 4200. For example, an imaging engine 1100 may be integrated with every lighting fixture 1000.

In some implementations, the imaging engine 1100 may utilize the LED source 400 in the lighting fixture 1000 as an illumination source for acquiring imagery/spectra instead of the LED elements 1142. The LED source 400 in the lighting fixtures includes one or more LED elements that emit radiation at known wavelengths. In some implementations, each LED element in the LED source 400 may be independently activated similar to the LED elements 1142. Thus, in some implementations, the imaging engine 1100 may not include narrowband irradiators 1140 source, instead relying upon other illumination sources in the environment (e.g., the LED source 400).

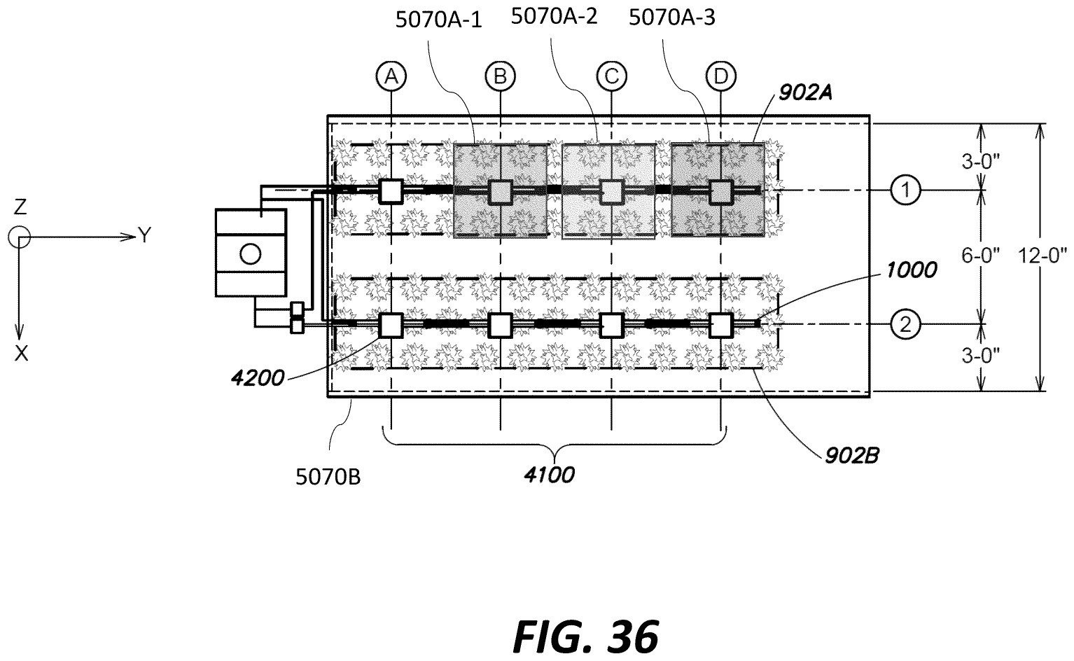

FIG. 36 shows a top-down view of a 3D node array 4100 of a multi-resolution multisensory imaging system indexed according to x, y, and z coordinates. FIG. 36 illustrates an agricultural environment that includes two elongated shelves 902A and 902B disposed proximate to each other at a spacing in a growing area. Three rows of plants are positioned next to each other on each shelf along the long length of the shelf. Above each shelf, positioned generally over the middle row of the three rows of plants, are four lighting fixtures 1000. In this example, a y-axis for the node array is chosen parallel to the long length of the shelves 902A and 902B (and, accordingly, the x-axis is parallel to the short width of the shelves). The center lines of the shelves themselves along the length (e.g., halfway across the width of a shelf) define indexed positions 1 and 2 along the x-axis, and the four lighting fixtures 1000 disposed above each of the shelves 902A and 902B respectively define indexed positions A, B, C, and D along the y-axis (e.g., the centers of the lighting fixtures may correspond with the indexed positions A through D). The z-axis for the node array is taken along the vertical height of the environment and is divided into several indexed positions or “levels”. Thus, in the example of FIG. 36, there are a plurality of nodes 4200 in the node array 4100 of the distributed sensor grid.

FIG. 36 illustrates the multi-resolution nature of this exemplary multisensory imaging system. In this example, each sensor node 4200 includes the sensor array described in FIG. 35, including an imaging engine 1100 and several point sensors 4220. Each imaging engine 1100 in the system defines a micro field of view 5070A-1-5070A-3. Multispectral images are acquired with imaging engines 1100 at each node, defining “micro” fields of view 5070A-1, 5070A-2, 5070A-3, etc. These micro fields of view may overlap for easier image stitching and higher resolution. Alternatively, the micro fields of view may not overlap and thereby sample a larger portion of the CEH system. In addition, the point sensors 4220 at each sensor node 4200 act as a pixel in a macro field of view 5070B. Multisensory compound-eye images are generated using sensor measurements at each sensor node 4200. Multispectral images may be overlayed with multisensory compound-eye images to provide multi-resolution multisensory images.

As described above with respect to the exemplary multispectral imaging system 5050A, and the exemplary multisensory imaging system 5050B, a vector of values at each pixel may be generated by the multi-resolution multisensory imaging system. The vector of values may include sensory data from point sensors 4220 and multispectral imagery from the imaging engine 1100. The vectors of values may be featurized and matched to conditions of interest using the reference condition library 5120 and a machine learning algorithm.

The multi-resolution multisensory imaging system may be coupled to one or more control systems in the agricultural environment such that conditions determined by the multi-resolution multisensory imaging system may be used to adjust the operating parameters of one or more control systems. The control systems can include, but are not limited to, lighting, heating, air flow, hydronics, and humidity conditioning systems. For many agricultural environments, the control systems may be configured to affect growing conditions from a single or few locations in the environment. For example, HVAC systems affecting air flow may be dispersed intermittently along the wall or ceiling in an environment, thus affecting multiple nodes 4200 when operating parameters are changed. In another example, a lighting fixture 1000 can affect growing conditions at nodes 4200 located directly below and near the lighting fixture 1000. Thus, data acquired by one or more sensors/imagers can be used to adjust the control systems such that growing conditions across multiple nodes 4200 are improved or maintained.

FIGS. 37A-37F show various views of a modular integrated sensor assembly 1100E according to one exemplary implementation, in which the integrated sensor assembly 1100E has the general form factor of the various example imaging engines 1100A-1100D discussed above. As should be readily appreciated from the discussion herein, the integrated sensor assembly 1100E may be deployed as part of a multisensory imaging system, a multi-resolution multisensory imaging system, or more fundamentally as a data collection device to sense multiple environmental conditions and provide sensor signals representing the sensed environmental conditions.

In one salient aspect that differs from the various imaging engines discussed previously herein, the integrated sensor assembly 1100E only includes three sensors, i.e., an infrared thermal sensor 1005C, a time-of-flight proximity sensor 1005D, and a light sensor 1005E. Thus, in this implementation, the integrated sensor assembly 1100E does not include any irradiation sources to facilitate image acquisition (e.g., by detecting radiation reflected or emitted by an object in the controlled horticultural environment), nor does the integrated sensor assembly 1100E include any supplemental illumination source (e.g., to provide UV or far red illumination). In some example implementations, the integrated sensor assembly 1100E further does not include any camera.

More specifically, with reference again to the imaging engine 1100C previously described in connection with FIGS. 5-7, the imaging engine 1100C includes narrowband irradiators 1140A and 1140B (e.g., LEDs 1142) to facilitate multi spectral imaging of reflected/emitted light, as well as supplemental illuminators 1150A and 1150B (e.g., LEDs 1152). In contrast, the integrated sensor assembly 1100E shown in FIGS. 37A-F does not include either the naarrowband irradiators 1140 to facilitate multispectral imaging or the supplemental illuminators 1150. However, it should be appreciated that the integrated sensor assembly 1100E may still include one or more irradiators, not to facilitate multispectral imaging or provide supplemental illumination, but rather to facilitate operation of one or more of the sensors 1005C, 1005D, or 1005E themselves. For example, the time-of-flight proximity sensor 1005D may include a narrowband irradiator (e.g., a laser), as a constituent component of an integrated package, to facilitate distance-related measurements.

As noted above, another salient difference between the example of the integrated sensor assembly 1100E shown in FIGS. 37A-F and the previously described imaging engines is that the assembly 1100E does not include any camera. With reference again to the imaging engine 1100C shown in FIGS. 5-7, the imaging engine 1100C includes a first camera 1005A to acquire UV-SWIR imagery (e.g., sensitive to radiation from the UV through the short wave infrared spectrum) and a second camera 1005B to acquire long wave infrared (LWIR) thermal imagery. In contrast, the integrated sensor assembly 1100E does not include either of these cameras (or other cameras). It should be appreciated, however, that an alternative implementation of the integrated sensor assembly 1100E may include one or more cameras, but not narrowband irradiators to facilitate multispectral imaging or supplemental illuminators, as discussed above.

The implementation of an integrated sensor assembly 1100E having a similar or same form factor as the imaging engines described previously, but with a purposefully reduced number of components and particularly-selected sensor types, provides additional benefits that compliment or are valuable alternatives to those provided by the previously-described imaging engines.

For example, one benefit is that the integrated sensor assembly 1100E does not include any LED arrays, which may not be needed for a variety of horticultural sensing applications for which the three sensors of the assembly 1100E nonetheless provide valuable information. Excluding LEDs from the integrated sensor assembly appreciably reduces or, in some instances, mitigates light interference when acquiring sensory data via the sensors 1005C, 1005D, and 1005E. The reduction of light interference may increase the signal-to-noise ratio in data collected by the sensors 1005C, 1005D, and 1005E. One form of light interference that may be avoided is light emitted by an LED disposed on the circuit board 3710, which, if present, may be reflected back toward the circuit board 3710 by the housing 1120A.

Another benefit of the integrated sensor assembly 1100E is that it may be relatively lower in cost to manufacture compared to the imaging engines 1100A-1100D, due at least in part to the reduction of components (e.g., such as the exclusion of irradiation/illumination sources and cameras). This may allow users to more readily replace and/or upgrade the integrated sensor assembly 1100E without incurring significant costs (e.g., in view of improvements in various sensor technology and/or respective sensor updates). In another example, the user may swap respective integrated sensor assemblies that include one or more sensors configured to provide a different field of view (e.g., for different horticultural applications).

Additionally, the exclusion of irradiators and/or illuminators from the integrated sensor assembly 1100E may also provide greater ease of maintenance and/or replacement by grouping together components that have similar operating lifetimes. Generally, irradiators and/or illuminators may in some instances have longer operating lifetimes compared to the sensors due, in part, to differences in reliability and functionality. By excluding irradiators and/or illuminators from the integrated sensor assembly 1100E, the user can replace the sensors at the end of their operating lifetime without unnecessarily replacing the irradiators (which, if advantageous in a given application, may be included as part of a lighting fixture serving as a “host” for the integrated sensor assembly). In applications for which irradiators/supplemental illuminators may be useful, the irradiators and/or illuminators may be supported by one or more lighting fixtures; a ceiling, wall, or floor of a grow room in the CEH system; and/or on a separate support in the CEH system. In this way, an integrated sensor assembly 1100E may be deployed in, moved around, or removed from the CEH system without moving the irradiators and/or supplemental illuminators.

Regarding the respective sensors of the integrated sensor assembly 1100E, each of the infrared thermal sensor 1005C, the time-of-flight proximity sensor 1005D, and the color light sensor 1005E of the integrated sensor assembly 1100E may generally be a custom-made sensor or a commercial-off-the-shelf sensor.

For example, the IR thermal sensor 1005C may be an MLX90614 IR infrared thermometer. The MLX90614 IR infrared thermometer includes a 16×12-pixel array of infrared sensors to detect far-infrared radiation. Thus, the MLX90614 IR infrared thermometer can provide non-contact temperature measurements within the CEH environment (e.g., for leaf temperature measurements). Further details of the MLX90614 IR infrared thermometer can be found in the MLX90614 16×12 IR array Datasheet (Revision 3—Dec. 9, 2019, 3901090641), which is incorporated by reference herein in its entirety.

In another example, the time-of-flight proximity sensor 1005D may be a VL53L1 time-of-flight proximity sensor. The VL53L1 time-of-flight proximity sensor 1005D provides non-contact measurements of object distance. The VL53L1 time-of-flight proximity sensor includes a 940 nm emitter, a single photon avalanche diode (SPAD) receiving array with integrated lens with a field-of-view of 27°, and a low-power microcontroller. Further details of the VL53L1 time-of-flight proximity sensor can be found in the TCS3400 Color Light-to-Digital Converter specification sheet (ams Datasheet [v1-06], Oct. 10, 2017), which is incorporated by reference herein in its entirety.

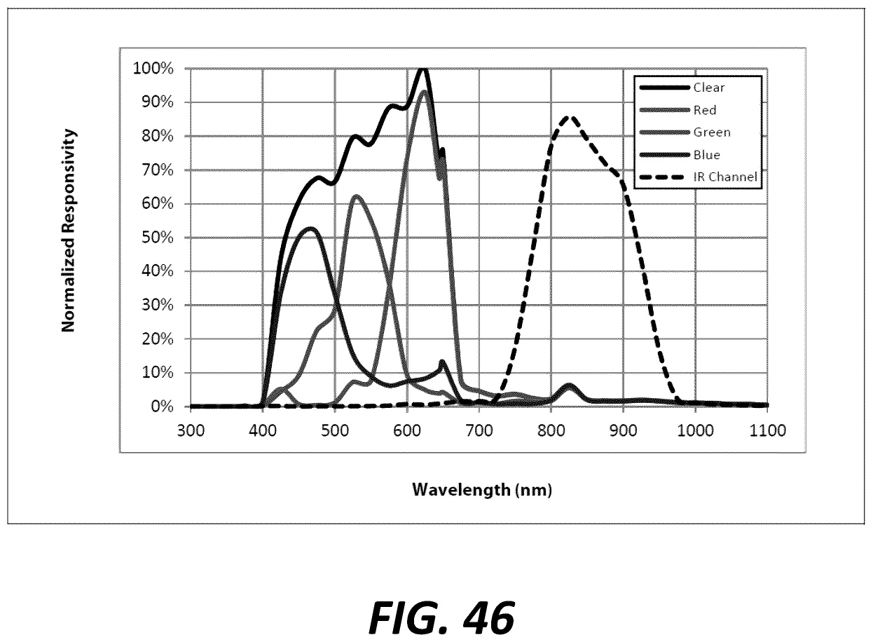

In yet another example, the color light sensor 1005E may be a TCS3400 color light sensor. The TCS3400 sensor measures radiation in the visible and near-infrared wavelength range to obtain data on the luminosity (e.g., lux) and color temperature of the light detected. Specifically, the TCS3400 color sensor includes a segmented photodiode array tailored to measure radiation in multiple spectral bands. As shown in FIG. 46, the photodiode array of the TCS3400 color sensor may include respective photodiodes configured to detect light predominantly at blue wavelengths (Blue line), predominantly green wavelengths (Green line), predominantly red wavelengths (Red line), predominantly visible light (Clear line), and near infrared radiation (IR channel). In some example applications of the integrated sensor assembly 1100E, the multiple spectral bands detected by the TCS3400 color sensor serving as the color light sensor 1005E can be used to characterize the optical characteristics of the plants (e.g., the albedo) and/or detect various chemical compounds to evaluate the overall health of the plants. Further details of the TCS3400 color sensor can be found in the VL53L1X datasheet and production data (DocID031281 Rev 4, October 2021), which is incorporated by reference herein in its entirety.

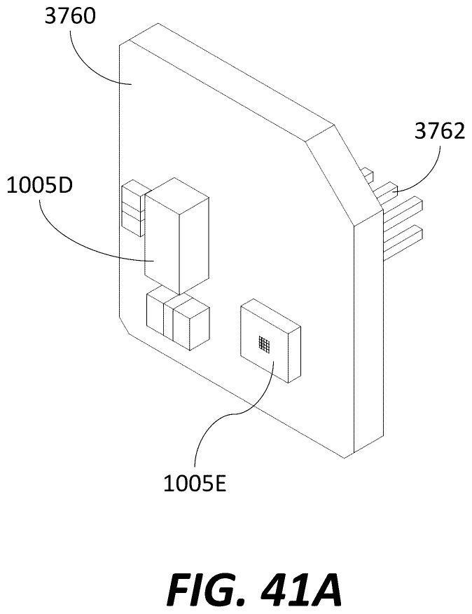

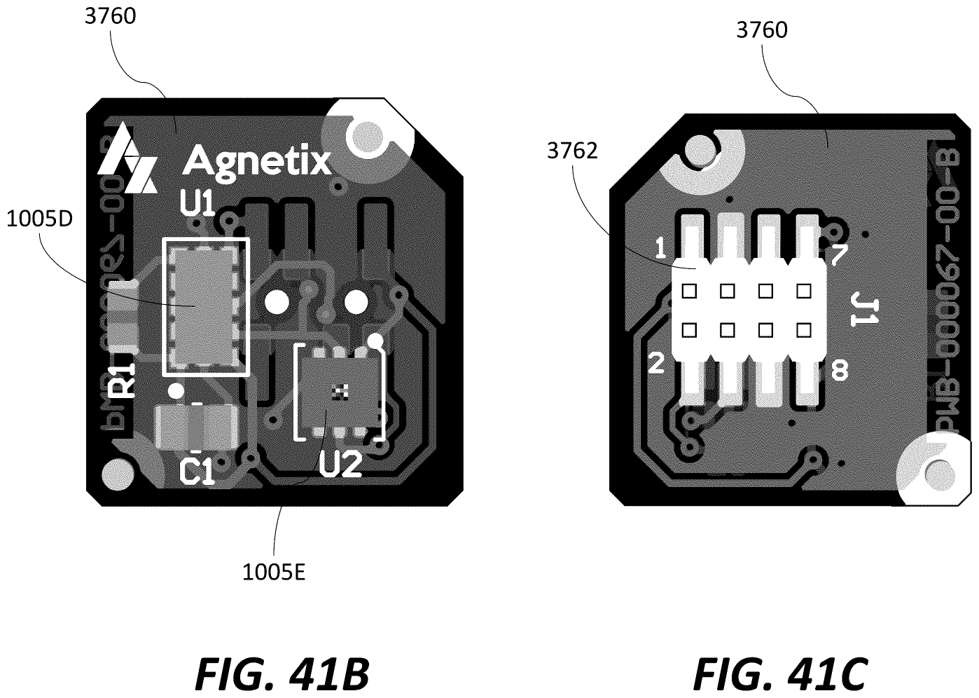

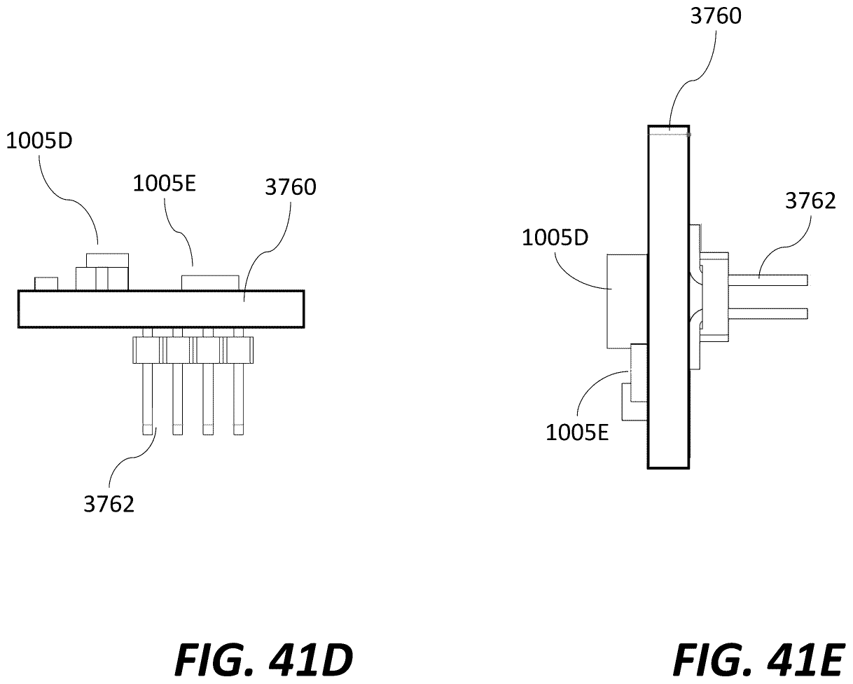

The sensors 1005C, 1005D, and 1005E of the integrated sensor assembly 1100E may generally be disposed on one or more circuit boards. For example, FIGS. 37A and 37B show that, in one example implementation, the sensors 1005D and 1005E may be disposed on a smaller “sub” circuit board 3760 that is in turn connected to the circuit board 3710. The sensor 1005C may be directly connected to the circuit board 3710. The circuit board 3710 provides mechanical support for the sensors 1005C, 1005D, and 1005E, in part, by providing one or more mating electrical connectors and/or bonding pads. For example, the circuit board 3760 includes an electrical connector 3762 that connects to a corresponding electrical connector on the circuit board 3710 (see, for example, FIGS. 41A-41E). The circuit board 3710 may generally support other electronic circuitry to facilitate operation of the assembly 1100E. For example, the circuit board 3710 may support one or more microcontrollers (e.g., a peripheral interface controller or PIC) that is electrically and electronically coupled to each of the sensors 1005C, 1005D, and 1005E to provide electrical power and facilitate data communication.

The integrated sensor assembly 1100E also includes a housing 1120A to enclose and protect the various components of the assembly 1100E. In some aspects, the housing may facilitate installation of the assembly 1100E in a CEH system (e.g., onto the frame of a lighting fixture; a ceiling, wall, or floor of a grow room in the CEH system; and/or on a separate support in the CEH system). Specifically, the housing 1120A may define a cavity to contain the circuit boards 3710 and 3760, the sensors 1005C, 1005D, and 1005E, and any other electronic circuitry. The housing 1120A may generally include one or more of the same features as the housing 1120 described above.

The housing 1120A may have a substantially rectangular geometry as shown in FIGS. 37A-37F. As shown, the housing 1120A may have a length (l), a width (w), and a thickness (t). In some implementations, the housing 1120A may be shaped to have a relatively low profile where the thickness is significantly smaller than the length or the width. For example, the ratio of the length to the thickness (or the width to the thickness) may generally range between 5 to 10. In some implementations, the length may range from about 3.5 inches to about 4.5 inches. More preferably, the length may be about 4 inches. In some implementations, the width may range from about 2.5 inches to about 3.0 inches. More preferably, the width may be about 2.7 inches. In some implementations, the thickness may range from about 0.25 inches to about 0.75 inches. More preferably, the thickness may be about 0.5 inches. The term “about,” when used to describe the dimensions of the housing 1120A, are intended to cover manufacturing tolerances. For example, “about 1 inch” may correspond to the following dimensional ranges: 0.99 to 1.01 inches (+/−1% tolerance), 0.992 to 1.008 inches (+/−0.8% tolerance), 0.994 to 1.006 inches (+/−0.6% tolerance), 0.996 to 1.004 inches (+/−0.4% tolerance), 0.998 to 1.002 inches (+/−0.2% tolerance), including all values and sub-ranges in between.

The housing 1120A may generally have a front side 1102 that is oriented towards the area of interest (e.g., one or more plants) in which the sensors 1005C, 1005D, and 1005E acquire data. The housing 1120A also includes a back side 1104 that may abut against a surface supporting the assembly 1100E (e.g., the frame of a lighting fixture). The housing 1120A and the circuit board 3710 may also include one or more through-mounting holes 1122 to receive corresponding fasteners for ease of installation and assembly. For example, the assembly 1100E includes through-mounting holes 1122 disposed at respective corners of the housing 1120A and the circuit board 3710.

In some implementations, with reference again for the moment to FIG. 34A, the assembly 1100E may be mounted to the lighting fixture 1000 and disposed between two LED boards 400A and 400B, in a manner similar to the imaging engine 1100 shown in FIG. 34A. In some implementations, the assembly 1100E and, in particular, the housing 1120A may be shaped and/or dimensioned so as not to protrude significantly below respective lenses and/or covers covering the LED boards 400A and 400B of the lighting fixture 1000. The frame of the lighting fixture may further include an opening through which the assembly 1100E can be connected to the control circuitry of the lighting fixture.

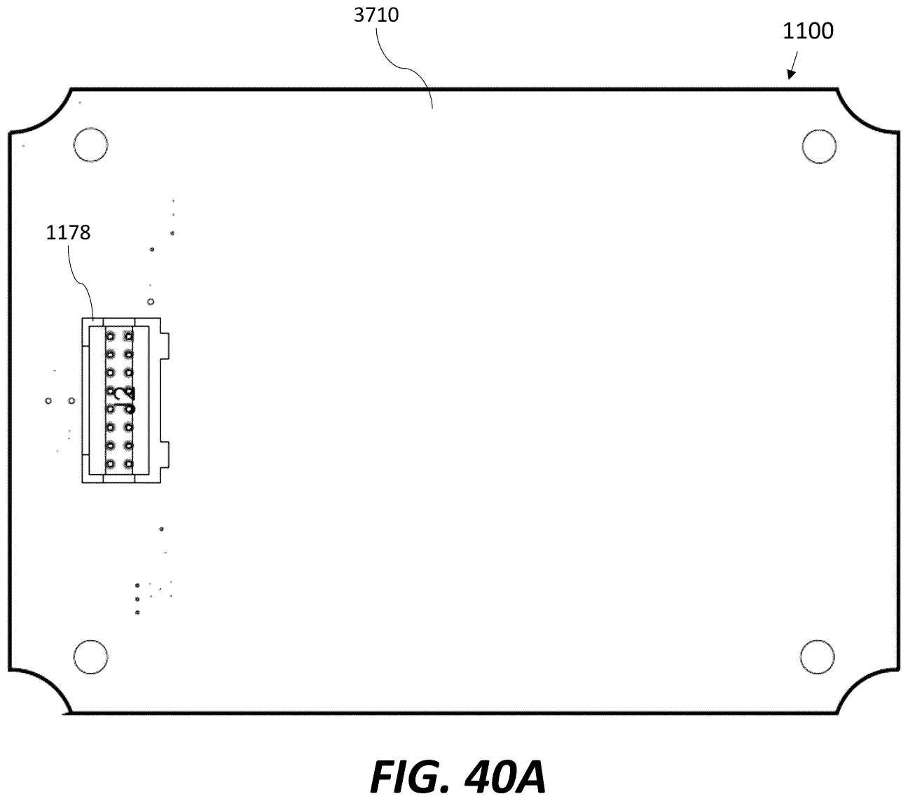

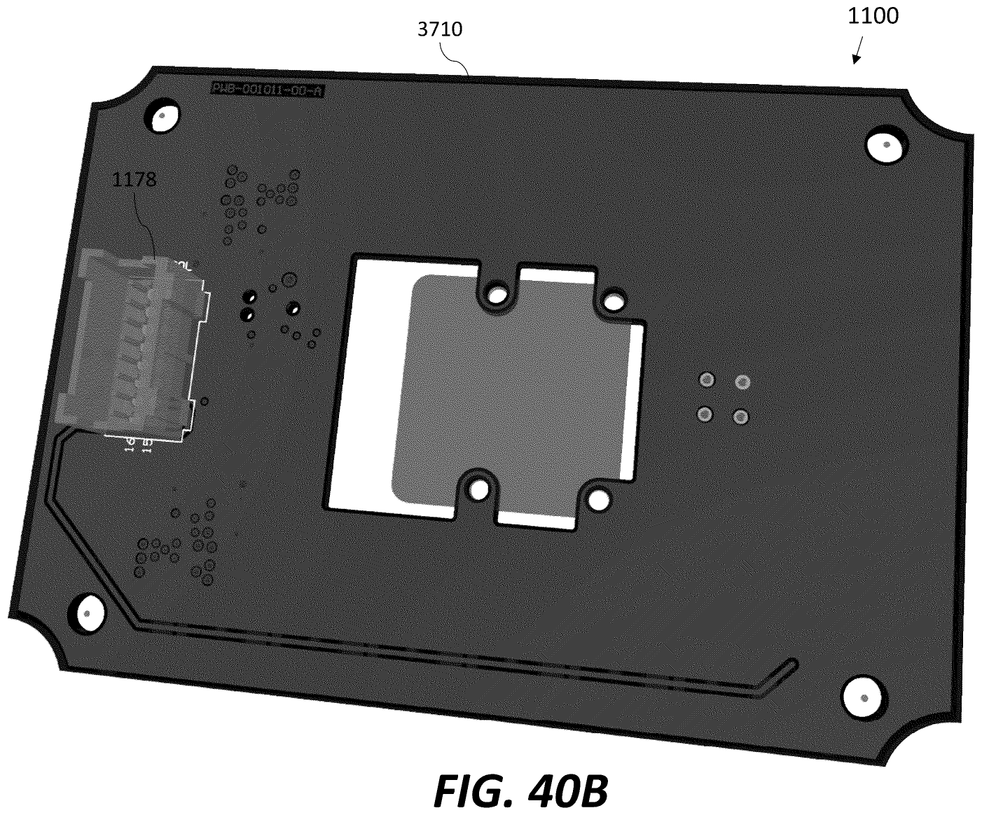

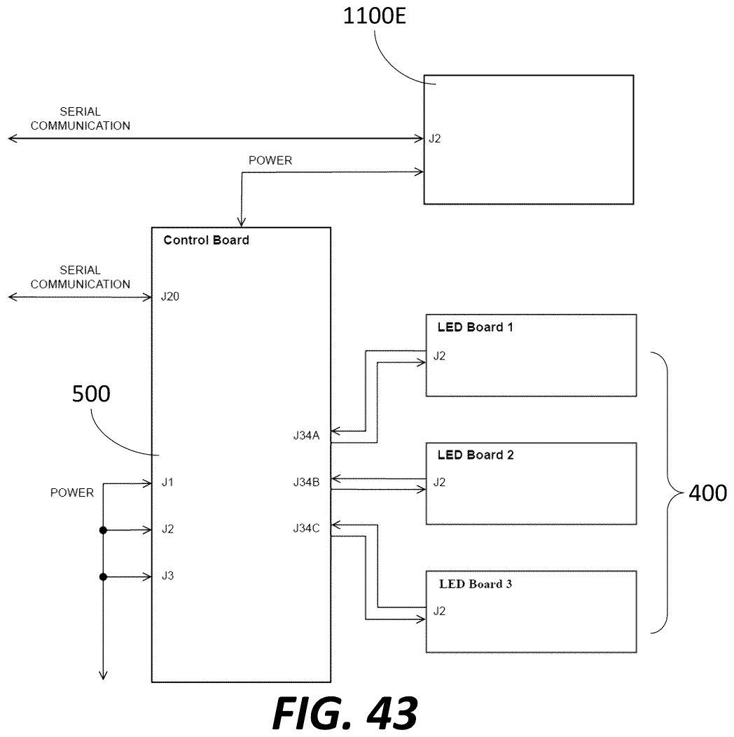

In some example implementations, the integrated sensor assembly 1100E further includes a connector 1178 on the back side of the housing to electrically and communicatively couple the assembly 1100E to a device in the CEH system (e.g., the lighting fixture, a processor, and/or the HMI). For example, the connector 1178 may be coupled to one or more of the control circuitry boards of a lighting fixture (see, for example, the control circuitry 500 of FIG. 43) such that the integrated sensor assembly 1100E is able to receive electrical power directly from the lighting fixture and/or signals generated by the lighting fixture. An exemplary version of the connector 1178 is described in greater detail below and in FIGS. 40A and 40B.

In some implementations, the housing 1120A may form a substantially sealed enclosure in order to prevent moisture and/or water from contacting the various electronics and sensors on the circuit board 3710. The housing 1120A may include a groove along its periphery to support a gasket 1124 to form a seal. In some implementations, the housing 1120A may form a substantially watertight seal.

The housing 1120A may be formed from various plastic and/or ceramic materials. In some implementations, the housing 1120A may be formed from a material that is substantially transparent to light at wavelengths corresponding to the wavelengths of light sensed by the sensors 1005C, 1005D, and 1005E. In some implementations, the housing 1120A may be formed from a material that is not sufficiently transparent across the wavelength range of interest. In any of these implementations, the housing 1120A may include areas 1126C and 1126D disposed near the sensors 1005C, and 1005D and 1005E, respectively. The areas 1126C and 1126D may be formed of the same material as the housing 1120A, but the material may be substantially thinner than the rest of the housing 1120A. The thinner material in the areas 1126C and 1126D substantially reduces (attenuates) parasitic absorption by the housing 1120A at the wavelength range(s) of interest. In some implementations, the areas 1126C and 1126D may be openings in the housing 1120A that are shaped to support various optical elements tailored for the appropriate wavelength ranges of each sensor, as described above (e.g., germanium windows).

In some implementations, the same or similar form factors of the integrated sensor assembly 1100E and the imaging engines 1100A-1100C described earlier provide for interchangeable and flexible integration of these respective apparatuses with one or more lighting fixtures in a CEH lighting system. As discussed in further detail below, in some system implementations, one or more lighting fixtures of a system may be equipped with the integrated sensor assembly 1100E, while one or more other lighting fixtures of the system may be equipped with an imaging engine that includes one or more of narrowband irradiators to facilitate multi spectral imaging, supplemental illuminators (e.g., to provide UV or far red illumination), and one or more cameras. For example, in one implementation, all but one lighting fixture in a row of lighting fixtures may be equipped with an integrated sensor assembly 1100E, while one lighting fixture in the row is equipped with an imaging engine having additional components beyond the integrated sensor assembly 1100E. One of ordinary skill in the art would readily appreciate that a wide variety of system implementations and geometries are possible, in which one or more imaging engines are deployed in some locations while one or more integrated sensor assemblies 1100E are deployed in other locations.

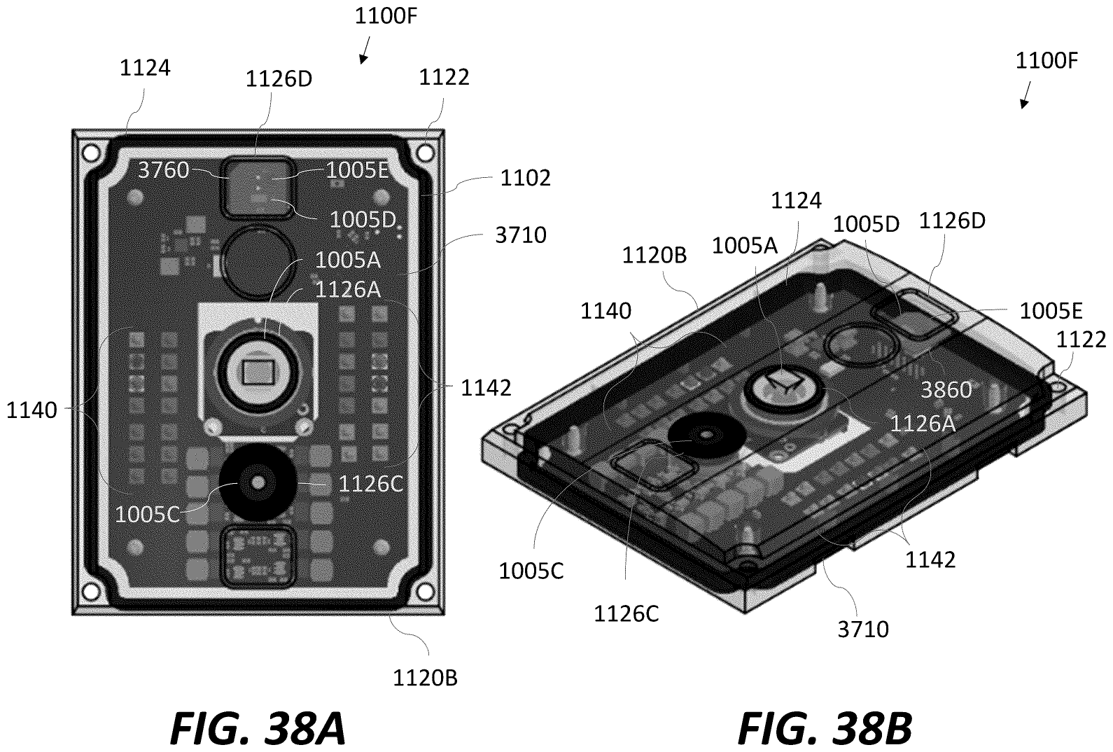

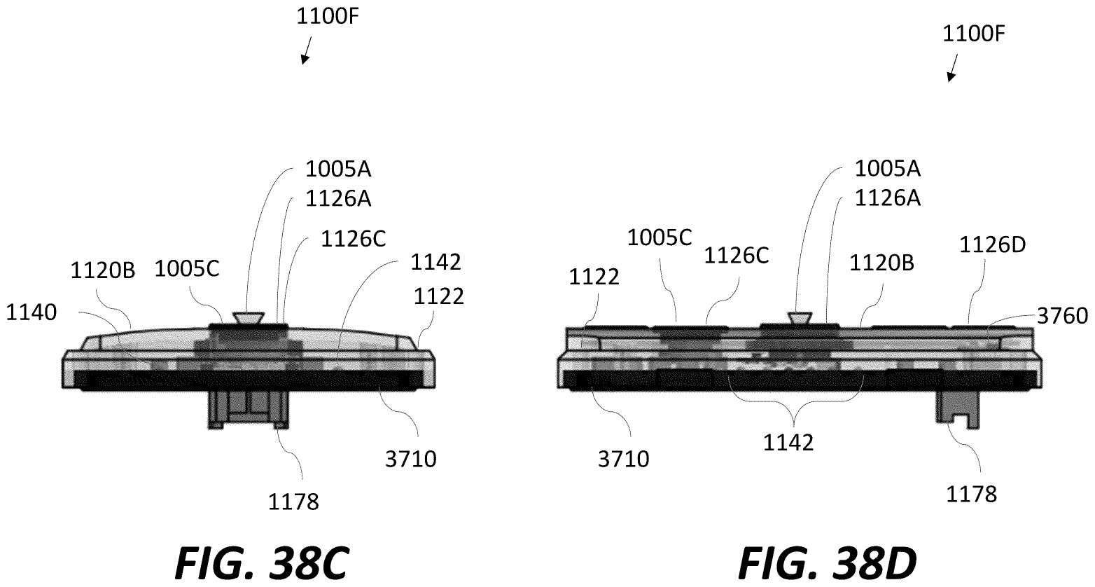

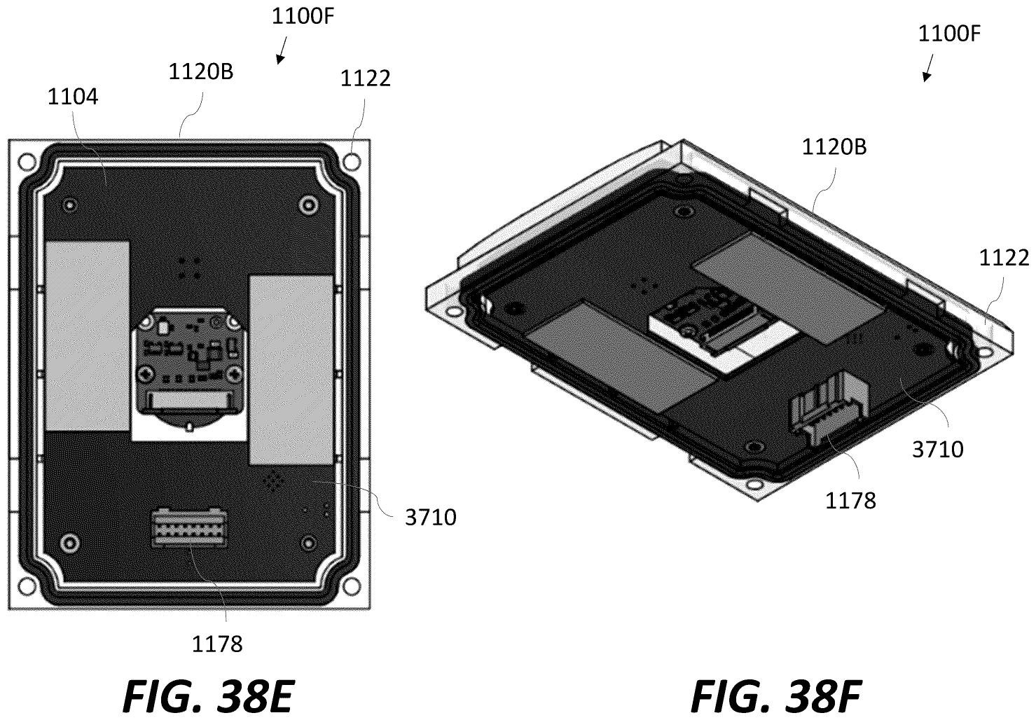

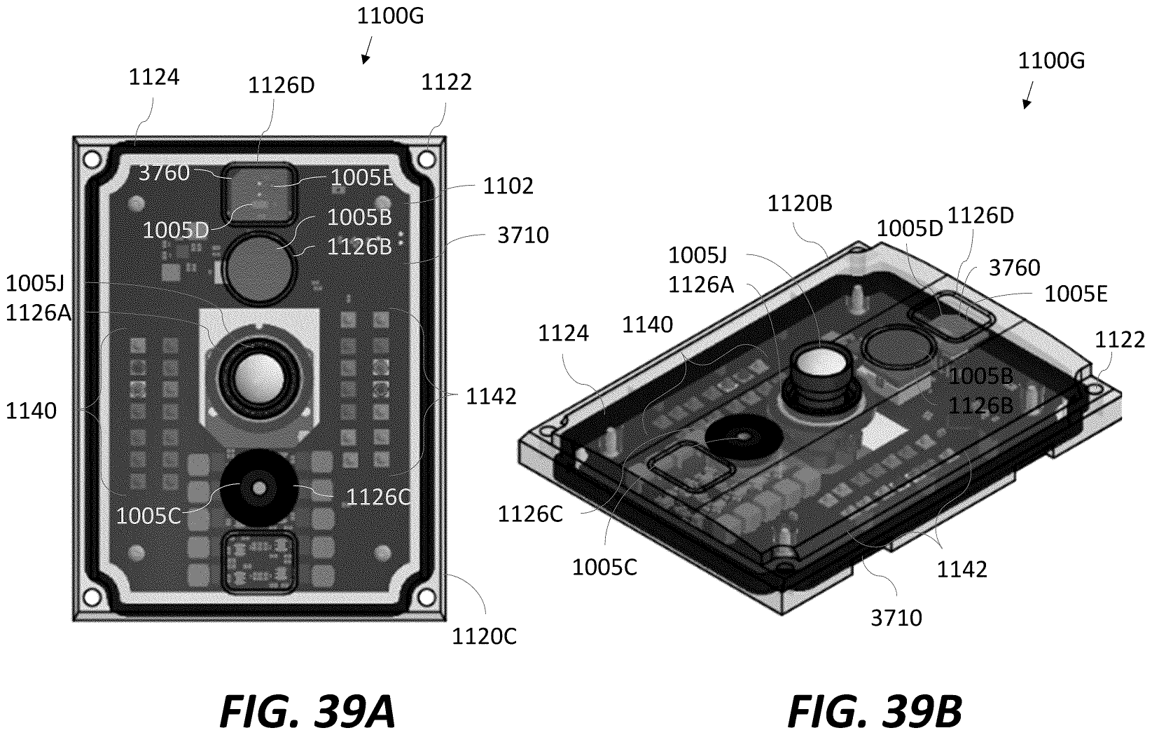

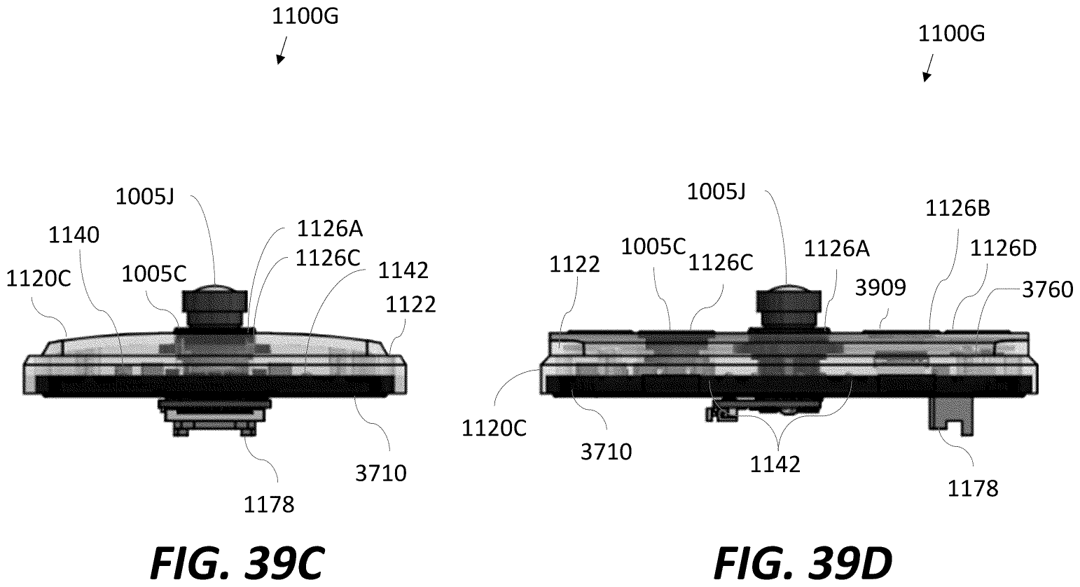

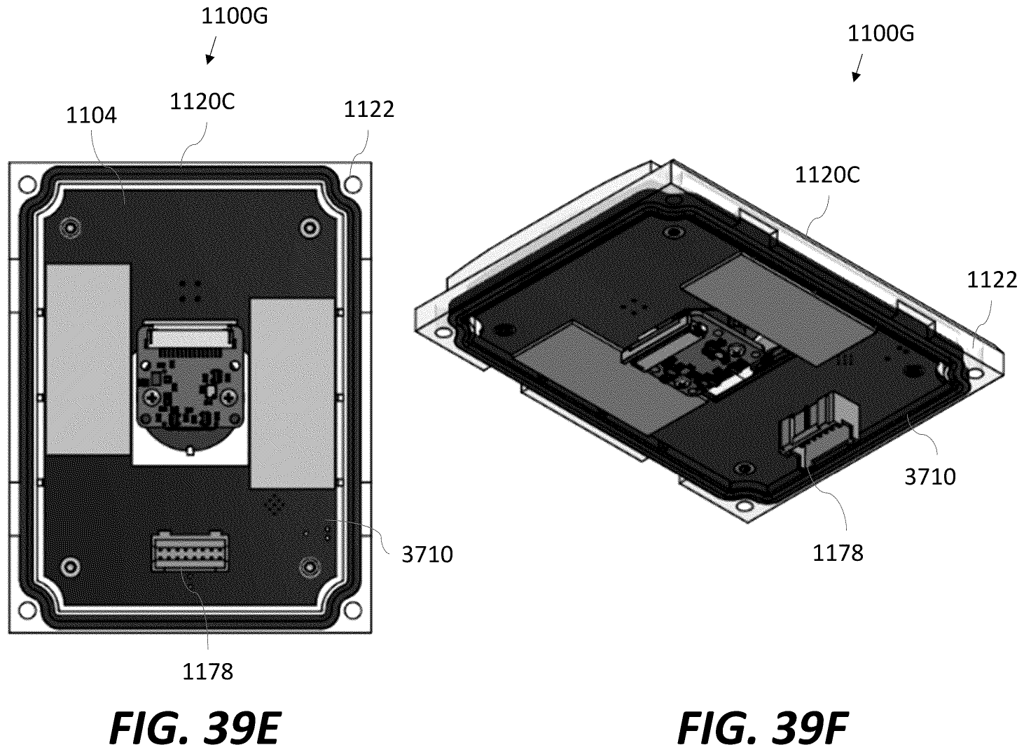

In the spirit of flexible deployment of sensing and/or imaging systems having different functionalities, FIGS. 38A-F illustrate another example of an imaging engine 1100F having a particular set of components and functionality, and FIGS. 39E-F illustrate yet another example of an imaging engine 1100G having yet additional components and particular functionality.

For example, FIGS. 38A-38F show various views of an exemplary imaging engine 1100F (e.g., which may be deployed as part of the multisensory, multispectral, or multi-resolution multisensory imaging system as described above). The imaging engine 1100F includes an IR infrared thermometer 1005C, a time-of-flight proximity sensor 1005D, a color light sensor 1005E, and camera 1005A. As an example, the IR infrared thermometer 1005C may be an MLX90614 IR infrared thermometer, the time-of-flight proximity sensor 1005D may be a VL53L1 time-of-flight proximity sensor, the color light sensor 1005E may be a TCS3400 color sensor, and the camera 1005A may be a v2 Pi NoIR camera. The imaging engine in FIG. 38 includes narrowband irradiators 1140 and 1142 which collectively include illumination at eight wavelength bands centered at 940 nm, 850 nm, 730 nm; 660 nm, 620 nm, 535 nm, 450 nm, and 365 nm. The sensors 1005C, 1005D, and 1005E and the camera 1005A are disposed on and supported by the circuit board 3710. The imaging engine 1100F includes a connector 1178 to electrically and communicatively couple the imaging engine 1100F to a device in the CEH system (e.g., the lighting fixture, a processor, and/or the HMI). The imaging engine 1100F also includes a housing 1120B to protect the sensors 1005C, 1005D, and 1005E; the camera 1005A; and the irradiators 1140 and 1142.

The housing 1120F may be used, in part, to enclose and protect the various components of the imaging engine 1100F and to facilitate installation of the imaging engine 1100F in the CEH system (e.g., onto the frame of a lighting fixture; a ceiling, wall, or floor of a grow room in the CEH system; and/or on a separate support in the CEH system). In some implementations, the housing 1120B may form a substantially sealed enclosure in order to prevent moisture and/or water from contacting the various electronics and sensors on the circuit board 3710. The housing 1120B may include a groove along its periphery to support a gasket 1124 to form a seal. In some implementations, the housing 1120B may form a substantially watertight seal. The housing 1120B may include through-mounting holes 1122 for ease of installation.

The housing 1120B may be formed from various plastic and/or ceramic materials. In some implementations, the housing 1120B may be formed from a material that is substantially transparent to light at wavelengths corresponding to the wavelengths of light sensed by the sensors 1005C, 1005D, and 1005E and/or the camera 1005A. In some implementations, the housing 1120B may be formed from a material that is not sufficiently transparent across the wavelength range of interest. In any of these implementations, the housing 1120B may include areas 1126A, 1126C, and 1126D disposed near the camera or sensor 1005A, 1005C, and 1005D, respectively. The areas 1126A, 1126C, and 1126D may be formed of the same material as the housing 1120B, but the material may be substantially thinner than the rest of the housing 1120A. The thinner material in the areas 1126C, 1126D, and 1126E substantially reduces (attenuates) parasitic absorption by the housing 1120B at the wavelength range(s) of interest. In some implementations, the areas 1126A, 1126C, and 1126D may be openings in the housing 1120B that are shaped to support various optical elements tailored for the appropriate wavelength ranges of each sensor, as described above.

FIGS. 39A-39F show various views of another example implementation of an imaging engine 1100G. The imaging engine 1100G includes an IR infrared thermometer 1005C, a time-of-flight proximity sensor 1005D, a color light sensor 1005E, a thermal imager 1005B, and camera 1005J. As an example, the IR infrared thermometer 1005C may be an MLX90614 IR infrared thermometer, the time-of-flight proximity sensor 1005D may be a VL53L1 time-of-flight proximity sensor, the color light sensor 1005E may be a TCS3400 color sensor, the thermal imager 1005B may be a FLIR Lepton 3.5 micro thermal imager, and the camera 1005J may be an IMX477 13-megapixel Pi NoIR camera with an M12 lens. The imaging engine 1100G includes narrowband irradiators 1140 and 1142 for eight wavelengths bands centered at 940 nm, 850 nm, 730 nm, 660 nm, 620 nm, 535 nm, 450 nm, and 365 nm. The sensors 1005C, 1005D, and 1005E and the cameras 1005B and 1005J are disposed on and supported by the circuit board 3710. The imaging engine 1100G includes a connector 1178 to electrically and communicatively couple the imaging engine 1100G to a device in the CEH system (e.g., the lighting fixture, a processor, and/or the HMI). The imaging engine 1100G also includes a housing 1120C to protect the sensors 1005C, 1005D, and 1005E; the cameras 1005B and 1005J; and the irradiators 1140 and 1142.

The housing 1120G may be used, in part, to enclose and protect the various components of the imaging engine 1100G and to facilitate installation of the imaging engine 1100G in the CEH system (e.g., onto the frame of a lighting fixture; a ceiling, wall, or floor of a grow room in the CEH system; and/or on a separate support in the CEH system). In some implementations, the housing 1120C may form a substantially sealed enclosure in order to prevent moisture and/or water from contacting the various electronics and sensors on the circuit board 3710. The housing 1120C may include a groove along its periphery to support a gasket 1124 to form a seal. In some implementations, the housing 1120C may form a substantially watertight seal. The housing 1120C may include through-mounting holes 1122 for ease of installation.

The housing 1120C may be formed from various plastic and/or ceramic materials. In some implementations, the housing 1120C may be formed from a material that is substantially transparent to light at wavelengths corresponding to the wavelengths of light sensed by the sensors 1005C, 1005D, and 1005E and/or the cameras 1005B and 1005J. In some implementations, the housing 1120C may be formed from a material that is not sufficiently transparent across the wavelength range of interest. In any of these implementations, the housing 1120B may include areas 1126A, 1126B, 1126C, and 1126D disposed near the camera or sensor 1005J, 1005B, 1005C, and 1005D, respectively. The areas 1126A, 1126B, 1126C, and 1126D may be formed of the same material as the housing 1120C, but the material may be substantially thinner than the rest of the housing 1120C. The thinner material in the areas 1126A, 1126B, 1126C, and 1126D substantially reduces (attenuates) parasitic absorption by the housing 1120C at the wavelength range(s) of interest. In some implementations, the areas 1126A, 1126B, 1126C, and 1126D may be openings in the housing 1120C that are shaped to support various optical elements tailored for the appropriate wavelength ranges of each sensor, as described above.

FIGS. 40A and 40B shows different views of a version of the connector 1178 that is a multi-pin electrical connector to electrically couple the integrated sensor assembly 1100E or the exemplary imaging engines 1100F or 1100G to a corresponding connector on the lighting fixture with complementary socket connectors to receive the respective pins of the multi-pin electrical connector. In some implementations, a cable may couple the multi-pin electrical connector of the integrated sensor assembly/imaging engine to the corresponding connector on the lighting fixture. By providing a common mechanical and electrical interface, the lighting fixture may be customized by enabling the grower to readily swap out integrated sensor assemblies/imaging engines as desired. The integrated sensor assembly and different imaging engines may also have the same form factor so that they may be easily swapped. For instance, a subset of the lighting fixtures in a grow room may include the imaging engine 1100A and another subset of the lighting fixtures may include the imaging engine 1100C, and another subset may include the integrated sensor assembly 1100E.

FIGS. 41A-41E show several views of the circuit board 3760. As shown, the circuit board 3760 may mechanically, electrically, and electronically support the time-of-flight sensor 1005D and the color light sensor 1005E. The circuit board 3760 further includes an electrical connector 3762 to connect the circuit board 3760 the circuit board 3710. In some implementations, the sensors 1005D and 1005E may be positioned sufficiently close such that respective sensory data may be acquired through the same area 1126D of the housing 1120A.

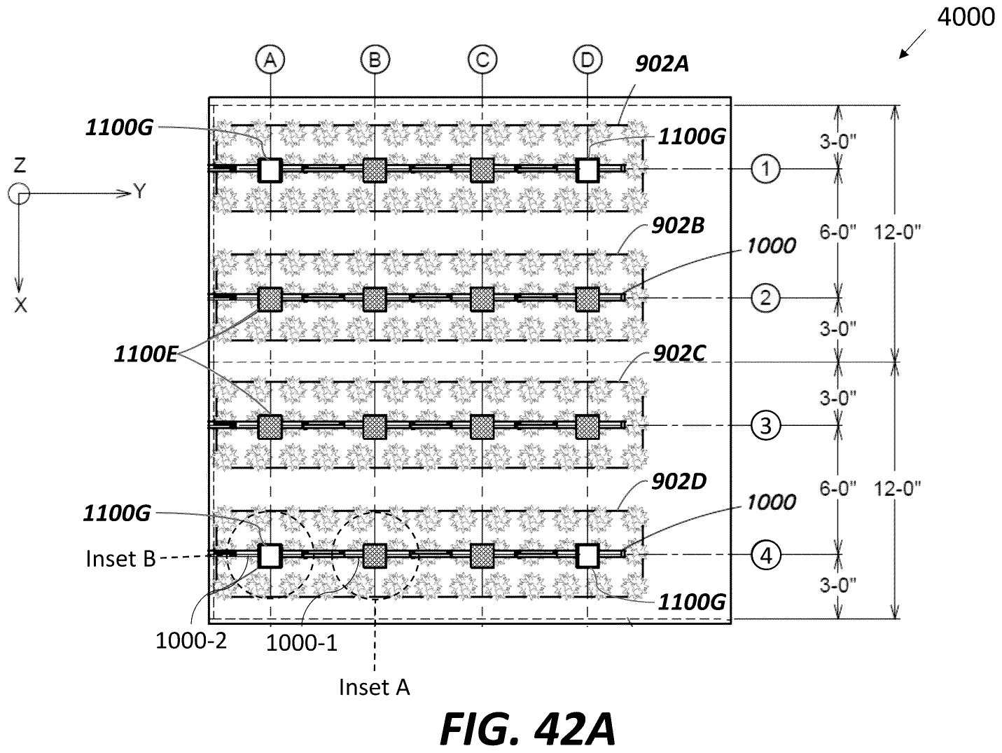

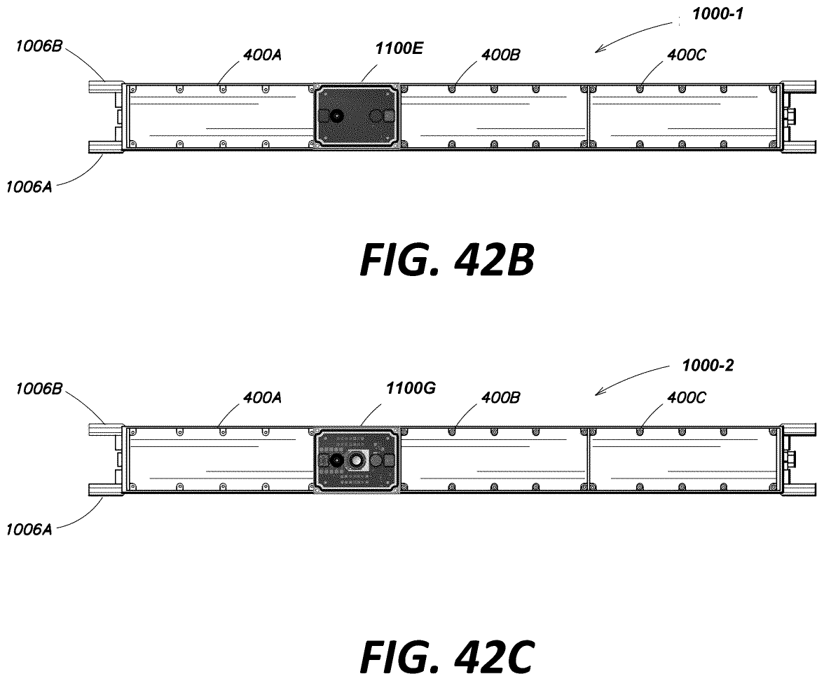

FIG. 42A shows a top-down view of an exemplary CEH system 4000 with various exemplary integrated sensor assemblies and/or imaging engines (collectively labeled as 1100 for convenience) deployed in the CEH system. The CEH system 4000 includes four elongated shelves 902A-902D disposed proximate to each other at a spacing in a growing area. Three rows of plants are positioned next to each other on each shelf along the long length of the shelf. Above each shelf, positioned generally over the middle row of the three rows of plants, are four lighting fixtures 1000.

In this example, the growing area defines a 3D node array of the system indexed according to x, y, and z coordinates. In this example, ay-axis for the node array is chosen parallel to the long length of the shelves 902A-902D (and, accordingly, the x-axis is parallel to the short width of the shelves). The center lines of the shelves themselves along the length (e.g., halfway across the width of a shelf) define indexed positions 1, 2, 3, and 4 along the x-axis, and the four lighting fixtures 1000 disposed above each of the shelves 902A-902D respectively define indexed positions A, B, C, and D along the y-axis (e.g., the centers of the lighting fixtures may correspond with the indexed positions A through D). The z-axis for the node array is taken along the vertical height of the environment and is divided into several indexed positions or “levels”. As an example, each integrated sensor assembly/imaging engine may be mechanically and electrically mounted to each lighting fixture as shown in FIG. 34A.

An integrated sensor assembly/imaging engine 1100 is disposed at each node of the node array. In this example, an imaging engine 1100G is deployed at the nodes in each of the four corners of the growing area to provide higher resolution data at these nodes. The integrated sensor array 1100E is deployed at every other node in the node array. In other words, an integrated sensor assembly or imaging engine is deployed at each lighting fixture, and different types of these apparatuses are deployed at different nodes This configuration is beneficial when there is higher risk of environmental variability in the corners of the growing area. The higher resolution imaging engines 1100G provide higher resolution data regarding the environmental conditions in the four corners so that the conditions can be carefully monitored This configuration is also beneficial because it provides cost savings. The lower cost integrated sensor assemblies 1100E can be deployed widely and the higher cost imaging engine 1100G can be deployed at nodes of special interest. In other examples, imaging engine 1100G may be deployed at the center of the growing area. In other examples, imaging engines 1100F may be deployed in place of the imaging engines 1100G. While the imaging engine 1100F provides fewer types of measurements, it may be preferred in some cases for its lower cost compared to the imaging engine 1100G, but additional functionality compared to the integrated sensor assembly 1100E.

FIGS. 42B and 42C show adjacent lighting fixtures 1000-1 and 1000-2, in which an integrated sensor assembly 1100E is disposed on lighting fixture 1000-1 and imaging engine 1100G is disposed on lighting fixture 1000-2. The respective apparatuses 1100E an 1100G are connected to the corresponding lighting fixtures via connectors 1178 disposed on the back of the apparatuses 1100E and 1100G. As can be clearly seen in FIGS. 42B and 42C, these apparatuses are each disposed between LED light sources 400A and 400B on the lighting fixtures 1000-1 and 1000-2.

The integrated sensor assembly 1100E or the imaging engines 1100F-1100G may be coupled to one or more control systems in the agricultural environment such that conditions determined by the apparatuses 1100E, 1100F and/or 1100G may be used to adjust the operating parameters of one or more control systems. Examples of such control systems can include, but are not limited to, those that control lighting (e.g., PAR, supplemental illumination in the UV and/or far red regime, narrowband irradiation to facilitate multispectral imaging), heating, air flow, hydronics, CO2 concentration, and humidity. For many agricultural environments, the control systems may be configured to affect growing conditions from a single or few locations in the environment. For example, HVAC systems affecting air flow may be dispersed intermittently along the wall or ceiling in an environment, thus affecting multiple nodes when operating parameters are changed. In another example, a lighting fixture 1000 can affect growing conditions at nodes located directly below and near the lighting fixture 1000. Thus, data acquired by one or more apparatuses 1100E-1100G can be used to adjust the control systems such that growing conditions across the growing area are improved or maintained.

With reference again to FIGS. 42B and 42C, in one example implementation the integrated sensor assembly 1100E or the imaging engines 1100F-1100G may provide one or more output signals that is/are used to control a spectral power distribution of the PAR generated by one or more lighting fixtures 1000-1 and 1000-2.

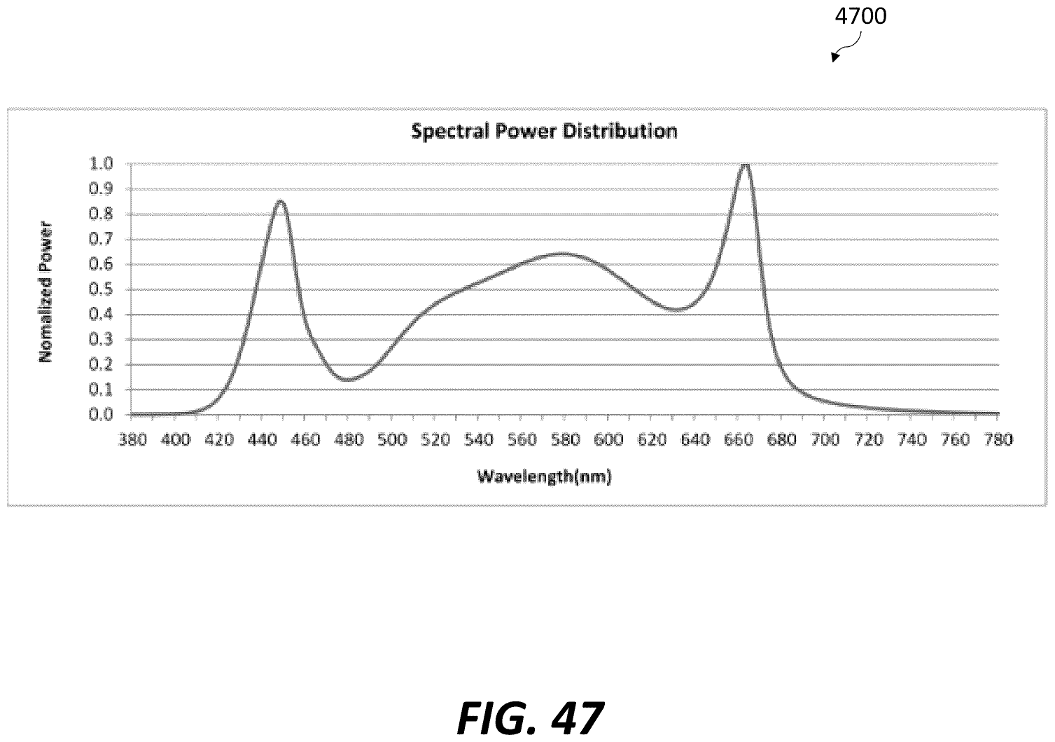

FIG. 47 shows an example of a nominal spectral power distribution 4700 of the PAR generated by one or both of lighting fixtures 1000-1 and 1000-2 shown in FIGS. 42B and 42C. In one implementation, a given lighting fixture may include two or three individually controllable LED boards 400A, 400B, 400C to generate the photosynthetically active radiation (PAR). For example, a first LED board 400A may include a first plurality of LEDs to generate first radiation having a predominantly red spectrum between 600 nanometers and 699 nanometers, and a second LED board 400B may include a second plurality of LEDs to generate second radiation having a predominantly blue spectrum between 400 nanometers and 499 nanometers. A third LED board 400C may include a third plurality of LEDs to generate third radiation including a green spectrum between 500 nanometers and 599 nanometers. FIG. 43 illustrates that a control board 500 coupled to the integrated sensor assembly 1100E and the respective LED boards 400A, 400B and 400C may individually control one or more of the LED boards to change the spectral power distribution of the photosynthetically active radiation (PAR) of the lighting fixture, based at least in part on one or more sensor signals from the integrated sensor assembly 1100E (or an imaging engine).

More specifically, using the specific example of the integrated sensor assembly 1100E discussed above in connection with FIGS. 37A-F, FIG. 43 shows an exemplary system block diagram of the assembly 1100E connected to a lighting fixture. In some implementations, the lighting fixture may include an onboard control board 500 to receive electrical power from an external power source (e.g., AC power from the building mains) and data communication signals from one or more single board computers (not shown) that manage and control the operation of the various components of the lighting fixture (e.g., the LED modules 400). In some implementations, the single board computer may be onboard the lighting fixture, or may include the processor 5000 generally discussed above to process various outputs of an integrated sensor assembly 1100E or imaging engine 1100A-D. Accordingly, it may be appreciated that in some implementations, the single board computer may form part of a control system that is physically separate from the lighting fixture. The lighting fixture may also include one or more LED modules 400 that each have a separate LED board (e.g., LED boards 1-3) to support one or more LEDs. As shown, the control board may provide both electrical power (e.g., DC power) and data communication signals to each of the LED modules during operation. FIG. 43 also shows assembly 1100E, when installed onto the lighting fixture, may receive electrical power from the control board. In some implementations, the assembly 1100E may receive data communication signals directly from the single board computer(s) controlling the LED modules. It should be appreciated that the system block diagram of FIG. 43 may also be used to connect any other imaging engine disclosed herein.

As discussed above generally in connection with a processor 5000, it may be readily appreciated that, in connection with the integrated sensor assembly 1100E, a processor may receive sensor signals respectively output by the infrared thermal sensor, the time-of-flight proximity sensor and the color light sensor, wherein the sensor signals respectively represent at least three different measurable conditions. The processor may process the received sensor signals, based at least in part on a reference condition library 5120 comprising a plurality of labeled feature sets 5140 corresponding to reference conditions, to estimate or determine at least one environmental condition. As noted above, at least one labeled feature set of the plurality of labeled feature sets includes a plurality of reference values, each reference value of the plurality of reference values corresponding to one measurable condition of the at least three different measurable conditions. The processor is further configured to adjust one or more operating parameters of at least one control system (e.g., one or more light sources, a heating system, an air flow control system, a hydronics system, a CO2 concentration control system, a humidity conditioning system) based at least in part on the estimated or determined environmental condition(s). As noted above, in one example the control system may be a light source (lighting fixture) and the processor is configured to adjust a spectral power distribution of the light source based at least in part on the estimated or determined environmental condition(s).

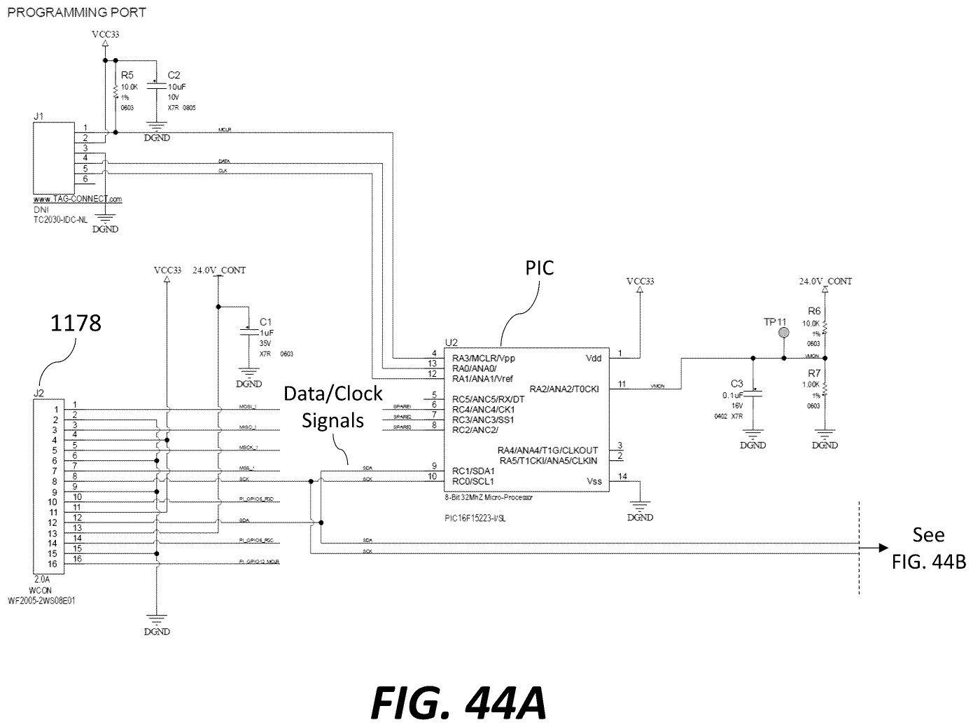

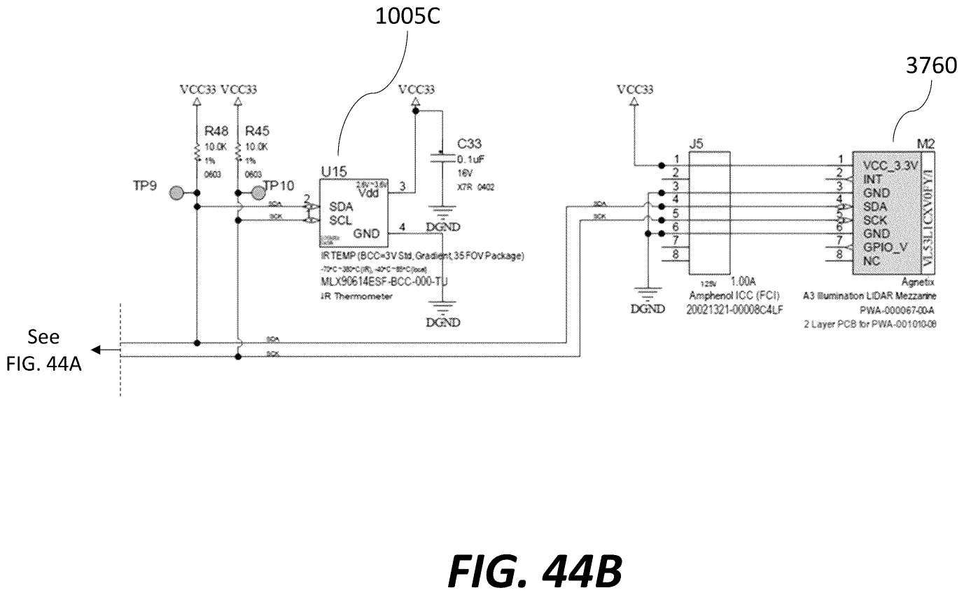

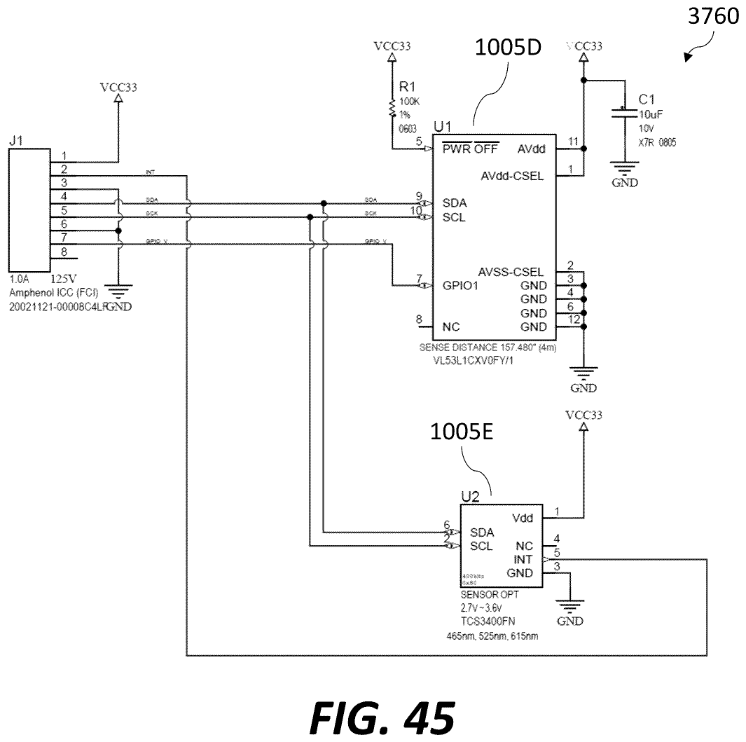

FIGS. 44A and 44B show an exemplary circuit diagram for the integrated sensor assembly 1100E with circuitry related specifically to the operation of the sensors 1005C, 1005D, and 1005E. As shown, the assembly 1100E may transmit and/or receive multiple data communication signals from a separate control system (e.g., control board 500) via the connector 1178 including, but not limited to, I2C signals (e.g., a data signal, a clock signal). The assembly 1100E may also include a processor (e.g., a PIC) to receive the I2C signals and, in turn, relay the control signals originating from the single board computer to the sensors 1005C, 1005D, and 1005E. FIG. 45 further shows an exemplary circuit diagram for the circuit board 3760, which is connected to the circuit board 3710.

In some implementations, a multisensory imaging system may provide an array of integrated sensor assemblies 1100E integrated into the CEH system. The sensors may be arranged spatially within the CEH system to collect measurements from one or more portions of a grow area or essentially the entire grow area of the CEH system.

In one exemplary implementation, multiple integrated sensor assemblies 1100E are distributed in a CEH system as a distributed integrated sensor grid. The distributed integrated sensor grid includes one or more node arrays, where each node array divides at least a portion of the controlled horticultural environment into nodes in the environment, as described above.

An integrated sensor assembly 1100E may be disposed at each node so each node includes an infrared thermal sensor 1005C, a time-of-flight proximity sensor 1005D, and a light sensor 1005E. In other words, temperature, distance, visible light, and infrared light may be measured at each node. As noted above, in one example, the light sensor 1005E may be a TCS3400 color light sensor. The TCS3400 sensor measures radiation in the visible and near-infrared wavelength range to obtain data on the luminosity (e.g., lux) and color temperature of the light detected. Specifically, the TCS3400 color sensor detects light predominantly at blue wavelengths (Blue line), predominantly green wavelengths (Green line), predominantly red wavelengths (Red line), predominantly visible light (Clear line), and near infrared radiation (IR channel), as shown in FIG. 46.

The data collected from the grid array of integrated sensor assemblies 1100E may be used to create 2D mono-sensory compound-eye images similar to those shown in FIG. 28 but corresponding to the particular measurements acquired by the integrated sensor assemblies 1100E. The compound-eye images generated by the grid array of integrated sensor assemblies 1100E includes a plurality of pixels (nodes). Each pixel has a vector of values, each value corresponding to one of the three sensors (infrared thermal sensor 1005C, a time-of-flight proximity sensor 1005D, or a light sensor 1005E) in the integrated sensor assembly 1100E. The vector of values may provide the basis for a feature set used by an image processor to non-destructively identify conditions of interest. A machine learning or deep learning algorithm may be used to facilitate identification of conditions of interest. Each pixel is digitally indexed (or “addressed”) by pixel coordinates representing a spatial position in the collective field of view. Values measured at each pixel may be featurized to create a feature set suitable for input into the algorithm. In other words, the measured values may be represented by a set of structured mathematical representations called features.

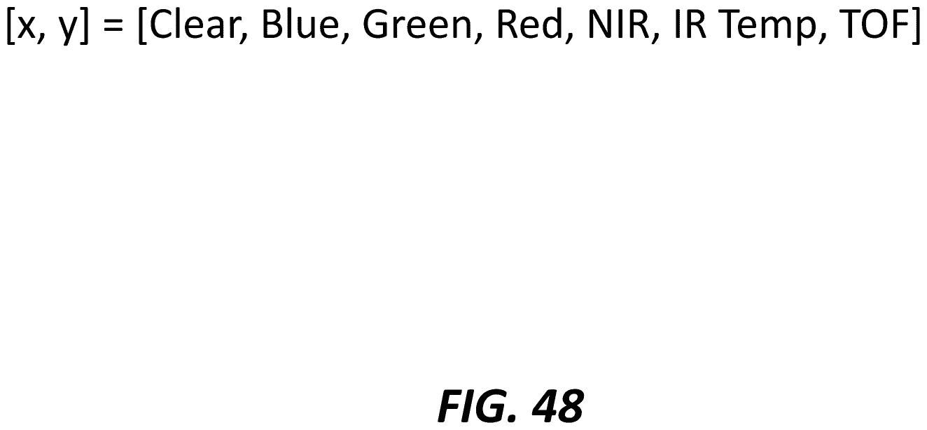

FIG. 48 shows an example feature set of eight values received as sensor signals measured by the three sensors in each integrated sensor assembly 1100E indexed in two dimensions in the multisensory imaging system. The feature set includes values measured by the infrared thermal sensor 1005C, the time-of-flight proximity sensor 1005D, and the light sensor 1005E. In this feature set, the light sensor 1005E is the TCS3400 sensor described above. The feature set includes values for measures of predominantly blue wavelengths of light (Blue), predominantly green wavelengths of light (Green), predominantly red wavelengths of light (Red), predominantly visible light (Clear), near infrared radiation (NIR), temperature as measured by the infrared thermal sensor (IR Temp), and distance. For a given use-case, any subset of the available features may be picked to define a feature set for a given measurement exercise. In other words, the feature set may have 2, 3, 4, or more elements. Not all measurements may be needed to identify the condition of interest. The feature set in FIG. 48 may be indexed in three dimensions, similar to that shown in FIG. 33 above.

The feature set in FIG. 48 may be used to create a reference condition library. Alternatively, the feature set in FIG. 48 may be compared to a reference condition library to observe conditions, similar to the reference library described above and in FIG. 30. The reference condition library may include any number of prospectively useful reference conditions that may be of interest. A feature set representing a known condition of interest can be labeled (“annotated”) and thereby facilitate model training for use in machine learning matching (e.g., with a confidence value) to identify conditions of interest observed in real time measurements of an object (e.g., plant(s)).

### CONCLUSION

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions, and arrangement of respective elements of the exemplary implementations without departing from the scope of the present disclosure. The use of a numerical range does not preclude equivalents that fall outside the range that fulfill the same function, in the same way, to produce the same result.

The above-described embodiments can be implemented in multiple ways. For example, embodiments may be implemented using hardware, software, or a combination thereof. When implemented in software, the software code can be executed on a suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in a suitable form, including a local area network or a wide area network, such as an enterprise network, an intelligent network (IN) or the Internet. Such networks may be based on a suitable technology, may operate according to a suitable protocol, and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Some implementations may specifically employ one or more of a particular operating system or platform and a particular programming language and/or scripting tool to facilitate execution.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An integrated sensor assembly (1100E) comprising:
a housing (1120A) having a rectangular shape, a front side (1102) having a length (l) and width (w) and including a plurality of openings (1126), and a thickness (t) significantly less than the length or the width of the front side;
an infrared thermal sensor (1005C) disposed in the housing and aligned with a first opening of the plurality of openings;
a time-of-flight proximity sensor (1005D) disposed in the housing and aligned with a second opening of the plurality of openings; and
a color light sensor (1005E), disposed in the housing and aligned with the second opening of the plurality of openings, to respectively sense at least red light, green light, and blue light,
wherein the integrated sensor assembly does not include a narrowband irradiator (1142) to facilitate multispectral imaging of reflected or emitted radiation from at least one object in response to irradiation by the narrowband irradiator.

2. The integrated sensor assembly of claim 1, wherein the assembly does not include a camera (1005A, 1005B).

3. The integrated sensor assembly of claim 1, wherein:
the housing further includes a back side (1104) opposite the front side; and
the back side includes at least one connector (1178) configured to facilitate mating electrical engagement of the at least one connector with a complimentary connector (1170) of a lighting fixture that generates photosynthetically active radiation (PAR) for a controlled horticultural environment.

4. The integrated sensor assembly of claim 3, in combination with the lighting fixture, wherein:
at least one of the integrated sensor assembly or the lighting fixture includes at least one processor (500) to receive at least one sensor signal output by at least one of the infrared thermal sensor, the time-of-flight proximity sensor or the color light sensor; and
the at least one processor changes a spectral power distribution of the photosynthetically active radiation (PAR) of the lighting fixture based at least in part on the at least one sensor signal.

5. The combination of claim 4, wherein:
the lighting fixture includes at least two individually controllable LED boards (400A, 400B) to generate the photosynthetically active radiation (PAR);
a first LED board of the at least two individually controllable LED boards generates first radiation having a predominantly red spectrum between 600 nanometers and 699 nanometers; and
a second LED board of the at least two individually controllable LED boards generates second radiation including a green spectrum between 500 nanometers and 599 nanometers.

6. The combination of claim 5, wherein the at least one processor controls at least one of the first LED board or the second LED board to change the spectral power distribution of the photosynthetically active radiation (PAR) of the lighting fixture based at least in part on the at least one sensor signal.

7. The combination of claim 5, wherein:
a third LED board of the at least two individually controllable LED boards generates third radiation having a predominantly blue spectrum between 400 nanometers and 499; and
the at least one processor controls at least one of the first LED board, the second LED board, or the third LED board to change the spectral power distribution of the photosynthetically active radiation (PAR) of the lighting fixture based at least in part on the at least one sensor signal.

8. The integrated sensor assembly of claim 3, in combination with the lighting fixture, wherein:
the lighting fixture includes at least two LED boards (400A, 400B) to generate the photosynthetically active radiation (PAR); and
the integrated sensor assembly is disposed between respective LED boards of the at least two LED boards.

9. The integrated sensor assembly of claim 1, further comprising at least one processor (5000) to:
receive sensor signals respectively output by the infrared thermal sensor, the time-of-flight proximity sensor and the color light sensor, the sensor signals respectively representing at least three different measurable conditions in a controlled horticultural environment; and
process the received sensor signals, based at least in part on a reference condition library (5120) comprising a plurality of labeled feature sets (5140) corresponding to reference conditions, to estimate or determine at least one environmental condition in the controlled horticultural environment,
wherein at least one labeled feature set of the plurality of labeled feature sets includes a plurality of reference values, each reference value of the plurality of reference values corresponding to one measurable condition of the at least three different measurable conditions.

10. The integrated sensor assembly of claim 9, wherein:
the controlled horticultural environment is associated with at least one control system to regulate at least a first environmental condition in the controlled horticultural environment; and
the at least one processor is further configured to adjust at least one operating parameter of the at least one control system based at least in part on the estimated or determined at least one environmental condition.

11. The integrated sensor assembly of claim 10, in combination with the at least one control system, wherein the at least one control system includes at least one of:
at least one light source;
a heating system;
an air flow control system;
a hydronics system; or
a humidity conditioning system.

12. The integrated sensor assembly of claim 10, in combination with the at least one control system, wherein the at least one control system includes a CO₂ concentration control system.

13. The combination of claim 11, wherein:
the at least one control system includes the at least one light source; and
the at least one light source includes at least one of:
a lighting fixture to generate photosynthetically active radiation (PAR);
a supplemental illuminator to generate at least one of UV radiation or far red radiation; or
at least one narrowband irradiator to facilitate multispectral imaging.

14. The combination of claim 11, wherein:
the at least one processor is configured to adjust a spectral power distribution of the at least one light source based at least in part on the estimated or determined at least one environmental condition.

15. The integrated sensor assembly of claim 1, wherein the housing forms a substantially water tight seal to prevent moisture from contacting the infrared thermal sensor, the time-of-flight proximity sensor, and the color light sensor.

16. The integrated sensor assembly of claim 15, wherein:
the housing includes a groove along a periphery of the housing; and
the assembly further includes a gasket (1124) supported by the groove.

17. The integrated sensor assembly of claim 1, wherein the housing further includes a plurality of mounting holes (1122), disposed in respective corners of the rectangular shape, to facilitate coupling of the assembly to a lighting fixture.

18. The integrated sensor assembly of claim 1, wherein the infrared thermal sensor includes a two-dimensional infrared sensor array having fewer than 200 pixels.

19. The integrated sensor assembly of claim 1, wherein the color light sensor further senses broadband visible light between 400 nanometers to 700 nanometers and near infrared light between 700 nanometers and 1000 nanometers.

20. An integrated sensor assembly (1100E) comprising:
a housing (1120A) having a rectangular shape and a front side (1102) including a plurality of openings (1126);
an infrared thermal sensor (1005C) disposed in the housing and aligned with a first opening of the plurality of openings, the infrared thermal sensor including a two-dimensional infrared sensor array having fewer than 200 pixels;
a time-of-flight proximity sensor (1005D) disposed in the housing and aligned with a second opening of the plurality of openings; and
a color light sensor (1005E), disposed in the housing and aligned with the second opening of the plurality of openings, to respectively sense at least red light, green light, and blue light, broadband visible light between 400 nanometers to 700 nanometers, and near infrared light between 700 nanometers and 1000 nanometers,
wherein the integrated sensor assembly does not include a narrowband irradiator (1142) to facilitate multispectral imaging of reflected or emitted radiation from at least one object in response to irradiation by the narrowband irradiator, and further does not include a camera (1005A, 1005B).

21. The integrated sensor assembly of claim 20, wherein:
the housing further includes a back side (1104) opposite the front side; and
the back side includes at least one connector (1178) configured to facilitate mating electrical engagement of the at least one connector with a complimentary connector (1170) of a lighting fixture that generates photosynthetically active radiation (PAR) for a controlled horticultural environment.

22. The integrated sensor assembly of claim 21, in combination with the lighting fixture having the complimentary connector, wherein:
the lighting fixture includes at least two LED boards (400A, 400B) to generate the photosynthetically active radiation (PAR); and
the integrated sensor assembly is disposed between respective LED boards of the at least two LED boards.

23. The integrated sensor assembly of claim 21, wherein the housing forms a substantially water tight seal to prevent moisture from contacting the infrared thermal sensor, the time-of-flight proximity sensor, and the color light sensor.

24. The integrated sensor assembly of claim 23, wherein:
the housing includes a groove along a periphery of the housing; and
the assembly further includes a gasket (1124) supported by the groove.

25. The integrated sensor assembly of claim 24, wherein the housing further includes a plurality of mounting holes (1122), disposed in respective corners of the rectangular shape, to facilitate coupling of the assembly to the lighting fixture.

26. An integrated sensor assembly (1100E) comprising:
an infrared thermal sensor (1005C);
a time-of-flight proximity sensor (1005D);
a color light sensor (1005E) to respectively sense at least red light, green light, and blue light; and
at least one processor (5000) to:
receive sensor signals respectively output by the infrared thermal sensor, the time-of-flight proximity sensor and the color light sensor, the sensor signals respectively representing at least three different measurable conditions in a controlled horticultural environment; and
process the received sensor signals, based at least in part on a reference condition library (5120) comprising a plurality of labeled feature sets (5140) corresponding to reference conditions, to estimate or determine at least one environmental condition in the controlled horticultural environment,
wherein:
at least one labeled feature set of the plurality of labeled feature sets includes a plurality of reference values, each reference value of the plurality of reference values corresponding to one measurable condition of the at least three different measurable conditions; and
the integrated sensor assembly does not include a narrowband irradiator (1142) to facilitate multispectral imaging of reflected or emitted radiation from at least one object in the controlled horticultural environment in response to irradiation by the narrowband irradiator.

27. The integrated sensor assembly of claim 26, wherein the assembly does not include a camera (1005A, 1005B).

28. The integrated sensor assembly of claim 26, wherein the infrared thermal sensor includes a two-dimensional infrared sensor array having fewer than 200 pixels.

29. The integrated sensor assembly of claim 26, wherein the color light sensor further senses broadband visible light between 400 nanometers to 700 nanometers and near infrared light between 700 nanometers and 1000 nanometers.

30. The integrated sensor assembly of claim 26, wherein:
the controlled horticultural environment is associated with at least one control system to regulate at least a first environmental condition in the controlled horticultural environment; and
the at least one processor is further configured to adjust at least one operating parameter of the at least one control system based at least in part on the estimated or determined at least one environmental condition.

31. The integrated sensor assembly of claim 30, in combination with the at least one control system, wherein the at least one control system includes at least one of:
the lighting fixture;
a heating system;
an air flow control system;
a hydronics system; or
a humidity conditioning system.

32. The integrated sensor assembly of claim 30, in combination with the at least one control system, wherein the at least one control system includes a CO₂ concentration control system.

33. The combination of claim 31, wherein:
the at least one control system includes the at least one light source; and
the at least one light source includes at least one of:
a lighting fixture to generate photosynthetically active radiation (PAR);
a supplemental illuminator to generate at least one of UV radiation or far red radiation; or
at least one narrowband irradiator to facilitate multispectral imaging.

34. The combination of claim 31, wherein:
the at least one processor is configured to adjust a spectral power distribution of the at least one light source based at least in part on the estimated or determined at least one environmental condition.

35. A system comprising:
an integrated sensor assembly (1100E) comprising:
an infrared thermal sensor (1005C);
a time-of-flight proximity sensor (1005D);
a color light sensor (1005E) to respectively sense at least red light, green light, and blue light;
a lighting fixture communicatively coupled to the integrated sensor assembly, the lighting fixture generating photosynthetically active radiation (PAR); and
at least one processor (500) to receive at least one sensor signal output by at least one of the infrared thermal sensor, the time-of-flight proximity sensor or the color light sensor and change a spectral power distribution of the photosynthetically active radiation (PAR) of the lighting fixture based at least in part on the at least one sensor signal.

36. The system of claim 35, wherein:
the lighting fixture includes at least two individually controllable LED boards (400A, 400B, 400C) to generate the photosynthetically active radiation (PAR);
a first LED board of the at least two individually controllable LED boards generates first radiation having a predominantly red spectrum between 600 nanometers and 699 nanometers; and
a second LED board of the at least two individually controllable LED boards generates second radiation including a green spectrum between 500 nanometers and 599 nanometers.

37. The system of claim 36, wherein the at least one processor controls at least one of the first LED board or the second LED board to change the spectral power distribution of the photosynthetically active radiation (PAR) of the lighting fixture based at least in part on the at least one sensor signal.

38. The system of claim 36, wherein:
a third LED board of the at least two individually controllable LED boards generates third radiation having a predominantly blue spectrum between 400 nanometers and 499 nanometers; and
the at least one processor controls at least one of the first LED board, the second LED board, or the third LED board to change the spectral power distribution of the photosynthetically active radiation (PAR) of the lighting fixture based at least in part on the at least one sensor signal.

39. A system of a first lighting fixture (1000A) and a second lighting fixture (1000B) to generate photosynthetically active radiation (PAR) for a controlled horticultural environment, wherein:
the first lighting fixture comprises an integrated sensor assembly (1100E) comprising:
an infrared thermal sensor (1005C);
a time-of-flight proximity sensor (1005D); and
a color light sensor (1005E) to respectively sense at least red light, green light, and blue light,
wherein the integrated sensor assembly does not include any narrowband irradiator (1142) to facilitate multispectral imaging of reflected or emitted radiation from at least one object in the controlled horticultural environment in response to irradiation by the narrowband irradiator; and
the second lighting fixture comprises an imaging engine (1100A, 1100B, 1100C, 1100D) comprising:
at least one irradiation source (1140) including a plurality of narrowband irradiators in a first range of wavelengths from the ultraviolet (UV) regime to the short wavelength infrared (SWIR) regime; and
at least one first camera (1005A) to acquire UV-SWIR imagery in a first field of view and in the first range of wavelengths.

40. The system of claim 39, wherein the integrated sensor assembly does not include any camera (1005A, 1005B).

41. The system of claim 40, further comprising at least one processor (5000) to:
receive sensor signals respectively output by at least the infrared thermal sensor, the time-of-flight proximity sensor and the color light sensor of the integrated sensor assembly, the sensor signals respectively representing at least three different measurable conditions in the controlled horticultural environment; and
process the received sensor signals, based at least in part on a reference condition library (5120) comprising a plurality of labeled feature sets (5140) corresponding to reference conditions, to estimate or determine at least one environmental condition in the controlled horticultural environment,
wherein at least one labeled feature set of the plurality of labeled feature sets includes a plurality of reference values, each reference value of the plurality of reference values corresponding to one measurable condition of the at least three different measurable conditions.

42. The system of claim 41, wherein the at least one processor:
further receives the UV-SWIR imagery acquired by the at least one first camera of the imaging engine; and
processes the received sensor signals and the UV-SWIR imagery, based at least in part on the reference condition library, to estimate or determine the at least one environmental condition in the controlled horticultural environment.

43. The system of claim 41, wherein:
the controlled horticultural environment is associated with at least one control system to regulate at least a first environmental condition in the controlled horticultural environment; and
the at least one processor is further configured to adjust at least one operating parameter of the at least one control system based at least in part on the estimated or determined at least one environmental condition.

44. The system of claim 43, in combination with the at least one control system, wherein the at least one control system includes at least one of:
the lighting fixture;
a heating system;
an air flow control system;
a hydronics system; or
a humidity conditioning system.

45. The system of claim 43, in combination with the at least one control system, wherein the at least one control system includes a CO₂ concentration control system.

46. The system of claim 39, wherein the imaging engine further comprises at least one second camera (1005B) to acquire LWIR imagery in the first field of view and in the long wavelength infrared (LWIR) regime.

47. The system of claim 46, wherein the integrated sensor assembly does not include any camera (1005A, 1005B).

48. The system of claim 46, wherein the imaging engine further comprises:
at least one controller (5020) to control the at least one irradiation source and the at least one first camera, wherein the at least one second camera continually acquires the LWIR imagery while the at least one controller periodically activates the at least one first camera in combination with the at least one irradiation source to acquire the UV-SWIR imagery.

49. The system of claim 48, wherein the plurality of narrowband irradiators of the at least one irradiation source comprises a plurality of essentially monochromatic LEDs, wherein respective LEDs of at least some of the plurality of essentially monochromatic LEDs have different emission wavelengths in a range of from 275 nanometers (nm) to 2060 nanometers (nm).

50. The system of claim 49, wherein the at least one controller is configured to, during operation of the imagine engine:
A) activate a first LED element of the plurality of essentially monochromatic LEDs to emit first radiation at a first wavelength;
B) during A), control the at least one first camera to acquire first UV-SWIR imagery;
C) deactivate the first LED element;
D) activate a second LED element of the plurality of essentially monochromatic LEDs to emit second radiation at a second wavelength;
E) during D), control the at least one first camera to acquire second UV-SWIR imagery; and
F) deactivate the second LED element.

51. The system of claim 50, wherein the at least one controller is configured to:
G) during operation of the imaging engine, repeat D), E), and F) by successively substituting each additional LED element of the plurality of essentially monochromatic LEDs for the second LED element in D), E), and F).

52. The system of claim 51, further comprising an image processor (5000A) to overlay the UV-SWIR imagery acquired by the at least one first camera in the first field of view and the LWIR imagery acquired by the at least one second camera in the first field of view to generate at least one multispectral image (5090A) that includes the UV-SWIR imagery and the LWIR imagery.

53. The system of claim 52, wherein:
the UV-SWIR imagery includes a plurality of object images, at respective wavelengths of the different emission wavelengths, recording an albedo of a first object (900) in the first field of view during irradiation of the first object by the different emission wavelengths; and
the image processor overlays the plurality of object images of the UV-SWIR imagery to generate the multispectral image.

54. The system of claim 53, wherein the image processor is configured to process the plurality of object images recording the albedo of the first object at the respective wavelengths of the different emission wavelengths to detect and/or quantify one or more chemical compounds or constituents present in the first object, based at least in part on one or more peaks of absorptance or reflectance present in the plurality of object images.

55. The system of claim 54, wherein the one or more chemical compounds or constituents include at least one of mold, mildew, a photosynthetic compound, water, NO₃, NO₂, P₄, K+, C₂H₄, CH₄, O₂ or CO₂.
